(19) United States
(12) Patent Application Publication
(10) Pub. No.: US 2026/0025183 A1
(43) Pub. Date: Jan. 22, 2026

(54) CSI CODEBOOK FOR MULTI-TRP COHERENT JOINT TRANSMISSION

(71) Applicant: Samsung Electronics Co., Ltd., Suwon-si (KR)

(72) Inventors: Gilwon Lee, Prosper, TX (US); Md. Saifur Rahman, Plano, TX (US); Eko Onggosanusi, Coppell, TX (US)

(21) Appl. No.: 19/340,835

(22) Filed: Sep. 25, 2025

Related U.S. Application Data
(63) Continuation of application No. 18/310,396, filed on May 1, 2023, now abandoned.
(60) Provisional application No. 63/340,379, filed on May 10, 2022.
(60) Provisional application No. 63/343,025, filed on May 17, 2022.
(60) Provisional application No. 63/343,475, filed on May 18, 2022.
(60) Provisional application No. 63/396,482, filed on Aug. 9, 2022.
(60) Provisional application No. 63/398,436, filed on Aug. 16, 2022.
(60) Provisional application No. 63/399,102, filed on Aug. 18, 2022.
(60) Provisional application No. 63/404,435, filed on Sep. 7, 2022.
(60) Provisional application No. 63/413,197, filed on Oct. 4, 2022.

(51) Int. Cl. H04B 7/06

(52) U.S. Cl. CPC H04B 7/0626; H04B 7/0634

(57) ABSTRACT

Apparatuses and methods for channel state information (CSI) reporting in multi-transmission reception point (TRP) operations in wireless networks. A method performed by a user equipment (UE) includes receiving information about a CSI report associated with Nₜᵣₚ groups of antenna ports, where Nₜᵣₚ>1 and, based on the information, determining the CSI report associated with N≤Nₜᵣₚ groups of antenna ports, where N∈{2, 3, . . . , Nₜᵣₚ}. The CSI report includes a first indicator indicating, for each layer l=1, . . . , v, indices of Mᵥ vectors including columns of a frequency-domain (FD) basis matrix W_{f,l}, where v≥1 is a rank value and a second indicator indicating an index of a FD offset value φᵣ for each of the N groups of antenna ports, where r∈{1, . . . , N}, r≠r* and r* is an index of a reference group of antenna ports. The method further includes transmitting the CSI report including the first and the second indicators.

### CROSS-REFERENCE TO RELATED APPLICATION AND CLAIM OF PRIORITY

This application is a continuation of U.S. patent application Ser. No. 18/310,396, filed on May 1, 2023, which claims priority under 35 U.S.C. § 119(e) to U.S. Provisional Patent Application No. 63/340,379 filed on May 10, 2022, U.S. Provisional Patent Application No. 63/343,025 filed on May 17, 2022, U.S. Provisional Patent Application No. 63/343,475 filed on May 18, 2022, U.S. Provisional Patent Application No. 63/396,482 filed on Aug. 9, 2022, U.S. Provisional Patent Application No. 63/398,436 filed on Aug. 16, 2022, U.S. Provisional Patent Application No. 63/399,102 filed on Aug. 18, 2022, U.S. Provisional Patent Application No. 63/404,435 filed on Sep. 7, 2022, and U.S. Provisional Patent Application No. 63/413,197 filed on Oct. 4, 2022. The above-identified provisional patent applications are hereby incorporated by reference in their entirety.

### TECHNICAL FIELD

The present disclosure relates generally to wireless communication systems and, more specifically, to electronic devices and methods for channel state information (CSI) codebook for multi-transmission reception point (TRP) coherent joint transmission (C-JT) in wireless networks.

### BACKGROUND

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

This disclosure relates to apparatuses and methods for CSI codebook for multi-TRP C-JT operations.

In one embodiment, a user equipment (UE) is provided. The UE includes a transceiver configured to receive information about a CSI report associated with Nₜᵣₚ groups of antenna ports, where Nₜᵣₚ>1. The UE further includes a processor operably coupled to the transceiver. The processor, based on the information, is configured to determine the CSI report associated with N≤Nₜᵣₚ groups of antenna ports, where N∈{2, 3, . . . , Nₜᵣₚ}. The CSI report includes a first indicator indicating, for each layer l=1, . . . , v, indices of Mᵥ vectors including columns of a frequency-domain (FD) basis matrix W_{f,l}, where v≥1 is a rank value and a second indicator indicating an index of a FD offset value φᵣ for each of the N groups of antenna ports, where r∈{1, . . . , N}, r≠r* and r* is an index of a reference group of antenna ports. The transceiver is further configured to transmit the CSI report including the first and the second indicators. The FD basis matrix associated with an r-th group of antenna ports is determined based on W_{f,l} and φᵣ.

In another embodiment, a base station (BS) is provided. The BS includes a processor configured to identify information about a CSI report associated with Nₜᵣₚ groups of antenna ports, where Nₜᵣₚ>1. The BS further includes a transceiver operably coupled to the processor, the transceiver configured to transmit the information and receive the CSI report associated with N≤Nₜᵣₚ groups of antenna ports, where N∈{2, 3, . . . , Nₜᵣₚ}. The CSI report includes a first indicator indicating, for each layer l=1, . . . , v, indices of Mᵥ vectors including columns of a FD basis matrix W_{f,l}, where v≥1 is a rank value and a second indicator indicating an index of a FD offset value φᵣ for each of the N groups of antenna ports, where r∈{1, . . . , N}, r≠r* and r* is an index of a reference group of antenna ports. The FD basis matrix associated with an r-th group of antenna ports is determined based on W_{f,l} and φᵣ.

In yet another embodiment, a method performed by a UE is provided. The method includes receiving information about a CSI report associated with Nₜᵣₚ groups of antenna ports, where Nₜᵣₚ>1 and, based on the information, determining the CSI report associated with N≤Nₜᵣₚ groups of antenna ports, where N∈{2, 3, . . . , Nₜᵣₚ}. The CSI report includes a first indicator indicating, for each layer l=1, . . . , v, indices of Mᵥ vectors including columns of a FD basis matrix W_{f,l}, where v≥1 is a rank value and a second indicator indicating an index of a FD offset value φᵣ for each of the N groups of antenna ports, where r∈{1, . . . , N}, r≠r* and r* is an index of a reference group of antenna ports. The method further includes transmitting the CSI report including the first and the second indicators. The FD basis matrix associated with an r-th group of antenna ports is determined based on W_{f,l} and φᵣ.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example user equipment (UE) according to embodiments of the present disclosure;

FIG. 4 illustrates an example antenna blocks or arrays forming beams according to embodiments of the present disclosure;

FIG. 5 illustrates an example distributed multiple-input multiple-output (MIMO) system according to embodiments of the present disclosure;

FIG. 6 illustrates an example distributed MIMO system according to embodiments of the present disclosure;

FIG. 7 illustrates an example antenna port layout according to embodiments of the present disclosure;

FIG. 8 illustrates a 3D grid of oversampled discrete Fourier transform (DFT) beams according to embodiments of the present disclosure;

FIG. 9 illustrates two new codebooks according to embodiments of the present disclosure;

FIG. 10 illustrates an example distributed MIMO system where each TRP has a single antenna panel according to embodiments of the present disclosure;

FIG. 11 illustrates an example distributed MIMO system where each TRP has a multiple antenna panels according to embodiments of the present disclosure;

FIG. 12 illustrates an example distributed MIMO system where each TRP can be a single panel or a multiple panel according to embodiments of the present disclosure; and

FIG. 13 illustrates an example method performed by a UE in a wireless communication system according to embodiments of the present disclosure.

### DETAILED DESCRIPTION

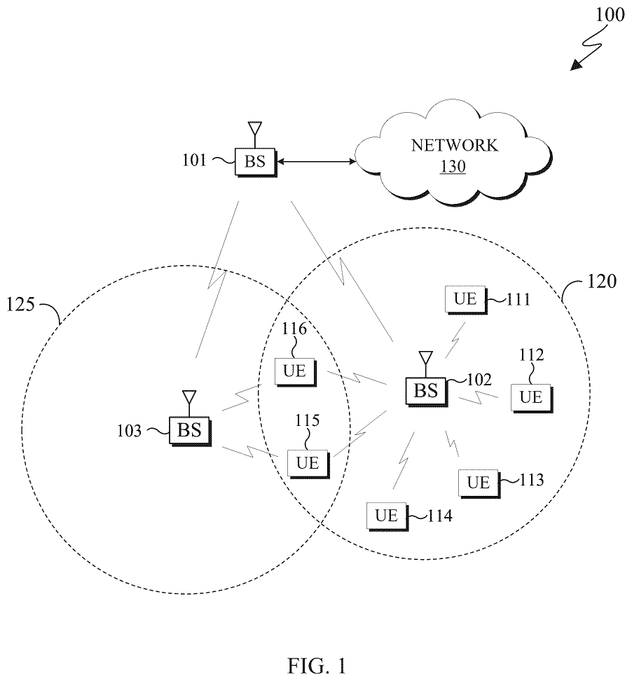

FIGS. 1 through 13, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably-arranged system or device.

The following documents and standards descriptions are hereby incorporated by reference into the present disclosure as if fully set forth herein: 3GPP TS 36.211 v17.2.0, “E-UTRA, Physical channels and modulation” (herein “REF 1”); 3GPP TS 36.212 v17.2.0, “E-UTRA, Multiplexing and Channel coding” (herein “REF 2”); 3GPP TS 36.213 v17.2.0, “E-UTRA, Physical Layer Procedures” (herein “REF 3”); 3GPP TS 36.321 v17.1.0, “E-UTRA, Medium Access Control (MAC) protocol specification” (herein “REF 4”); 3GPP TS 36.331 v17.1.0, “E-UTRA, Radio Resource Control (RRC) Protocol Specification” (herein “REF 5”); 3GPP TS 38.211 v17.2.0, “NR, Physical channels and modulation” (herein “REF 6”); 3GPP TS 38.212 v17.2.0, “NR, Multiplexing and Channel coding” (herein “REF 7”); 3GPP TS 38.213 v17.2.0, “NR, Physical Layer Procedures for Control” (herein “REF 8”); 3GPP TS 38.214 v17.2.0, “NR, Physical Layer Procedures for Data” (herein “REF 9”); 3GPP TS 38.215 v17.1.0, “NR, Physical Layer Measurements” (herein “REF 10”); 3GPP TS 38.321 v17.1.0, “NR, Medium Access Control (MAC) protocol specification” (herein “REF 11”); 3GPP TS 38.331 v17.1.0, “NR, Radio Resource Control (RRC) Protocol Specification” (herein “REF 12”).

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage is of paramount importance.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHZ, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3rd generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for supporting CSI codebook for multi-TRP coherent joint transmission. In certain embodiments, one or more of the BSs 101-103 include circuitry, programing, or a combination thereof for supporting CSI codebook for multi-TRP coherent joint transmission.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

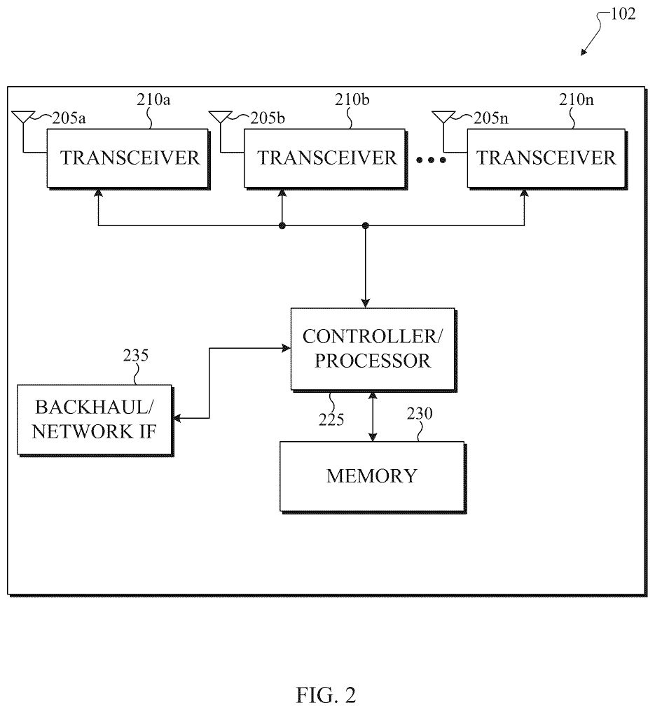

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. As another example, the controller/processor 225 could support methods for supporting CSI codebook for multi-TRP coherent joint transmission. Any of a wide variety of other functions could be supported in the gNB 102 by the controller/processor 225.

The controller/processor 225 is also capable of executing programs and other processes resident in the memory 230, such as an OS. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

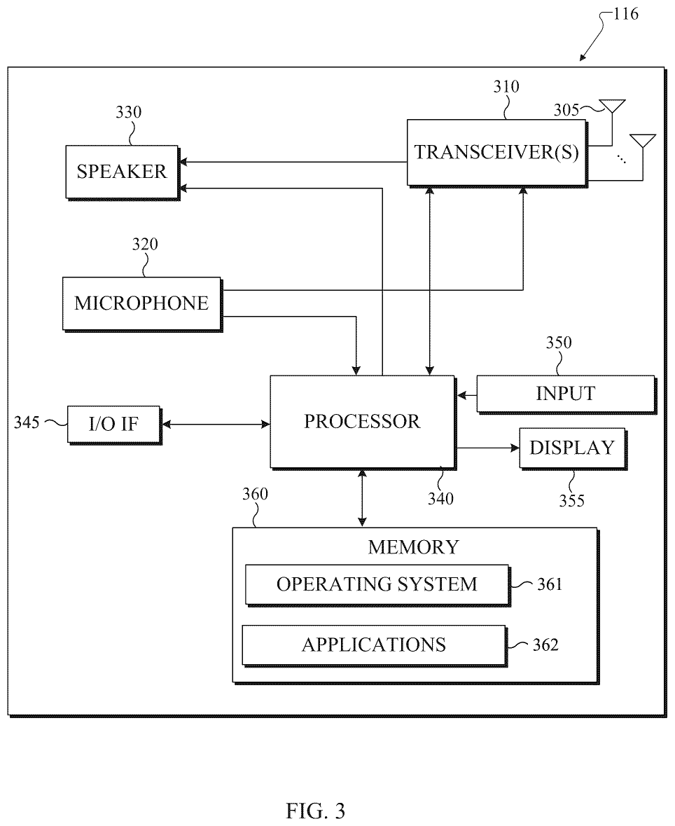

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives, from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. As another example, the processor 340 could support methods for utilizing a CSI codebook to receive a multi-TRP coherent joint transmission. In some embodiments, the processor 340 includes at least one microprocessor or microcontroller.

The processor 340 is also capable of executing other processes and programs resident in the memory 360. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

The 3GPP NR specification supports up to 32 CSI-RS antenna ports which enable a gNB to be equipped with a large number of antenna elements (such as 64 or 128). In this case, a plurality of antenna elements is mapped onto one CSI-RS port. For next generation cellular systems such as 5G, the maximum number of CSI-RS ports can either remain the same or increase.

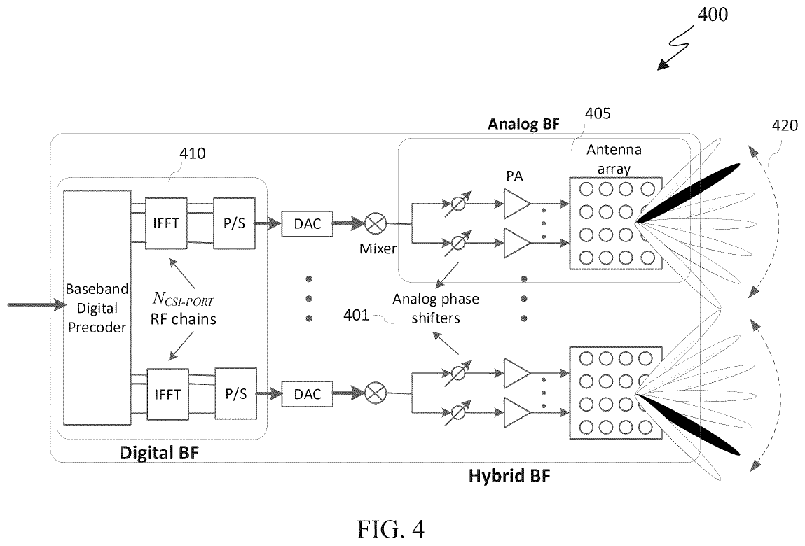

FIG. 4 illustrates an example antenna blocks or arrays 400 according to embodiments of the present disclosure. The embodiment of the antenna blocks or arrays 400 illustrated in FIG. 4 is for illustration only. FIG. 4 does not limit the scope of this disclosure to any particular implementation of the antenna blocks or arrays.

For mmWave bands, although the number of antenna elements can be larger for a given form factor, the number of CSI-RS ports—which can correspond to the number of digitally precoded ports—tends to be limited due to hardware constraints (such as the feasibility to install a large number of ADCs/DACs at mmWave frequencies) as illustrated in FIG. 4. In this case, one CSI-RS port is mapped onto a large number of antenna elements which can be controlled by a bank of analog phase shifters 401. One CSI-RS port can then correspond to one sub-array which produces a narrow analog beam through analog beamforming 405. This analog beam can be configured to sweep across a wider range of angles 420 by varying the phase shifter bank across symbols or subframes. The number of sub-arrays (equal to the number of RF chains) is the same as the number of CSI-RS ports N_{CSI-PORT}. A digital beamforming unit 410 performs a linear combination across N_{CSI-PORT} analog beams to further increase precoding gain. While analog beams are wideband (hence not frequency-selective), digital precoding can be varied across frequency sub-bands or resource blocks. Receiver operation can be conceived analogously.

Since the above system utilizes multiple analog beams for transmission and reception (wherein one or a small number of analog beams are selected out of a large number, for instance, after a training duration—to be performed from time to time), the term “multi-beam operation” is used to refer to the overall system aspect. This includes, for the purpose of illustration, indicating the assigned DL or UL transmit (TX) beam (also termed “beam indication”), measuring at least one reference signal for calculating and performing beam reporting (also termed “beam measurement” and “beam reporting”, respectively), and receiving a DL or UL transmission via a selection of a corresponding receive (RX) beam.

The above system is also applicable to higher frequency bands such as >52.6 GHZ (also termed the FR4). In this case, the system can employ only analog beams. Due to the O2 absorption loss around 60 GHz frequency (˜10 dB additional loss @ 100 m distance), larger number of and sharper analog beams (hence larger number of radiators in the array) will be needed to compensate for the additional path loss.

At lower frequency bands such as <1 GHz, on the other hand, the number of antenna elements may not be large in a given form factor due to the large wavelength. As an example, for the case of the wavelength size (λ) of the center frequency 600 MHZ (which is 50 cm), it desires 4 m for uniform-linear-array (ULA) antenna panel of 16 antenna elements with the half-wavelength distance between two adjacent antenna elements. Considering a plurality of antenna elements is mapped to one digital port in practical cases, the desirable size for antenna panel(s) at gNB to support a large number of antenna ports such as 32 CSI-RS ports becomes very large in such low frequency bands, and it leads the difficulty of deploying 2-D antenna element arrays within the size of a conventional form factor. This results in a limited number of CSI-RS ports that can be supported at a single site and limits the spectral efficiency of such systems.

Various embodiments of the present disclosure recognize that for a cellular system operating in a sub-1 GHz frequency range (e.g., less than 1 GHZ), supporting large number of CSI-RS antenna ports (e.g., 32) at a single location or remote radio head (RRH) or TRP is challenging due to that a larger antenna form factor size is needed at these frequencies than a system operating at a higher frequency such as 2 GHz or 4 GHz. At such low frequencies, the maximum number of CSI-RS antenna ports that can be co-located at a single site (or TRP/RRH) can be limited, for example to 8. This limits the spectral efficiency of such systems. In particular, the MU-MIMO spatial multiplexing gains offered due to large number of CSI-RS antenna ports (such as 32) can't be achieved.

One way to operate a sub-1 GHz system with large number of CSI-RS antenna ports is based on distributing antenna ports at multiple locations (or TRP/RRHs). The multiple sites or TRPs/RRHs can still be connected to a single (common) base unit, hence the signal transmitted/received via multiple distributed TRPs/RRHs can still be processed at a centralized location. This is called distributed MIMO or multi-TRP coherent joint transmission (C-JT).

Various embodiments of the present disclosure recognize that CSI enhancement described in Rel-18 MIMO considers Rel-16/17 Type-II CSI codebook refinements to support mTRP coherent joint transmission (C-JT) operations by considering performance-and-overhead trade-off. The Rel-16/17 Type-II CSI codebook has three components W₁, W₂, and W_{f}. Various embodiments of the present disclosure recognize that based on the three components, an mTRP codebook needs to be specified in Rel-18. Further, various embodiments of the present disclosure recognize that CSI coefficients in W₂ across TRPs can have different reference amplitude values due to power imbalance across TRPs. Various embodiments of the present disclosure recognize that components for indicating the reference values across TRPs need to be supported in Rel-18.

Accordingly, various embodiments of the present disclosure provide components to indicate reference values, and reporting for W1/W2/Wf are proposed for multi-TRP C-JT scenarios. In addition, various embodiments of the present disclosure consider the multi-TRP C-JT scenario and propose methods and apparatus for CSI reporting in multi-TRP C-JT scenarios. Further, various embodiments of the present disclosure provide components for an mTRP codebook based on the three components W₁, W₂, and W_{f} for mTRP coherent joint transmission (C-JT).

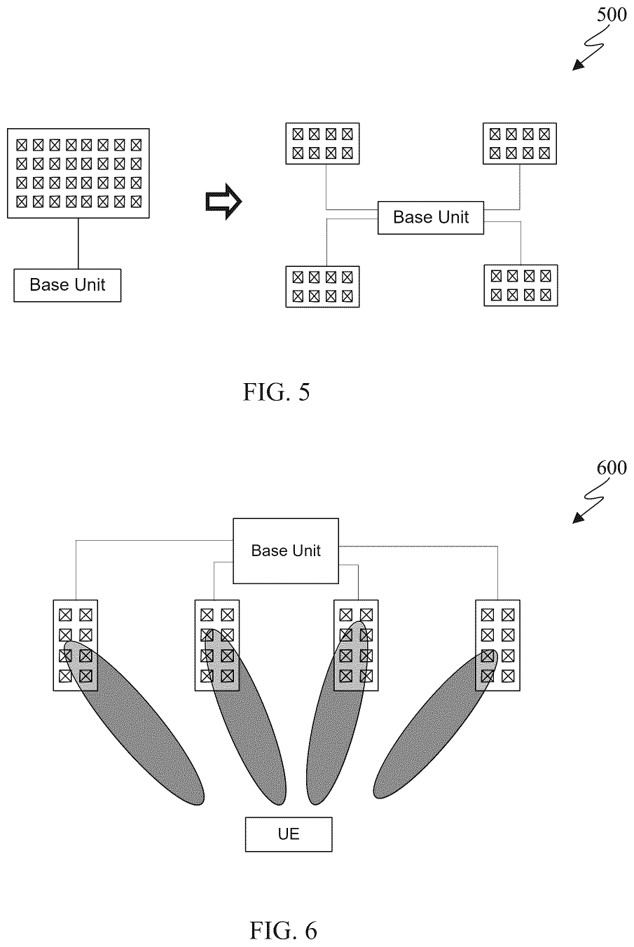

FIG. 5 illustrates an example distributed MIMO system 500 according to embodiments of the present disclosure. The embodiment of the distributed MIMO system 500 illustrated in FIG. 5 is for illustration only. FIG. 5 does not limit the scope of this disclosure to any particular implementation of the distributed MIMO system 500.

One possible approach to resolving the issue is to form multiple TRPs (multi-TRP) or RRHs with a small number of antenna ports instead of integrating all of the antenna ports in a single panel (or at a single site) and to distribute the multiple panels in multiple locations/sites (or TRPs, RRHs). This approach is shown in FIG. 5.

FIG. 6 illustrates an example distributed MIMO system 600 according to embodiments of the present disclosure. The embodiment of the distributed MIMO system 600 illustrated in FIG. 6 is for illustration only. FIG. 6 does not limit the scope of this disclosure to any particular implementation of the distributed MIMO system 600.

As illustrated in FIG. 6, the multiple TRPs at multiple locations can still be connected to a single base unit, and thus the signal transmitted/received via multiple distributed TRPs can be processed in a centralized manner through the single base unit.

Note that although the present disclosure has mentioned low frequency band systems (sub-1 GHz band) as a motivation for distributed MIMO (or mTRP), the distributed MIMO technology is frequency-band-agnostic and can be useful in mid-(sub-6 GHZ) and high-band (above-6 GHZ) systems in addition to low-band (sub-1 GHZ) systems.

The terminology “distributed MIMO” is used as an illustrative purpose, it can be considered under another terminology such as multi-TRP, mTRP, cell-free network, and so on.

All the following components and embodiments are applicable for UL transmission with CP-OFDM (cyclic prefix OFDM) waveform as well as DFT-SOFDM (DFT-spread OFDM) and SC-FDMA (single-carrier FDMA) waveforms. Furthermore, all the following components and embodiments are applicable for UL transmission when the scheduling unit in time is either one subframe (which can consist of one or multiple slots) or one slot.

In the present disclosure, the frequency resolution (reporting granularity) and span (reporting bandwidth) of CSI reporting can be defined in terms of frequency “subbands” and “CSI reporting band” (CRB), respectively.

A subband for CSI reporting is defined as a set of contiguous PRBs which represents the smallest frequency unit for CSI reporting. The number of PRBs in a subband can be fixed for a given value of DL system bandwidth, configured either semi-statically via higher-layer/RRC signaling, or dynamically via L1 DL control signaling or MAC control element (MAC CE). The number of PRBs in a subband can be included in CSI reporting setting.

“CSI reporting band” is defined as a set/collection of subbands, either contiguous or non-contiguous, wherein CSI reporting is performed. For example, CSI reporting band can include all the subbands within the DL system bandwidth. This can also be termed “full-band”. Alternatively, CSI reporting band can include only a collection of subbands within the DL system bandwidth. This can also be termed “partial band”.

The term “CSI reporting band” is used only as an example for representing a function. Other terms such as “CSI reporting subband set” or “CSI reporting bandwidth” can also be used.

In terms of UE configuration, a UE can be configured with at least one CSI reporting band. This configuration can be semi-static (via higher-layer signaling or RRC) or dynamic (via MAC CE or L1 DL control signaling). When configured with multiple (N) CSI reporting bands (e.g., via RRC signaling), a UE can report CSI associated with n≤N CSI reporting bands. For instance, >6 GHz, large system bandwidth may require multiple CSI reporting bands. The value of n can either be configured semi-statically (via higher-layer signaling or RRC) or dynamically (via MAC CE or L1 DL control signaling). Alternatively, the UE can report a recommended value of n via an UL channel.

Therefore, CSI parameter frequency granularity can be defined per CSI reporting band as follows. A CSI parameter is configured with “single” reporting for the CSI reporting band with Mₙ subbands when one CSI parameter for all the Mₙ subbands within the CSI reporting band. A CSI parameter is configured with “subband” for the CSI reporting band with Mₙ subbands when one CSI parameter is reported for each of the Mₙ subbands within the CSI reporting band.

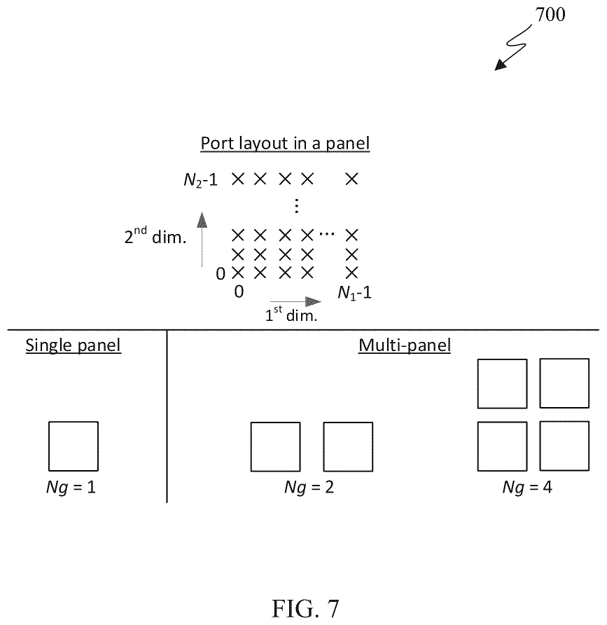

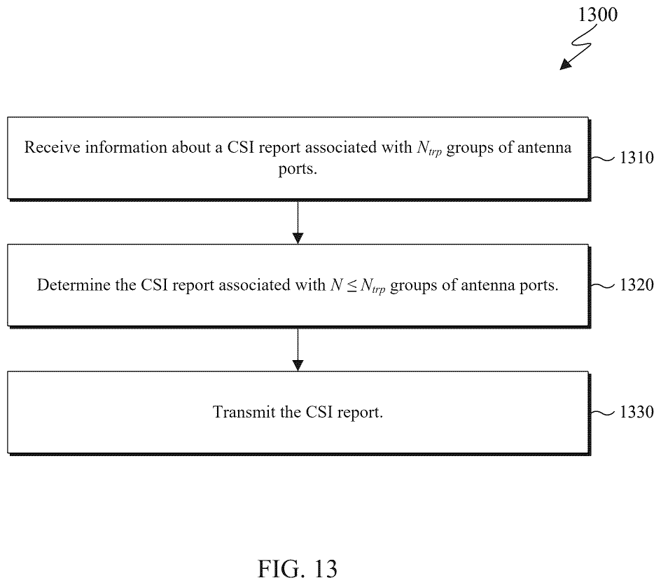

FIG. 7 illustrates an example antenna port layout 700 according to embodiments of the present disclosure. The embodiment of the antenna port layout 700 illustrated in FIG. 13 is for illustration only. FIG. 7 does not limit the scope of this disclosure to any particular implementation of the antenna port layout.

As illustrated in FIGS. 7, N₁ and N₂ are the number of antenna ports with the same polarization in the first and second dimensions, respectively. For 2D antenna port layouts, N₁>1, N₂>1, and for 1D antenna port layouts N₁>1 and N₂=1. Therefore, for a dual-polarized antenna port layout, the total number of antenna ports is 2N₁N₂ when each antenna maps to an antenna port. An illustration is shown in FIG. 7 where “X” represents two antenna polarizations. In this disclosure, the term “polarization” refers to a group of antenna ports. For example, antenna ports

$$j = X + 0 , X + 1 , … , X + \frac{{P}_{CSIRS}}{2} - 1$$

comprise a first antenna polarization, and antenna ports

$$j = X + \frac{{P}_{CSIRS}}{2} , X + \frac{{P}_{CSIRS}}{2} + 1 , … , X + {P}_{CSIRS} - 1$$

comprise a second antenna polarization, where P_{CSIRS} is a number of CSI-RS antenna ports and X is a starting antenna port number (e.g., X=3000, then antenna ports are 3000, 3001, 3002, . . . ). Let N_{g} be a number of antenna panels at the gNB. When there are multiple antenna panels (N_{g}>1), we assume that each panel is dual-polarized antenna ports with N₁ and N₂ ports in two dimensions. This is illustrated in FIG. 7. Note that the antenna port layouts may or may not be the same in different antenna panels.

In one example, the antenna architecture of a D-MIMO or CJT (coherent joint-transmission) system is structured. For example, the antenna structure at each RRH (or TRP) is dual-polarized (single or multi-panel as shown in FIG. 7. The antenna structure at each RRH/TRP can be the same. Alternatively, the antenna structure at an RRH/TRP can be different from another RRH/TRP. Likewise, the number of ports at each RRH/TRP can be the same. Alternatively, the number of ports at one RRH/TRP can be different from another RRH/TRP. In one example, N_{g}=N_{RRH}, a number of RRHs/TRPs in the D-MIMO transmission.

In another example, the antenna architecture of a D-MIMO or CJT system is unstructured. For example, the antenna structure at one RRH/TRP can be different from another RRH/TRP.

The remainder of the present disclosure assumes a structured antenna architecture. For simplicity, in the remainder of the present disclosure it is assumed that each RRH/TRP is equivalent to a panel, although, an RRH/TRP can have multiple panels in practice. The present disclosure however is not restrictive to a single panel assumption at each RRH/TRP, and can easily be extended (covers) the case when an RRH/TRP has multiple antenna panels.

In one embodiment, an RRH constitutes (or corresponds to or is equivalent to) at least one of the following:
In one example, an RRH corresponds to a TRP.
In one example, an RRH or TRP corresponds to a CSI-RS resource. A UE is configured with K=N_{RRH}>1 non-zero-power (NZP) CSI-RS resources, and a CSI reporting is configured to be across multiple CSI-RS resources. This is similar to Class B, K>1 configuration in Rel. 14 LTE. The K NZP CSI-RS resources can belong to a CSI-RS resource set or multiple CSI-RS resource sets (e.g., K resource sets each comprising one CSI-RS resource). The details are as explained earlier in this disclosure.
In one example, an RRH or TRP corresponds to a CSI-RS resource group, where a group comprises one or multiple NZP CSI-RS resources. A UE is configured with K≥N_{RRH}>1 non-zero-power (NZP) CSI-RS resources, and a CSI reporting is configured to be across multiple CSI-RS resources from resource groups. This is similar to Class B, K>1 configuration in Rel. 14 LTE. The K NZP CSI-RS resources can belong to a CSI-RS resource set or multiple CSI-RS resource sets (e.g., K resource sets each comprising one CSI-RS resource). The details are as explained earlier in this disclosure. In particular, the K CSI-RS resources can be partitioned into N_{RRH} resource groups. The information about the resource grouping can be provided together with the CSI-RS resource setting/configuration, or with the CSI reporting setting/configuration, or with the CSI-RS resource configuration.
In one example, an RRH or TRP corresponds to a subset (or a group) of CSI-RS ports. A UE is configured with at least one NZP CSI-RS resource comprising (or associated with) CSI-RS ports that can be grouped (or partitioned) multiple subsets/groups/parts of antenna ports, each corresponding to (or constituting) an RRH/TRP. The information about the subsets of ports or grouping of ports can be provided together with the CSI-RS resource setting/configuration, or with the CSI reporting setting/configuration, or with the CSI-RS resource configuration.
In one example, an RRH or TRP corresponds to one or more examples described above depending on a configuration. For example, this configuration can be explicit via a parameter (e.g., an RRC parameter). Alternatively, it can be implicit.
   In one example, when implicit, it could be based on the value of K. For example, when K>1 CSI-RS resources, an RRH corresponds to one or more examples described above, and when K=1 CSI-RS resource, an RRH corresponds to one or more examples described above.
   In another example, the configuration could be based on the configured codebook. For example, an RRH corresponds to a CSI-RS resource or resource group when the codebook corresponds to a decoupled codebook (modular or separate codebook for each RRH), and an RRH corresponds to a subset (or a group) of CSI-RS ports when codebook corresponds to a coupled (joint or coherent) codebook (one joint codebook across TRPs/RRHs).

In one example, when RRH or TRP maps (or corresponds to) a CSI-RS resource or resource group, and a UE can select a subset of RRHs (resources or resource groups) and report the CSI for the selected TRPs/RRHs (resources or resource groups), the selected TRPs/RRHs can be reported via an indicator. For example, the indicator can be a CRI or a PMI (component) or a new indicator.

In one example, when RRH or TRP maps (or corresponds to) a CSI-RS port group, and a UE can select a subset of TRPs/RRHs (port groups) and report the CSI for the selected TRPs/RRHs (port groups), the selected TRPs/RRHs can be reported via an indicator. For example, the indicator can be a CRI or a PMI (component) or a new indicator.

In one example, when multiple (K>1) CSI-RS resources are configured for N_{RRH} TRPs/RRHs, a decoupled (modular) codebook is used/configured, and when a single (K=1) CSI-RS resource for N_{RRH} TRPs/RRHs, a joint codebook is used/configured.

As described in U.S. Pat. No. 10,659,118, issued May 19, 2020, and entitled “Method and Apparatus for Explicit CSI Reporting in Advanced Wireless Communication Systems,” which is incorporated herein by reference in its entirety, a UE is configured with high-resolution (e.g., Type II) CSI reporting in which the linear combination-based Type II CSI reporting framework is extended to include a frequency dimension in addition to the first and second antenna port dimensions.

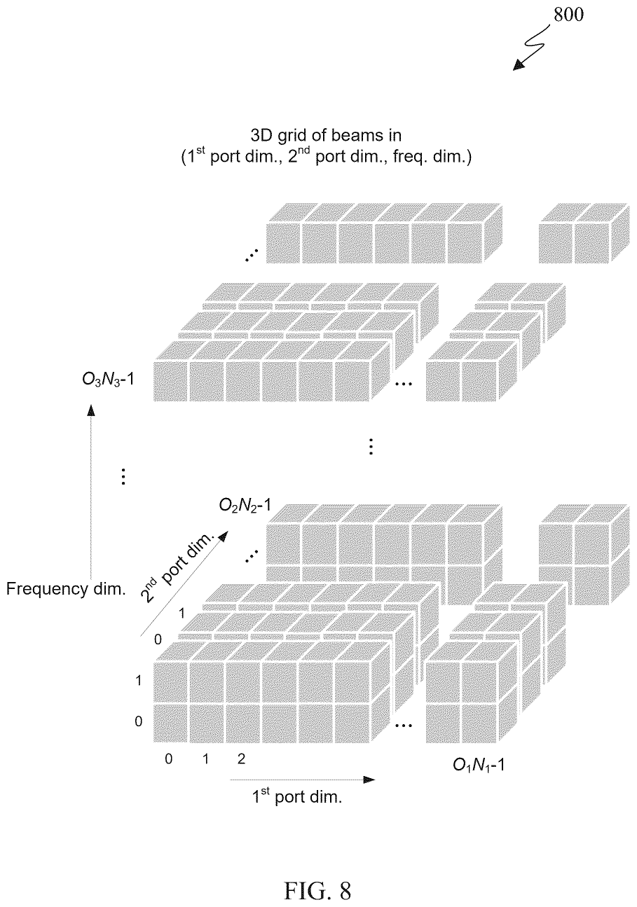

FIG. 8 illustrates a 3D grid of oversampled DFT beams 800 according to embodiments of the present disclosure. The embodiment of the 3D grid of oversampled DFT beams 800 illustrated in FIG. 8 is for illustration only. FIG. 8 does not limit the scope of this disclosure to any particular implementation of the 3D grid of oversampled DFT beams.

As illustrated, FIG. 8 shows a 3D grid 800 of the oversampled DFT beams (1st port dim., 2nd port dim., freq. dim.) in which
a 1st dimension is associated with the 1st port dimension,
a 2nd dimension is associated with the 2nd port dimension, and
a 3rd dimension is associated with the frequency dimension.

The basis sets for 1^{st} and 2^{nd} port domain representation are oversampled DFT codebooks of length-N₁ and length-N₂, respectively, and with oversampling factors O₁ and O₂, respectively. Likewise, the basis set for frequency domain representation (i.e., 3rd dimension) is an oversampled DFT codebook of length-N₃ and with oversampling factor O₃. In one example, O₁=O₂=O₃=4. In one example, O₁=O₂=4 and O₃=1. In another example, the oversampling factors Oᵢ belongs to {2, 4, 8}. In yet another example, at least one of O₁, O₂, and O₃ is higher layer configured (via RRC signaling).

As explained in Section 5.2.2.2.6 of REF8, a UE is configured with higher layer parameter codebookType set to ‘typeII-PortSelection-r16’ for an enhanced Type II CSI reporting in which the pre-coders for all SBs and for a given layer l=1, . . . , v, where v is the associated RI value, is given by either

$${W}^{l} = A {C}_{l} {B}^{H} = [ \begin{matrix}{a}_{0} & {a}_{1} & … & {a}_{L - 1}\end{matrix} ] [ \begin{matrix}{c}_{l , 0 , 0} & {c}_{l , 0 , 1} & ⋯ & {c}_{l , 0 , M - 1} \\ {c}_{l , 1 , 0} & {c}_{l , 1 , 1} & ⋯ & {c}_{l , 1 , M - 1} \\ ⋮ & ⋮ & ⋮ & ⋮ \\ {c}_{l , L - 1 , 0} & {c}_{l , L - 1 , 1} & ⋯ & {c}_{l , L - 1 , M - 1}\end{matrix} ] {[ \begin{matrix}{b}_{0} & {b}_{1} & … & {b}_{M - 1}\end{matrix} ]}^{H} \text{} = {\sum }_{f = 0}^{M - 1} {\sum }_{i = 0}^{L - 1} {c}_{l , i , f} ( {a}_{i} {b}_{f}^{H} ) = {\sum }_{i = 0}^{L - 1} {\sum }_{f = 0}^{M - 1} {c}_{l , i , f} ( {a}_{i} {b}_{f}^{H} ) , \\ or \qquad ( Eq . 1 )$$

$${W}^{l} = [ \begin{matrix}A & 0 \\ 0 & A\end{matrix} ] {C}_{l} {B}^{H} = [ \begin{matrix}\begin{matrix}{a}_{0} & {a}_{1} & … & {a}_{L - 1}\end{matrix} & 0 \\ 0 & \begin{matrix}{a}_{0} & {a}_{1} & … & {a}_{L - 1}\end{matrix}\end{matrix} ] {[ \begin{matrix}{c}_{l , 0 , 0} & {c}_{l , 0 , 1} & ⋯ & {c}_{l , 0 , M - 1} \\ {c}_{l , 1 , 0} & {c}_{l , 1 , 1} & ⋯ & {c}_{l , 1 , M - 1} \\ ⋮ & ⋮ & ⋮ & ⋮ \\ {c}_{l , L - 1 , 0} & {c}_{l , L - 1 , 1} & ⋯ & {c}_{l , L - 1 , M - 1}\end{matrix} ] [ \begin{matrix}{b}_{0} & {b}_{1} & … & {b}_{M - 1}\end{matrix} ]}^{H} = [ \begin{matrix}{\sum }_{f = 0}^{M - 1} {\sum }_{i = 0}^{L - 1} {c}_{l , i , f} ( {a}_{i} {b}_{f}^{H} ) \\ {\sum }_{f = 0}^{M - 1} {\sum }_{i = 0}^{L - 1} {c}_{l , i + L , f} ( {a}_{i} {b}_{f}^{H} )\end{matrix} ] , \qquad ( Eq . 2 )$$

where:
   N₁ is a number of antenna ports in a first antenna port dimension (having the same antenna polarization),
   N₂ is a number of antenna ports in a second antenna port dimension (having the same antenna polarization),
   P_{CSI-RS} is a number of CSI-RS ports configured to the UE,
   N₃ is a number of SBs for PMI reporting or number of FD units or number of FD components (that comprise the CSI reporting band) or a total number of precoding matrices indicated by the PMI (one for each FD unit/component),
   aᵢ is a 2N₁N₂×1 (Eq. 1) or N₁N₂×1 (Eq. 2) column vector, or aᵢ is a P_{CSIRS}×1 (Eq. 1) or

$$\frac{{P}_{CSIRS}}{2} \times 1$$

port selection column vector, where a port selection vector is a defined as a vector which contains a value of 1 in one element and zeros elsewhere,
b_{f} is a N₃×1 column vector,
c_{l,i,f} is a complex coefficient.

In a variation, when the UE reports a subset K<2LM coefficients (where K is either fixed, configured by the gNB or reported by the UE), then the coefficient c_{l,i,f} in precoder equations Eq. 1 or Eq. 2 is replaced with x_{l,i,f}×c_{l,i,f}, where
x_{l,i,f}=1 if the coefficient c_{l,i,f} is reported by the UE according to some embodiments of this disclosure.
x_{l,i,f}=0 otherwise (i.e., c_{l,i,f} is not reported by the UE).

The indication whether x_{l,i,f}=1 or 0 is according to some embodiments of this disclosure. For example, it can be via a bitmap.

In a variation, the precoder equations Eq. 1 or Eq. 2 are respectively generalized to

$${W}^{l} = {\sum }_{i = 0}^{L - 1} {\sum }_{f = 0}^{{M}_{i} - 1} {c}_{l , i , f} ( {a}_{i} {b}_{i , f}^{H} ) \\ and \qquad ( Eq . 3 )$$

$${W}^{l} = [ \begin{matrix}{\sum }_{i = 0}^{L - 1} {\sum }_{f = 0}^{i} {c}_{l , i , f} ( {a}_{i} {b}_{i , f}^{H} ) \\ {\sum }_{i = 0}^{L - 1} {\sum }_{= 0}^{{M}_{i} - 1} {c}_{l , i + L , f} ( {a}_{i} {b}_{i , f}^{H} )\end{matrix} ] , \qquad ( Eq . 4 )$$

where for a given i, the number of basis vectors is Mᵢ and the corresponding basis vectors are {b_{i,f}}. Note that Mᵢ is the number of coefficients c_{l,i,f} reported by the UE for a given i, where Mᵢ≤M (where {Mᵢ} or ΣMᵢ is either fixed, configured by the gNB or reported by the UE).

The columns of W^{l} are normalized to norm one. For rank R or R layers (υ=R), the pre-coding matrix is given by

$${W}^{( R )} = \frac{1}{\sqrt{R}} [ \begin{matrix}{W}^{1} & {W}^{2} & … & {W}^{R}\end{matrix} ] .$$

Eq. 2 is assumed in the rest of the disclosure. The embodiments of the disclosure, however, are general and are also application to Eq. 1, Eq. 3 and Eq. 4.

Here

$$L \leq \frac{{P}_{CSI - RS}}{2}$$

### and M≤N₃. If

$$L = \frac{{P}_{CSI - RS}}{2} ,$$

then A is an identity matrix, and hence not reported. Likewise, if M=N₃, then B is an identity matrix, and hence not reported. Assuming M<N₃, in an example, to report columns of B, the oversampled DFT codebook is used. For instance, b_{f}=W_{f}, where the quantity w_{f} is given by

$${w}_{f} = [ \begin{matrix}1 & {e}^{j \frac{2 π {n}_{3 , l}^{( f )}}{{O}_{3} {N}_{3}}} & {e}^{j \frac{2 π \text{.2} {n}_{3 , l}^{( f )}}{{O}_{3} {N}_{3}}} & … & {e}^{{j \frac{2 π . ( {N}_{3} - 1 ) {n}_{3 , l}^{( f )}}{{O}_{3} {N}_{3}} ]}^{T}}\end{matrix} .$$

When O₃=1, the FD basis vector for layer l∈{1, . . . , υ} (where υ is the RI or rank value) is given by

$${w}_{f} = {[ \begin{matrix}{y}_{0 , l}^{( f )} & {y}_{1 , l}^{( f )} & … & {y}_{{N}_{3} - 1 , l}^{( f )}\end{matrix} ]}^{T} ,$$

$$where {y}_{t , l}^{( f )} = {e}^{j \frac{2 π t {n}_{3 , l}^{( f )}}{{N}_{3}}} and {n}_{3 , l} = [ {n}_{3 , l}^{( 0 )} , … , {n}_{3 , l}^{( M - 1 )} ] where {n}_{3 , l}^{( f )} ∈ \{ 0 , 1 , … , {N}_{3} - 1 \} .$$

In another example, discrete cosine transform DCT basis is used to construct/report basis B for the 3^{rd} dimension. The m-th column of the DCT compression matrix is simply given by

$${[ {W}_{f} ]}_{n m} = \{ \begin{matrix}\frac{1}{\sqrt{K}} , n = 0 \\ \sqrt{\frac{2}{K}} cos \frac{π ( 2 m + 1 ) n}{2 K} , n = 1 , … K - 1\end{matrix} , and K = {N}_{3} , and m = 0 , … , {N}_{3} - 1 .$$

Since DCT is applied to real valued coefficients, the DCT is applied to the real and imaginary components (of the channel or channel eigenvectors) separately. Alternatively, the DCT is applied to the magnitude and phase components (of the channel or channel eigenvectors) separately. The use of DFT or DCT basis is for illustration purpose only. The disclosure is applicable to any other basis vectors to construct/report A and B.

On a high level, a precoder W^{l} can be described as follows.

$$W = {A}_{l} {C}_{l} {B}_{l}^{H} = {W}_{1} {\tilde{W}}_{2} {W}_{f}^{H} , \qquad ( Eq . 5 )$$

where A=W₁ corresponds to the Rel. 15 W₁ in Type II CSI codebook [REF8], and B=W_{f}.

The Cₗ=\tilde{W}₂ matrix consists of all the required linear combination coefficients (e.g., amplitude and phase or real or imaginary). Each reported coefficient (c_{l,i,f}=p_{l,i,f}ϕ_{l,i,f}) in \tilde{W}₂ is quantized as amplitude coefficient (p_{l,i,f}) and phase coefficient (ϕ_{l,i,f}). In one example, the amplitude coefficient (p_{l,i,f}) is reported using a A-bit amplitude codebook where A belongs to {2, 3, 4}. If multiple values for A are supported, then one value is configured via higher layer signaling. In another example, the amplitude coefficient (p_{l,i,f}) is reported as

$${p}_{l , i , f} = {p}_{l , i , f}^{( 1 )} {p}_{l , i , f}^{( 2 )}$$

where

$${p}_{l , i , f}^{( 1 )}$$

is a reference or first amplitude which is reported using an A1-bit amplitude codebook where A1 belongs to {2, 3, 4}, and

$${p}_{l , i , f}^{( 2 )}$$

is a differential or second amplitude which is reported using a A2-bit amplitude codebook where A2≤A1 belongs to {2, 3, 4}.

For layer l, let us denote the linear combination (LC) coefficient associated with spatial domain (SD) basis vector (or beam) i∈{0, 1, . . . , 2L−1} and frequency domain (FD) basis vector (or beam) f∈{0, 1, . . . , M−1} as c_{l,i,f}, and the strongest coefficient as c_{l,i*,f*}. The strongest coefficient is reported out of the K_{NZ} non-zero (NZ) coefficients that is reported using a bitmap, where K_{NZ}≤K₀=[β×2LM]<2LM and β is higher layer configured. The remaining 2LM−K_{NZ} coefficients that are not reported by the UE are assumed to be zero. The following quantization scheme is used to quantize/report the K_{NZ} NZ coefficients.
UE reports the following for the quantization of the NZ coefficients in \tilde{W}₂
   A X-bit indicator for the strongest coefficient index (i*,f*), where X=┌log₂ K_{NZ}┐ or ┌log₂ 2L┐.
      i. Strongest coefficient c_{l,i*,f*}+=1 (hence its amplitude/phase are not reported)
   Two antenna polarization-specific reference amplitudes is used.
      i. For the polarization associated with the strongest coefficient c_{l,i*,f*}=1, since the reference amplitude

$${p}_{l , i , f}^{( 1 )} = 1 ,$$

it is not reported
ii. For the other polarization, reference amplitude

$${p}_{l , i , f}^{( 1 )}$$

is quantized to 4 bits.
   1. The 4-bit amplitude alphabet is

$$\{ 1 , {( \frac{1}{2} )}^{\frac{1}{4}} , {( \frac{1}{4} )}^{\frac{1}{4}} , {( \frac{1}{8} )}^{\frac{1}{4}} , … , {( \frac{1}{{2}^{14}} )}^{\frac{1}{4}} \} .$$

For {c_{l,i,f}, (i,f)≠(i*,f*)}:
   i. For each polarization, differential amplitudes

$${P}_{l , i , f}^{( 2 )}$$

of the coefficients calculated relative to the associated polarization-specific reference amplitude and quantized to 3 bits.
   1. The 3-bit amplitude alphabet is

$$\{ 1 , \frac{1}{\sqrt{2}} , \frac{1}{2} , \frac{1}{2 \sqrt{2}} , \frac{1}{4} , \frac{1}{4 \sqrt{2}} , \frac{1}{8} , \frac{1}{8 \sqrt{2}} \} .$$

2. Note: The final quantized amplitude p_{l,i,f} is given by

$${p}_{l , i , f}^{( 1 )} \times {p}_{l , i , f}^{( 2 )}$$

ii. Each phase is quantized to either 8PSK (Nₚₕ=8) or 16PSK (Nₚₕ=16) (which is configurable).

For the polarization r*∈{0,1} associated with the strongest coefficient c_{l,i*,f*}, we have

$${r}^{*} = ⌊ \frac{{i}^{*}}{L} ⌋$$

and the reference amplitude

$${p}_{l , i , f}^{( 1 )} = {p}_{l , {r}^{*}}^{( 1 )} = 1.$$

For the other polarization r∈{0,1} and r≠r*, we have

$$r = ( ⌊ \frac{{i}^{*}}{L} ⌋ + 1 )$$

mod 2 and the reference amplitude

$${p}_{l , i , f}^{( 1 )} = {p}_{l , r}^{( 1 )}$$

is quantized (reported) using the 4-bit amplitude codebook mentioned above.

In Rel. 16 enhanced Type II and Type II port selection codebooks, a UE can be configured to report M FD basis vectors. In one example,

$$M = ⌈ p \times \frac{{N}_{3}}{R} ⌉ ,$$

where R is higher-layer configured from {1,2} and p is higher-layer configured from

$$\{ \frac{1}{4} , \frac{1}{2} \} .$$

In one example, the p value is higher-layer configured for rank 1-2 CSI reporting. For rank>2 (e.g., rank 3-4), the p value (denoted by v₀) can be different. In one example, for rank 1-4, (p,v₀) is jointly configured from

$$\{ ( \frac{1}{2} , \frac{1}{4} ) , ( \frac{1}{4} , \frac{1}{4} ) , ( \frac{1}{4} , \frac{1}{8} ) \} ,$$

i.e.,

$$M = ⌈ p \times \frac{{N}_{3}}{R} ⌉$$

for rank 1-2 and

$$M = ⌈ {v}_{0} \times \frac{{N}_{3}}{R} ⌉$$

for rank 3-4. In one example, N₃=N_{SB}×R where N_{SB} is the number of SBs for CQI reporting. In one example, M is replaced with M_{υ} to show its dependence on the rank value υ, hence p is replaced with p_{υ}, υ∈{1,2} and v₀ is replaced with p_{υ}, υ∈{3,4}.

A UE can be configured to report M_{υ} FD basis vectors in one-step from N₃ basis vectors freely (independently) for each layer l∈{1, . . . , υ} of a rank υ CSI reporting. Alternatively, a UE can be configured to report M_{υ} FD basis vectors in two-step as follows.
In step 1, an intermediate set (InS) comprising

$${N}_{3}^{′} < {N}_{3}$$

basis vectors is selected/reported, wherein the InS is common for all layers.
In step 2, for each layer l∈{1, . . . , υ} of a rank υ CSI reporting, M_{υ} FD basis vectors are selected/reported freely (independently) from

$${N}_{3}^{′}$$

basis vectors in the InS.

In one example, one-step method is used when N₃≤19 and two-step method is used when N₃>19. In one example,

$${N}_{3}^{′} = ⌈ α {M}_{v} ⌉$$

where α>1 is either fixed (to 2 for example) or configurable.

The codebook parameters used in the DFT based frequency domain compression (Eq. 5) are (L,p_{υ} for υ∈{1,2}, p_{υ} for υ∈{3,4}, β, α, Nₚₕ). The set of values for these codebook parameters are as follows.
L: the set of values is {2,4} in general, except L∈{2,4,6} for rank 1-2, 32 CSI-RS antenna ports, and R=1.
(p_{υ} for υ∈{1,2}, p_{υ} for

$$v ∈ \{ 3 , 4 \} ) ∈ \{ ( \frac{1}{2} , \frac{1}{4} ) , ( \frac{1}{4} , \frac{1}{4} ) , ( \frac{1}{4} , \frac{1}{8} ) \} .$$

$$β ∈ \{ \frac{1}{4} , \frac{1}{2} , \frac{3}{4} \} .$$

$$α = 2$$

$${N}_{ph} = 16.$$

The set of values for these codebook parameters are as in Table 1.

TABLE 1

| | | p_{υ} | | |
|---|---|---|---|---|
| | | υ | υ | |
| paramCombination | L | ϵ {1, 2} | ϵ {3, 4} | β |
| 1 | 2 | ¼ | ⅛ | ¼ |
| 2 | 2 | ¼ | ⅛ | ½ |
| 3 | 4 | ¼ | ⅛ | ½ |
| 4 | 4 | ¼ | ⅛ | ½ |
| 5 | 4 | ¼ | ¼ | ¾ |
| 6 | 4 | ½ | ¼ | ½ |
| 7 | 6 | ¼ | — | ½ |
| 8 | 6 | ¼ | — | ¾ |

In Rel. 17 (further enhanced Type II port selecting codebook),

$$M ∈ \{ 1 , 2 \} , L = \frac{{K}_{1}}{2}$$

where K₁=α×P_{CSIRS}, and codebook parameters (M, α, β) are configured from Table 2.

TABLE 2

| paramCombination-r17 | M | α | β |
|---|---|---|---|
| 1 | 1 | ¾ | ½ |
| 2 | 1 | 1 | ½ |
| 3 | 1 | 1 | ¾ |
| 4 | 1 | 1 | 1 |
| 5 | 2 | ½ | ½ |
| 6 | 2 | ¾ | ½ |
| 7 | 2 | 1 | ½ |
| 8 | 2 | 1 | ¾ |

The above-mentioned framework (Eq. 5) represents the precoding-matrices for multiple (N₃) FD units using a linear combination (double sum) over 2L (or K₁) SD beams/ports and M_{υ} FD beams. This framework can also be used to represent the precoding-matrices in time domain (TD) by replacing the FD basis matrix W_{f} with a TD basis matrix Wₜ, wherein the columns of Wₜ comprises M_{υ} TD beams that represent some form of delays or channel tap locations. Hence, a precoder W^{l} can be described as follows.

$$W = {A}_{l} {C}_{l} {B}_{l}^{H} = {W}_{1} {\tilde{W}}_{2} {W}_{t}^{H} , \qquad ( Eq . 5 A )$$

In one example, the M_{υ} TD beams (representing delays or channel tap locations) are selected from a set of N₃ TD beams, i.e., N₃ corresponds to the maximum number of TD units, where each TD unit corresponds to a delay or channel tap location. In one example, a TD beam corresponds to a single delay or channel tap location. In another example, a TD beam corresponds to multiple delays or channel tap locations. In another example, a TD beam corresponds to a combination of multiple delays or channel tap locations.

In one example, the codebook for the CSI report is according to at least one of the following examples.
In one example, the codebook can be a Rel. 15 Type I single-panel codebook (cf. 5.2.2.2.1, TS 38.214).
In one example, the codebook can be a Rel. 15 Type I multi-panel codebook (cf. 5.2.2.2.2, TS 38.214).
In one example, the codebook can be a Rel. 15 Type II codebook (cf. 5.2.2.2.3, TS 38.214).
In one example, the codebook can be a Rel. 15 port selection Type II codebook (cf. 5.2.2.2.4, TS 38.214).
In one example, the codebook can be a Rel. 16 enhanced Type II codebook (cf. 5.2.2.2.5, TS 38.214).
In one example, the codebook can be a Rel. 16 enhanced port selection Type II codebook (cf. 5.2.2.2.6, TS 38.214).
In one example, the codebook can be a Rel. 17 further enhanced port selection Type II codebook (cf. 5.2.2.2.7, TS 38.214).
In one example, the codebook is a new codebook for C-JT CSI reporting.
   In one example, the new codebook is a decoupled codebook comprising the following components:
      Intra-TRP: per TRP Rel. 16/17 Type II codebook components, i.e., SD basis vectors (W1), FD basis vectors (Wf), W2 components (e.g., SCI, indices of NZ coefficients, and amplitude/phase of NZ coefficients).
      Inter-TRP: co-amplitude and co-phase for each TRP.
   In one example, the new codebook is a joint codebook comprising following components
      Per TRP SD basis vectors (W1)
      Single joint FD basis vectors (Wf)
      Single joint W2 components (e.g., SCI, indices of NZ coefficients, and amplitude/phase of NZ coefficients)

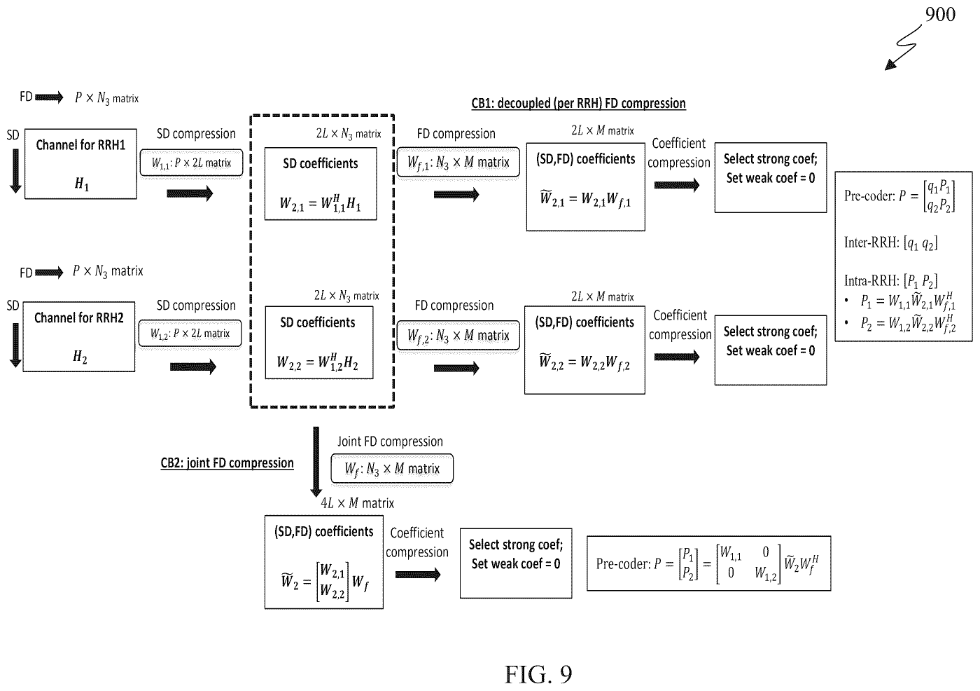

FIG. 9 illustrates two new codebooks 900 according to embodiments of the present disclosure. The embodiment of the two new codebooks 900 illustrated in FIG. 9 is for illustration only. FIG. 9 does not limit the scope of this disclosure to any particular implementation of the two new codebooks 900.

In one example, when the codebook is a legacy codebook (e.g., one of Rel. 15/16/17 NR codebooks, according to one of the examples above), then the CSI reporting is based on a CSI resource set comprising one or multiple NZP CSI-RS resource(s), where each NZP CSI-RS resource comprises CSI-RS antenna ports for all TRPs/RRHs, i.e.,

$$P = {\sum }_{r = 1}^{N} {P}_{r} ,$$

where P is the total number of antenna ports, and Pᵣ is the number of antenna ports associated with r-th TRP. In this case, a TRP corresponds to (or maps to or is associated with) a group of antenna ports.

In one example, when the codebook is a new codebook (e.g., one of the two new codebooks above), then the CSI reporting is based on a CSI resource set comprising one or multiple NZP CSI-RS resource(s).
In one example, each NZP CSI-RS resource comprises CSI-RS antenna ports for all TRPs/RRHs. i.e.,

$$P = {\sum }_{r = 1}^{N} {P}_{r} ,$$

where P is the total number of antenna ports, and Pᵣ is the number of antenna ports associated with r-th TRP. In this case, a TRP corresponds to (or maps to or is associated with) a group of antenna ports.
In one example, each NZP CSI-RS resource corresponds to (or maps to or is associated with) a TRP/RRH.

In the present disclosure, we use N, N_{TRP}, N_{RRH} interchangeably for a number of TRPs/RRHs.

In one embodiment, a UE is configured with an mTRP (or D-MIMO or C-JT) codebook, via e.g., higher layer parameter codebookType set to ‘typeII-r18-cjt’, which is designed based on Rel-16/17 Type-II codebook. For example, The mTRP codebook has a triple-stage structure which can be represented as

$$W = {W}_{1} {W}_{2} {W}_{f}^{H} ,$$

where the component W₁ is used to report/indicate a spatial-domain (SD) basis matrix comprising SD basis vectors, the component W_{f} is used to report/indicate a frequency-domain (FD) basis matrix comprising FD basis vectors, and the component W₂ is used to report/indicate coefficients corresponding to SD and FD basis vectors.

In the present disclosure, beam selection described in the below for W₁ is not only for SD beam selection, (e.g., DFT basis vector selection) but also for port selection, (e.g., vᵢ selection where vᵢ is a vector having 1 for the i-th element and 0 elsewhere.) Port selection and beam selection can be interchangeable when appropriate.

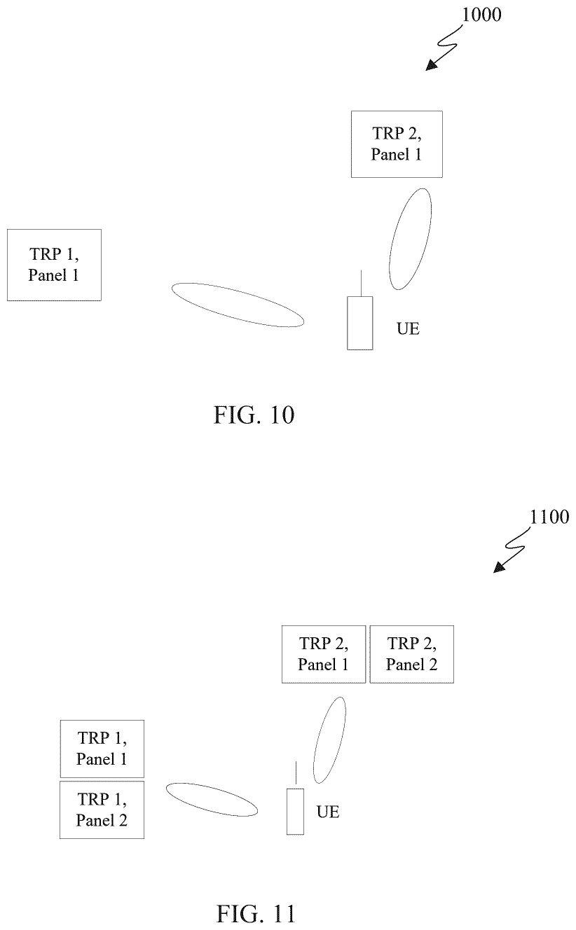

FIG. 10 illustrates an example distributed MIMO system 1000 where each TRP has a single antenna panel according to embodiments of the present disclosure. The embodiment of the distributed MIMO system 1000 where each TRP has a single antenna panel illustrated in FIG. 10 is for illustration only. FIG. 10 does not limit the scope of this disclosure to any particular implementation of the distributed MIMO system 1000 where each TRP has a single antenna panel.

As illustrated in FIG. 10, in one embodiment, each TRP has a single antenna panel. The component W₁ has a block diagonal structure comprising X diagonal blocks, where 1 (co-pol) or 2 (dual-pol) diagonal blocks are associated with each TRP.

In one example, X=N_{TRP} assuming co-polarized (single polarized) antenna structure at each TRP. In one example, when N_{TRP}=2, the components W₁ is given by

$${W}_{1} = [ \begin{matrix}{B}_{1} & 0 \\ 0 & {B}_{2}\end{matrix} ]$$

where B₁ is a basis matrix for the 1^{st} TRP, and B₂ is a basis matrix for the 2^{nd} TRP. In one example, Bᵣ=[b_{r,0}, b_{r,1}, . . . , b_{r,L}_{ᵣ}₋₁] comprises L, columns or beams (or basis vectors) for r-th TRP. In one example, Lᵣ=L for all r values (TRP-common L value), for example, L∈{2,3,4,6}. In one example, Lᵣ can be different across TRPs (TRP-specific L value), for example, Lᵣ can take a value (fixed or configured) from {2,3,4,6}.

In one example, X=2N_{TRP} assuming dual-polarized (cross-polarized) antenna structure at each TRP.

In one example, when N_{TRP}=2, the components W₁ is given by

$${W}_{1} = [ \begin{matrix}{B}_{1} & 0 & 0 & 0 \\ 0 & {B}_{1} & 0 & 0 \\ 0 & 0 & {B}_{2} & 0 \\ 0 & 0 & 0 & {B}_{2}\end{matrix} ]$$

where B₁ is a basis matrix for the 1^{st} TRP and is common (the same) for the two polarizations, which correspond to the first and second diagonal blocks, and B₂ is a basis matrix for the 2^{nd} TRP and is common (the same) for the two polarizations, which correspond to the third and fourth diagonal blocks. In general, (2r−1)-th and (2r)-th diagonal blocks correspond to the two antenna polarizations for the r-th TRP. In one example, Bᵣ=[b_{r,0}, b_{r,1}, . . . , b_{r,L}_{ᵣ}₋₁] comprises Lᵣ columns or beams (or basis vectors) for r-th TRP. In one example, Lᵣ=L for all r values (TRP-common L value), for example, L∈{2,3,4,6}. In one example, Lᵣ can be different across TRPs (TRP-specific L value), for example, Lᵣ can take a value (fixed or configured) from {2,3,4,6}.

In one example, when N_{TRP}=2, the components W₁ is given by

$${W}_{1} = [ \begin{matrix}{B}_{1} & 0 & 0 & 0 \\ 0 & {B}_{2} & 0 & 0 \\ 0 & 0 & {B}_{1} & 0 \\ 0 & 0 & 0 & {B}_{2}\end{matrix} ]$$

where B₁ is a basis matrix for the 1^{st} TRP and is common (the same) for the two polarizations, which correspond to the first and third diagonal blocks, and B₂ is a basis matrix for the 2^{nd} TRP and is common (the same) for the two polarizations, which correspond to the second and fourth diagonal blocks. In general, r-th and (r+N_{TRP})-th diagonal blocks correspond to the two antenna polarizations for the r-th TRP. In one example, Bᵣ=[b_{r,0}, b_{r,1}, . . . , b_{r,L}_{ᵣ}₋₁] comprises Lᵣ columns or beams (or basis vectors) for r-th TRP. In one example, Lᵣ=L for all r values (TRP-common L value), for example, L∈{2,3,4,6}. In one example, Lᵣ can be different across TRPs (TRP-specific L value), for example, Lᵣ can take a value (fixed or configured) from {2,3,4,6}.

In one example, when N_{TRP}=2, the components W₁ is given by

$${W}_{1} = [ \begin{matrix}{B}_{1 , 1} & 0 & 0 & 0 \\ 0 & {B}_{1 , 2} & 0 & 0 \\ 0 & 0 & {B}_{2 , 1} & 0 \\ 0 & 0 & 0 & {B}_{2 , 2}\end{matrix} ]$$

where B_{1,1} and B_{1,2} are basis matrices for the first and second antenna polarizations of the 1^{st} TRP, which correspond to the first and second diagonal blocks, and B_{2,1} and B_{2,2} are basis matrices for the first and second antenna polarizations of the 2^{nd} TRP, which correspond to the third and fourth diagonal blocks. In general, (2r−1)-th and (2r)-th diagonal blocks correspond to the two antenna polarizations for the r-th TRP. In one example, B_{r,p}=[b_{r,p,0}, b_{r,p,1}, . . . , b_{r,p,L}_{_{r,p}}₋₁] comprises L_{r,p} columns or beams (or basis vectors) for p-th polarization of r-th TRP. In one example, L_{r,p}=L for all r and p values (TRP-common and polarization-common L value), for example L∈{2,3,4,6}. In one example, L_{r,p}=Lᵣ for all p values (TRP-specific and polarization-common L value). In one example, L_{r,p}=Lₚ for all r values (TRP-common and polarization-specific L value). In one example, L_{r,p} can be different across TRPs (TRP-specific and polarization-specific L value).

In one example, when N_{TRP}=2, the components W₁ is given by

$${W}_{1} = [ \begin{matrix}{B}_{1 , 1} & 0 & 0 & 0 \\ 0 & {B}_{2 , 1} & 0 & 0 \\ 0 & 0 & {B}_{1 , 2} & 0 \\ 0 & 0 & 0 & {B}_{2 , 2}\end{matrix} ]$$

where B_{1,1} and B_{1,2} are basis matrices for the first and second antenna polarizations of the 1^{st} TRP, which correspond to the first and third diagonal blocks, and B_{2,1} and B_{2,2} are basis matrices for the first and second antenna polarizations of the 2^{nd} TRP, which correspond to the second and fourth diagonal blocks. In general, r-th and (r+N_{TRP})-th diagonal blocks correspond to the two antenna polarizations for the r-th TRP. In one example, B_{r,p}=[b_{r,p,0}, b_{r,p,1}, . . . , b_{r,p,L}_{_{r,p}}₋₁] comprises L_{r,p} columns or beams (or basis vectors) for p-th polarization of r-th TRP. In one example, L_{r,p}=L for all r and p values (TRP-common and polarization-common L value), for example L∈{2,3,4,6}. In one example, L_{r,p}=Lᵣ for all p values (TRP-specific and polarization-common L value). In one example, L_{r,p}=Lₚ for all r values (TRP-common and polarization-specific L value). In one example, L_{r,p} can be different across TRPs (TRP-specific and polarization-specific L value).

In one example,

$$X = {\sum }_{r = 1}^{{N}_{TRP}} {a}_{r} ,$$

where aᵣ=10r co-polarized (single polarized) antenna structure at r-th TRP, and aᵣ=2 for dual-polarized (cross-polarized) antenna structure at r-th TRP.

In one example, when N_{TRP}=2, the components W₁ is given by

$${W}_{1} = [ \begin{matrix}{B}_{1} & 0 & 0 \\ 0 & {B}_{2} & 0 \\ 0 & 0 & {B}_{2}\end{matrix} ]$$

where B₁ is a basis matrix for the 1^{st} TRP, and B₂ is a basis matrix for the 2^{nd} TRP and is common (the same) for the two polarizations, which correspond to the second and third diagonal blocks.

In one example, when N_{TRP}=2, the components W₁ is given by

$${W}_{1} = [ \begin{matrix}{B}_{1} & 0 & 0 \\ 0 & {B}_{2 , 1} & 0 \\ 0 & 0 & {B}_{2 , 2}\end{matrix} ]$$

where B₁ is a basis matrix for the 1^{st} TRP, and B_{2,1} and B_{2,2} are basis matrices for the first and second antenna polarizations of the 2^{nd} TRP, which correspond to the second and third diagonal blocks.

FIG. 11 illustrates an example distributed MIMO system 1100 where each TRP has a multiple antenna panels according to embodiments of the present disclosure. The embodiment of the distributed MIMO system 1100 where each TRP has a multiple antenna panels illustrated in FIG. 11 is for illustration only. FIG. 11 does not limit the scope of this disclosure to any particular implementation of the distributed MIMO system 1100 where each TRP has a multiple antenna panels.

As illustrated in FIG. 11, in one embodiment, each TRP has multiple antenna panels. The component W₁ has a block diagonal structure comprising X diagonal blocks, where N_{g,r} (co-pol) or 2N_{g,r} (dual-pol) diagonal blocks are associated with r-th TRP comprising N_{g,r} panels and N_{g,r}>1 for all values of r. Note N_{g,r}=2 for both TRPs in FIG. 11.

The examples herein can be extended in a straightforward manner in this case (of multiple panels at TRPs) by adding the diagonal blocks corresponding to multiple panels in W₁.

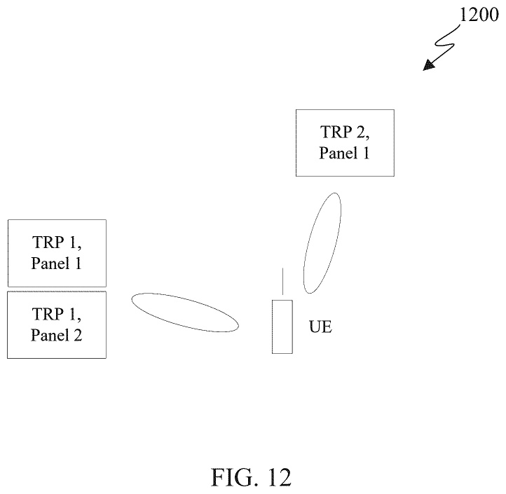

FIG. 12 illustrates an example distributed MIMO system 1200 where each TRP can have a single panel or have multiple panels according to embodiments of the present disclosure. The embodiment of the distributed MIMO system 1200 where each TRP can have a single panel or have multiple panels illustrated in FIG. 12 is for illustration only. FIG. 12 does not limit the scope of this disclosure to any particular implementation of the distributed MIMO system 1200 where each TRP can have a single panel or have multiple panels.

As illustrated in FIG. 12, in one embodiment, each TRP can have a single antenna panel or multiple antenna panels (cf. FIG. 12). The component W₁ has a block diagonal structure comprising X diagonal blocks, where N_{g,r} (co-pol) or 2N_{g,r} (dual-pol) diagonal blocks are associated with r-th TRP comprising N_{g,r} panels, and N_{g,r}=1 when r-th TRP has a single panel and N_{g,r}>1 when r-th TRP has multiple panels.

The examples described herein can be extended in a straightforward manner in this case (of multiple panels at TRPs) by adding the diagonal blocks corresponding to multiple panels in W₁.

In one embodiment, the basis matrices comprising the diagonal blocks of the component W₁ have columns that are selected from a set of oversampled 2D DFT vectors. When the antenna port layout is the same across TRPs, for a given antenna port layout (N₁,N₂) and oversampling factors (O₁,O₂) for two dimensions, a DFT vector v_{l,m} can be expressed as follows.

$${v}_{l , m} = {[ \begin{matrix}{u}_{m} & {e}^{j \frac{2 π l}{{O}_{1} {N}_{1}}} {u}_{m} & … & {e}^{j \frac{2 π l ( {N}_{1} - 1 )}{{O}_{1} {N}_{1}}} {u}_{m}\end{matrix} ]}^{T} \\ {u}_{m} = [ \begin{matrix}1 & {e}^{j \frac{2 π m}{{O}_{2} {N}_{2}}} & … & {e}^{j \frac{2 π m ( {N}_{2} - 1 )}{{O}_{2} {N}_{2}}}\end{matrix} ]$$

where l∈{0, 1, . . . , O₁N₁−1} and m∈{0, 1, . . . , O₂N₂−1}.

When the antenna port layout can be different across TRPs, for a given antenna port layout (N_{1,r},N_{2,r}) and oversampling factors (O_{1,r},O_{2,r}) associated with r-th TRP, a DFT vector Vₗ_{ᵣ}_{,m}_{ᵣ} can be expressed as follows.

$${v}_{{l}_{r} , {m}_{r}} = {[ \begin{matrix}{u}_{{m}_{r}} & {e}^{j \frac{2 π {l}_{r}}{{O}_{1 , r} {N}_{1 , r}}} {u}_{{m}_{r}} & … & {e}^{j \frac{2 π {l}_{r} ( {N}_{1 , r} - 1 )}{{O}_{1 r} {N}_{1 , r}}} {u}_{{m}_{r}}\end{matrix} ]}^{T} \\ {u}_{{m}_{r}} = [ \begin{matrix}1 & {e}^{j \frac{2 π {m}_{r}}{{O}_{2 , r} {N}_{2 , r}}} & … & {e}^{j \frac{2 π {m}_{r} ( {N}_{2 , r} - 1 )}{{O}_{2 , r} {N}_{2 , r}}}\end{matrix} ]$$

where lᵣ∈{0, 1, . . . , O_{1,r}N_{1,r}−1} and mᵣ∈{0, 1, . . . , O_{2,r}N_{2,r}−1}.

In one example, the oversampling factor is TRP-common, hence remains the same across TRPs. For example, e.g., O_{1,r}=O₁=O_{2,r}=O₂=4. In one example, the oversampling factor is TRP-specific, hence is independent for each TRP. For example, O_{1,r}=O_{2,r}=x and x is chosen (fixed or configured) from {2,4,8}.

In one embodiment, the basis matrices comprising the diagonal blocks of the component W₁ have columns that are selected from a set of port selection vectors. When the antenna port layout is the same across TRPs, for a given number of CSI-RS port P_{CSI-RS}, a port selection vector vₘ is a P_{CSI-RS}/2-element column vector containing a value of 1 in element

$$( m mod \frac{{P}_{CSI - RS}}{2} )$$

and zeros elsewhere (where the first element is element 0).

When the antenna port layout can be different across TRPs, for a given number of CSI-RS port P_{CSI-RS,r}, a port selection vector vₘ_{ᵣ} is a P_{CSI-RS,r}/2-element column vector containing a value of 1 in element

$$( {m}_{r} mod \frac{{P}_{CSI - RS , r}}{2} )$$

and zeros elsewhere (where the first element is element 0).

In one embodiment, each TRP can have a single antenna panel or multiple antenna panels (cf. FIG. 12). The component W₁ has a block diagonal structure comprising X=2 diagonal blocks, where N_{g,r} (co-pol) or 2N_{g,r} (dual-pol) diagonal blocks are associated with r-th TRP comprising N_{g,r} panels, and N_{g,r}=1 when r-th TRP has a single panel and N_{g,r}>1 when r-th TRP has multiple panels.

In the following, a term polarization is used to refer to a group/subset of CSI-RS ports. For example, a first antenna polarization corresponds to a first group/subset of CSI-RS ports

$$\{ X , X + 1 , … , X + \frac{{P}_{CSIRS}}{2} + 1 \} ,$$

and a second antenna polarization corresponds to a second group/subset of CSI-RS ports

$$\{ X + \frac{{P}_{CSIRS}}{2} , X + \frac{{P}_{CSIRS}}{2} + 1 , … , X + {P}_{CSIRS} + 1 \} .$$

Here, P_{CSIRS} is a total number of CSI-RS ports the CSI reporting is configured for. In one example, X=3000 is the first CSI-RS port index.

In the following, a TRP can refer to a CSI-RS resource (configured for channel measurement), or a group of CSI-RS ports within a CSI-RS resource (comprising multiple groups of CSI-RS ports).

In one embodiment, the component W₁ is TRP-common port selection (or TRP-common SD basis beam selection), i.e., a same set of ports is selected for all TRPs.

In one example, the component W₁ is TRP-common, polarization common, and layer-common (i.e., the same set of CSI-RS ports is selected/reported for all TRPs, for both antenna polarizations, and for all layers). For example, the W₁ can be expressed as:

$${W}_{1}^{( ℓ )} = {W}_{1} = [ \begin{matrix}B & 0 & 0 \\ 0 & ⋱ & 0 \\ 0 & 0 & B\end{matrix} ] , ℓ = 1 , … , V ,$$

where V is a number of layers,

$${W}_{1}^{( ℓ )}$$

is W₁ of the [symbol] -th layer, B includes a common set of port selection vectors for all TRPs, dual polarized antenna ports, and layers. In one example, when N_{TRP}=2, W₁=diag(B,B,B,B) for dual-polarized case, where diag(A, B, C, . . . ) is the block diagonal matrix composed of A, B, C, . . . matrices in the block diagonal way. In one example B=[b₀, b₁, . . . , b_{L-1}], where L is a number of port selection vectors. When the antenna port layout is the same across TRPs and the number of CSI-RS ports per TRP is P_{CSI-RS} (i.e., P_{CSI-RS,total}=N_{TRP}P_{CSI-RS}), the same L ports are selected out of

$$\frac{{P}_{CSI - RS}}{2}$$

(assuming a dual-polarized case) across TRPs and layers. In this case, an indicator with cardinality (payload)

$$⌈ {log}_{2} ( \begin{matrix}\frac{{P}_{CSI - RS}}{2} \\ L\end{matrix} ) ⌉$$

bits is needed to indicate selected L ports for all layers, and this indicator is reported in CSI reporting, e.g., as a PMI component.

In one example, the component W₁ is TRP-common, polarization common, and layer-specific (i.e., for each layer, a same set of CSI-RS ports is selected/reported for all TRPs, and for both antenna polarizations). For example, the W₁ can be expressed as:

$${W}_{1}^{( ℓ )} = [ \begin{matrix}{B}^{( ℓ )} & 0 & 0 \\ 0 & ⋱ & 0 \\ 0 & 0 & {B}^{( ℓ )}\end{matrix} ] , ℓ = 1 , … , V ,$$

where V is a number of layers,

$${W}_{1}^{( ℓ )}$$

is W₁ of the [symbol] -th layer, [symbol] includes a common set of port selection vectors for all TRPs and dual polarized antenna ports. In one example

$${B}^{( ℓ )} = [ {b}_{0}^{( ℓ )} , {b}_{1}^{( ℓ )} , … , {b}_{L - 1}^{( ℓ )} ] ,$$

where L is a number of port selection vectors. When the antenna port layout is the same across TRPs and the number of CSI-RS ports per TRP is P_{CSI-RS} (i.e., P_{CSI-RS,total}=N_{TRP}P_{CSI-RS}), the same L ports are selected out of

$$\frac{{P}_{CSI - RS}}{2}$$

(assuming a dual-polarized case) across TRPs for each layer. In this case, as an example, an indicator with cardinality (payload)

$$⌈ {log}_{2} ( \begin{matrix}\frac{{P}_{CSI - RS}}{2} \\ L\end{matrix} ) ⌉$$

is needed to indicate selected L ports for each layer, and each indicator is reported in CSI reporting, e.g., as a PMI component.

In another example, L depends on layer (index [symbol] ). In this case,

$${B}^{( ℓ )} = [ {b}_{0}^{( ℓ )} , {b}_{1}^{( ℓ )} , … , {b}_{{L}_{ℓ} - 1}^{( ℓ )} ] ,$$

and thus, in one example, an indicator with cardinality (payload)

$$⌈ {log}_{2} ( \begin{matrix}\frac{{P}_{CSI - RS}}{2} \\ {L}_{ℓ}\end{matrix} ) ⌉$$

is needed to indicate selected [symbol] ports for each layer [symbol] .

In one example, the component W₁ is TRP-common, polarization specific, and layer-common (i.e., for each polarization, a same set of CSI-RS ports is selected/reported for all TRPs and for all layers. For example, the W₁ can be expressed as:

$${W}_{1}^{( ℓ )} = {W}_{1} = [ \begin{matrix}{B}_{0 , 1} & 0 & 0 & 0 & 0 \\ 0 & {B}_{0 , 2} & 0 & 0 & 0 \\ 0 & 0 & ⋱ & 0 & 0 \\ 0 & 0 & 0 & {B}_{0 , 1} & 0 \\ 0 & 0 & 0 & 0 & {B}_{0 , 2}\end{matrix} ] , ℓ = 1 , … , V ,$$

where V is a number of layers,

$${W}_{1}^{( ℓ )}$$

is W₁ if the [symbol] -th layer, B_{0,k} includes a common set of port selection vectors for all TRPs and layers for k-th polarization (where k=1, 2). In one example B_{0,k}=[b_{0,k}, b_{1,k}, . . . , b_{L-1,k}], where L is a number of port selection vectors, for k-th polarization.

When the antenna port layout is the same across TRPs and the number of CSI-RS ports per TRP is P_{CSI-RS} (i.e., P_{CSI-RS,total}=N_{TRP}P_{CSI-RS}), the same L ports are selected out of

$$\frac{{P}_{CSI - RS}}{2}$$

(assuming a dual-polarized case) across TRPs and layers for each opalization. In this case, as an example, an indicator with cardinality (payload)

$$⌈ {log}_{2} ( \begin{matrix}\frac{{P}_{CSI - RS}}{2} \\ L\end{matrix} ) ⌉$$

is needed to indicate selected L ports for all TRPs and layers for each polarization, and each indicator is reported in CSI reporting, e.g., as a PMI component.

In another example, L depends on polarization (index k). In this case, B_{0,k}=[b_{0,k}, b_{1,k}, . . . , b_{L}_{ₖ}_{-1,k}], and thus, in one example, an indicator with cardinality (payload)

$$⌈ {log}_{2} ( \begin{matrix}\frac{{P}_{CSI - RS}}{2} \\ {L}_{k}\end{matrix} ) ⌉$$

is needed to indicate selected Lₖ ports for each polarization k.

In one example, the component W₁ is TRP-common, polarization-specific, and layer-specific (i.e., for each polarization, for each layer, a same set of CSI-RS ports is selected/reported for all TRPs. For example, the W₁ can be expressed as:

$${W}_{1}^{( ℓ )} = [ \begin{matrix}{B}_{0 , 1}^{( ℓ )} & 0 & 0 & 0 & 0 \\ 0 & {B}_{0 , 2}^{( ℓ )} & 0 & 0 & 0 \\ 0 & 0 & ⋱ & 0 & 0 \\ 0 & 0 & 0 & {B}_{0 , 1}^{( ℓ )} & 0 \\ 0 & 0 & 0 & 0 & {B}_{0 , 2}^{( ℓ )}\end{matrix} ] , ℓ = 1 , ⋯ , V ,$$

where V is a number of layers,

$${W}_{1}^{( ℓ )}$$

is W₁ of the [symbol] -th layer,

$${B}_{0 , k}^{( ℓ )}$$

includes a common set or port selection vectors for all TRPs for each layer for k-th polarization (where k=1, 2). In one example

$${B}_{0 , k}^{( ℓ )} = [ {b}_{0 , k}^{( ℓ )} , {b}_{1 , k}^{( ℓ )} , ⋯ , {b}_{L - 1 , k}^{( ℓ )} ] ,$$

where L is a number of port selection vectors for layer [symbol] for k-th polarization.

When the antenna port layout is the same across TRPs and the number of CSI-RS ports per TRP is P_{CSI-RS} (i.e., P_{CSI-RS,total}=N_{TRP}P_{CSI-RS}), the same L ports are selected out of

$$\frac{{P}_{CSI - RS}}{2}$$

(assuming a dual-polarized case) across TRPs for each layer for each polarization. In this case, as an example, an indicator with cardinality (payload)

$$⌈ {log}_{2} ( \begin{matrix}\frac{{P}_{CSI - RS}}{2} \\ L\end{matrix} ) ⌉$$

is needed to indicate selected L ports for all TRPs for each layer for each polarization, and each indicator is reported in CSI reporting, e.g., as a PMI component.

In another example, L depends on polarization k and/or layer [symbol] . In one example,

$${B}_{0 , k}^{( ℓ )} = [ {b}_{0 , k}^{( ℓ )} , {b}_{1 , k}^{( ℓ )} , ⋯ , {b}_{{L}_{k} - 1 , k}^{( ℓ )} ] ,$$

and thus, in one example, an indicator with cardinality (payload)

$$⌈ {log}_{2} ( \begin{matrix}\frac{{P}_{CSI - RS}}{2} \\ {L}_{k}\end{matrix} ) ⌉$$

is needed to indicate selected Lₖ ports for each polarization k. In another example,

$${B}_{0 , k}^{( ℓ )} = [ {b}_{0 , k}^{( ℓ )} , {b}_{1 , k}^{( ℓ )} , ⋯ , {b}_{{L}_{ℓ} - 1 , k}^{( ℓ )} ] ,$$

and thus, in one examples, an indicator with cardinality (payload)

$$⌈ {log}_{2} ( \begin{matrix}\frac{{P}_{CSI - RS}}{2} \\ {L}_{ℓ}\end{matrix} ) ⌉$$

is needed to indicate selected [symbol] ports for each layer [symbol] . In another example,

$${B}_{0 , k}^{( ℓ )} = [ {b}_{0 , k}^{( ℓ )} , {b}_{1 , k}^{( ℓ )} , ⋯ , {b}_{{L}_{ℓ ( i )} - 1 , k}^{( ℓ )} ] ,$$

and thus, in one example, an indicator with cardinality (payload)

$$⌈ {log}_{2} ( \begin{matrix}\frac{{P}_{CSI - RS}}{2} \\ {L}_{ℓ ( k )}\end{matrix} ) ⌉$$

is needed to indicate selected [symbol] ports for each layer [symbol] for each polarization k.

In one embodiment, the component W₁ is TRP-specific port selection (or TRP-specific SD basis beam selection), i.e., an independent set of ports is selected/reported for each TRP.

In the present disclosure, TRP index i can be determined based on CSI-RS port number, CSI-RS resource IDs. In another example, TRP index i can be determined based on RSRP/RSRQ/SINR (which can be, e.g., based on UE measurement), and can be configured by NW or reported by UE.

In one example, the component W₁ is TRP-specific, polarization common, and layer-common (i.e., for each TRP, a common set of CSI-RS ports is selected/reported for all layers, and for both antenna polarizations). For example, the W₁ can be expressed as:

$${W}_{1}^{( ℓ )} = {W}_{1} = [ \begin{matrix}{B}_{1} & 0 & 0 & 0 & 0 \\ 0 & {B}_{1} & 0 & 0 & 0 \\ 0 & 0 & ⋱ & 0 & 0 \\ 0 & 0 & 0 & {B}_{{N}_{TRP}} & 0 \\ 0 & 0 & 0 & 0 & {B}_{{N}_{TRP}}\end{matrix} ] , ℓ = 1 , ⋯ , V ,$$

where V is a number of layers,

$${W}_{1}^{( ℓ )}$$

is W₁ of the [symbol] -th layer, Bᵢ includes an independent set of port selection vectors for TRP i but the set is the same across polarizations and layers. In one example, when N_{TRP}=2, W₁=diag(B₁, B₁, B₂, B₂) for dual-polarized case, where diag(A, B, C, . . . ) is the block diagonal matrix composed of A, B, C, . . . matrices in the block diagonal way. In one example Bᵢ=[b_{i,0}, b_{i,1}, . . . , b_{i,L-1}], where L is a number of port selection vectors for TRP i. When the antenna port layout is the same across TRPs and the number of CSI-RS ports per TRP is P_{CSI-RS} (i.e., P_{CSI-RS,total}=N_{TRP}P_{CSI-RS}), the same L ports are selected out

$$\frac{{P}_{CSI - RS}}{2}$$

(assuming a dual-polarized case) across polarizations and layers. In this case, an indicator with cardinality (payload)

$$⌈ {log}_{2} ( \begin{matrix}\frac{{P}_{CSI - RS}}{2} \\ L\end{matrix} ) ⌉$$

is needed to indicate selected L ports for all layers and polarizations for each TRP, and each indicator is reported in CSI reporting. In another example, L depends on TRP.

The reporting of the (indices) of the port selection vectors for all TRPs can be via one joint indicator, or via multiple (separate) indicators, one for each TRP.

In one example, Bᵢ includes Lᵢ port selection vectors (TRP-specific the number of port selection vectors), i.e., Bᵢ=[b_{i,0}, b_{i,1}, . . . , b_{i,L}_{_{i−1}}], where Lᵢ is a number of port selection vectors for TRP i. In one example, L₁=2, L₂=4, and so on.
In one example, Lᵢs are selected from a same set of [symbol] . For example, [symbol] ={1,2}, [symbol] ={1,2,3}, or [symbol] ={1,2,3,4}.
In one example, Lᵢ for each TRP i is selected from a corresponding set of [symbol] ᵢ. For example, [symbol] ₁={1,2,3,4}, [symbol] ₂={1,2}, and so on.
In another example, (L₁, . . . , L_{N}_{_{TRP}}) are selected from a set [symbol] ⱼₒᵢₙₜ for joint indicator. For example, when N_{TRP}=2, [symbol] ⱼₒᵢₙₜ={(2,2), (2,3), (2,4), (3,4)}.

In one example, Lᵢs are configured by NW via RRC, MAC-CE, and/or DCI. In one example, some of Lᵢs are configured and the others are fixed or determined based on configured values. In one example, a UE determines and reports L₁ and/or L₂, and so on.

In one example, B₁ and B₂ include L₁ port selection vectors and B₃ and B₄ include L₂ port selection vectors (TRP-pair-specific the number of port selection vectors), i.e., Bᵢ=[b_{i,0}, b_{i,1}, . . . , b_{i,L}_{₁}₋₁] for i∈{1,2} and Bᵢ=[b_{i,0}, b_{i,1}, . . . , b_{i,L}_{₂}₋₁] for i∈{3,4}. In one example, (L₁, L₂)=(4,2),
In one example, L₁ and L₂ are selected from a same set of [symbol] . For example, [symbol] ={1,2}, [symbol] ={1,2,3}, or [symbol] ={1,2,3,4}.
In one example, Lᵢ is selected from a corresponding set of [symbol] ᵢ. For example, [symbol] ₁={1,2,3,4}, [symbol] ₂={1,2}.
In another example, (L₁, L₂) are selected from a set [symbol] ⱼₒᵢₙₜ for joint indicator. For example, [symbol] ⱼₒᵢₙₜ={(2,2), (2,3), (2,4), (3,4)}.

In one example, Lᵢs are configured by NW via RRC, MAC-CE, and/or DCI. In one example, one of Lᵢs are configured and the other is fixed or determined based on configured values. In one example, a UE determines and reports L₁ and/or L₂.

In one example, when N_{TRP}≤x, one L value is used for all TRPs, and when N_{TRP}>x, two L values are used, where x is a threshold value, which can be fixed e.g., 2 or configured.

For example, if x is fixed to 2, we can have
Bᵢ=[b_{i,0}, b_{i,1}, . . . , b_{i,L-1}] for i=1, 2 when N_{TRP}=2.
Bᵢ=[b_{i,0}, b_{i,1}, . . . , b_{i,L}_{₁}₋₁] for i=1, 2, Bᵢ=[b_{i,0}, b_{i,1}, . . . , b_{i,L}_{₂}₋₁] for i=3,4, when N_{TRP}=3 or 4.

In one example, (L₁,L₂)=(2,4), (3,4), or another pair value.

In one example, L₁ and L₂ are selected from a same set of [symbol] . For example, [symbol] ={1,2}, [symbol] ={1,2,3}, or [symbol] ={1,2,3,4}.

In one example, Lᵢ is selected from a corresponding set of [symbol] ᵢ. For example, [symbol] ₁={1,2,3,4}, [symbol] ₂={1,2}.

In another example, (L₁, L₂) are selected from a set [symbol] ′ for joint indicator. For example, [symbol] ′={(2,2), (2,3), (2,4), (3,4)}.

In one example, Lᵢs are configured by NW via RRC, MAC-CE, and/or DCI. In one example, one of Lᵢs are configured and the other is fixed or determined based on configured values. In one example, a UE determines and reports L₁ and/or L₂.

In one example, a total number of port selection vectors for all TRPs is Lₛᵤₘ.

In one example, Lₛᵤₘ is configured by NW via RRC, MAC-CE, and/or DCI. In another example, Lₛᵤₘ is fixed, e.g., Lₛᵤₘ=4. In one example, Lₛᵤₘ is determined by UE and reported.

In one example, Lₛᵤₘ is selected from a set [symbol] ₛᵤₘ, e.g., [symbol] ₛᵤₘ={4,5,6,7}.

In one example, when N_{TRP}≤x, Lₛᵤₘ is a first value, and when N_{TRP}>X, Lₛᵤₘ is a second value, where x is a threshold value, which can be fixed e.g., 2 or configured. In one example, (the first value, the second value) are configured or fixed.

In one example, Lᵢ value is layer-common and rank-common.

In one example, L′ value is layer-common and rank-common.

In one example, Lᵢ value is layer-specific and rank-common.

In one example, L′ value is layer-specific and rank-common.

In one example, Lᵢ value is layer-common and rank-specific.

In one example, L′ value is layer-common and rank-specific.

In one example, Lᵢ value is layer-specific and rank-specific.

In one example, L′ value is layer-specific and rank-specific.

In the above examples, TRP index i can be determined based on CSI-RS port number, CSI-RS resource IDs. In another example, TRP index i can be determined based on RSRP/RSRQ/SINR (which can be, e.g., based on UE measurement), and can be configured by NW or reported by UE.

In one example, the component W₁ is TRP-specific, polarization common, and layer-specific (i.e., for each TRP and for each layer, a common set of CSI-RS ports is selected/reported for both antenna polarizations). For example, the W₁ can be expressed as:

$${W}_{1}^{( ℓ )} = [ \begin{matrix}{B}_{1}^{( ℓ )} & 0 & 0 & 0 & 0 \\ 0 & {B}_{1}^{( ℓ )} & 0 & 0 & 0 \\ 0 & 0 & ⋱ & 0 & 0 \\ 0 & 0 & 0 & {B}_{{N}_{TRP}}^{( ℓ )} & 0 \\ 0 & 0 & 0 & 0 & {B}_{{N}_{TRP}}^{( ℓ )}\end{matrix} ] , ℓ = 1 , ⋯ , V ,$$

where V is a number of layers,

$${W}_{1}^{( ℓ )}$$

is W₁ of the [symbol] -th layer,

$${B}_{i}^{( ℓ )}$$

includes an independent set of port selection vectors for TRP i for layer [symbol] but the set is the same across polarizations. In one example

$${B}_{i} = [ {b}_{i , 0}^{( ℓ )} , {b}_{i , 1}^{( ℓ )} , ⋯ , {b}_{i , L - 1}^{( ℓ )} ] ,$$

where L is a number of port selection vectors for TRP i for layer [symbol] . When the antenna port layout is the same across TRPs and the number of CSI-RS ports per TRP is P_{CSI-RS} (i.e., P_{CSI-RS,total}=N_{TRP}P_{CSI-RS}), the same L ports are selected out of

$$\frac{{P}_{CSI - RS}}{2}$$

(assuming a dual-polarized case) across polarizations. In this case, an indicator with cardinality (payload)

$$⌈ {log}_{2} ( \begin{matrix}\frac{{P}_{CSI - RS}}{2} \\ L\end{matrix} ) ⌉$$

is needed to indicate selected L ports for all polarizations for each TRP i for each layer [symbol] , and each indicator is reported in CSI reporting. In another example, L depends on TRP and/or layer.

In one or more examples, L and relevant parameters can be extended according to one or more examples described herein.

In one example, the component W₁ is TRP-specific, polarization-specific, and layer-common (i.e., for each TRP and for each polarization, a common set of CSI-RS ports is selected/reported for all layers). For example, the W₁ can be expressed as:

$${W}_{1}^{( ℓ )} = {W}_{1} = [ \begin{matrix}{B}_{1 , 1} & 0 & 0 & 0 & 0 \\ 0 & {B}_{1 , 2} & 0 & 0 & 0 \\ 0 & 0 & ⋱ & 0 & 0 \\ 0 & 0 & 0 & {B}_{{N}_{TRP , 1}} & 0 \\ 0 & 0 & 0 & 0 & {B}_{{N}_{TRP , 2}}\end{matrix} ] , ℓ = 1 , ⋯ , V ,$$

where V is a number of layers,

$${W}_{1}^{( ℓ )}$$

is W₁ of the [symbol] -th layer, B_{i,k} includes an independent set of port selection vectors for TRP i for polarization k but the set is the same across layers. In one example B_{i,k}=[b_{i,0,k}, b_{i,1,k}, . . . , b_{i,L-1,k}], where L is a number of port selection vectors for TRP i for polarization k. When the antenna port layout is the same across TRPs and the number of CSI-RS ports per TRP is P_{CSI-RS} (i.e., P_{CSI-RS,total}=N_{TRP}P_{CSI-RS}), the same L ports are selected out of

$$\frac{{P}_{CSI - RS}}{2}$$

(assuming a dual-polarized case) across layers. In this case, an indicator with cardinality (payload)

$$⌈ {log}_{2} ( \begin{matrix}\frac{{P}_{CSI - RS}}{2} \\ L\end{matrix} ) ⌉$$

is needed to indicate selected L ports for all layers for each TRP i for each polarization k, and each indicator is reported in CSI reporting. In another example, L depends on TRP and/or polarization.

In one or more examples, L and relevant parameters can be extended according to one or more examples described herein.

In one example, the component W₁ is TRP-specific, polarization-specific, and layer-specific (i.e., for each TRP, for each polarization, and for each layer, a set of CSI-RS ports is selected/reported). For example, the W₁ can be expressed as:

$${W}_{1}^{( ℓ )} = [ \begin{matrix}{B}_{1 , 1}^{( ℓ )} & 0 & 0 & 0 & 0 \\ 0 & {B}_{1 , 2}^{( ℓ )} & 0 & 0 & 0 \\ 0 & 0 & ⋱ & 0 & 0 \\ 0 & 0 & 0 & {B}_{{N}_{TRP , 1}}^{( ℓ )} & 0 \\ 0 & 0 & 0 & 0 & {B}_{{N}_{TRP , 2}}^{( ℓ )}\end{matrix} ] , ℓ = 1 , ⋯ , V ,$$

where V is a number of layers,

$${W}_{1}^{( ℓ )}$$

is W₁ of the [symbol] -th layer,

$${B}_{i , k}^{( ℓ )}$$

includes an independent set of port selection vectors for TRP i for polarization k for layer [symbol] . In one example

$${B}_{i , k}^{( ℓ )} = [ {b}_{i , 0 , k}^{( ℓ )} , {b}_{i , 1 , k}^{( ℓ )} , … , {b}_{i , L - 1 , k}^{( ℓ )} ] ,$$

where L is a number of port selection vectors for TRP i for polarization k for layer [symbol] . When the antenna port layout is the same across TRPs and the number of CSI-RS ports per TRP is P_{CSI-RS} (i.e., P_{CSI-RS,total}=N_{TRP}P_{CSI-RS}), L ports are independently selected out of

$$\frac{{P}_{CSI - RS}}{2}$$

(assuming a dual-polarized case) for TRP/polarization/layer. In this case, an indicator with cardinality (payload)

$$⌈ {log}_{2} ( \begin{matrix}\frac{{P}_{CSI - RS}}{2} \\ L\end{matrix} ) ⌉$$

is needed to indicate selected L ports for each TRP i for each polarization k for each layer [symbol] , and each indicator is reported in CSI reporting. In another example, L depends on TRP, polarization, and/or layer.

In one or more examples, L and relevant parameters can be extended according to one or more examples described herein.

In one embodiment, the component W₁ is TRP-specific port selection (or TRP-specific SD basis beam selection) under a constraint that a total number of selected ports is Lₛᵤₘ. In this embodiment, under the constraint that a total number of selected ports is Lₛᵤₘ, Bᵢ includes Lᵢ port selection vectors for TRP i, where Lₛᵤₘ=ΣᵢLᵢ.

In one example, Lₛᵤₘ is configured by NW via RRC, MAC-CE, and/or DCI. In another example, Lₛᵤₘ is fixed, e.g., Lₛᵤₘ=4. In one example, Lₛᵤₘ is determined by UE and reported.

In one example, Lₛᵤₘ is selected from a set [symbol] ₛᵤₘ, e.g., [symbol] ₛᵤₘ={4,5,6,7}.

In one example, when N_{TRP}≤x, Lₛᵤₘ is a first value, and when N_{TRP}>X, Lₛᵤₘ is a second value, where x is a threshold value, which can be fixed e.g., 2 or configured. In one example, (the first value, the second value) are configured or fixed.

In one example, the component W₁ is TRP-specific, polarization-common, and layer-common.

In one example, the component W₁ is TRP-specific, polarization-common, and layer-specific. In this case, Lₛᵤₘ can depend on layer [symbol] , e.g., Lₛᵤₘ( [symbol] ). In another example, Lₛᵤₘ is fixed for all layers.

In one example, the component W₁ is TRP-specific, polarization-specific, and layer-common. Lₛᵤₘ can depend on polarization k, e.g., Lₛᵤₘ(k). In another example, Lₛᵤₘ is fixed for all polarizations.

In one example, the component W₁ is TRP-specific, polarization-specific, and layer-specific. Lₛᵤₘ can depend on layer [symbol] and/or polarization k, e.g., Lₛᵤₘ( [symbol] , k). In another example, Lₛᵤₘ is fixed for all layers and polarizations.

In one embodiment, the component W₁ is TRP-pair common port selection (or TRP-pair common SD basis beam selection), i.e., a same set of ports is selected for each TRP pair.

In one example, the component W₁ is TRP-pair common, polarization-common, and layer-common. For example, when N_{TRP}=4, two TRP pairs exist. In this case, the W₁ can be expressed as

$${W}_{1}^{( ℓ )} = {W}_{1} = diag ( {B}_{12} , {B}_{12} , {B}_{12} , {B}_{12} , {B}_{34} , {B}_{34} , {B}_{34} , {B}_{34} ) ,$$

where B₁₂=[b_{12,0}, . . . , b_{12,L-1}] and B₃₄=[b_{34,0}, . . . , b_{34,L-1}] are port selection vectors for TRP pairs (i.e., TRPs 1 and 2, TRPs 3 and 4), respectively. In this case, an indicator with cardinality

$$⌈ {log}_{2} ( \begin{matrix}\frac{{P}_{CSI - RS}}{2} \\ L\end{matrix} ) ⌉$$

is needed to indicate selected L ports for each TRP pair, and each indicator is used in CSI reporting.

In one example, the component W₁ is TRP-pair common, polarization-common, and layer-specific.

In one example, the component W₁ is TRP-pair common, polarization-specific, and

layer-common.

In one example, the component W₁ is TRP-pair common, polarization-specific, and layer-specific.

In one embodiment, the component W₁ includes port selection vectors for a subset of the TRPs.

In one embodiment, for the subset of the TRPs, the component W₁ is TRP-common port selection (or TRP-common SD basis beam selection), i.e., a same set of ports is selected for all TRPs.

In one example, the component W₁ is TRP-common, polarization-common, and layer-common.

In one example, the component W₁ is TRP-common, polarization-common, and layer-specific.

In one example, the component W₁ is TRP-common, polarization-specific, and layer-common.

In one example, the component W₁ is TRP-common, polarization-specific, and layer-specific.

In one embodiment, for the subset of the TRPs, the component W₁ is TRP-specific port selection (or TRP-specific SD basis beam selection), i.e., an independent set of ports is selected for each TRP.

In one example, the component W₁ is TRP-specific, polarization-common, and layer-common.

In one example, the component W₁ is TRP-specific, polarization-common, and layer-specific.

In one example, the component W₁ is TRP-specific, polarization-specific, and layer-common.

In one example, the component W₁ is TRP-specific, polarization-specific, and layer-specific.

Similar to Rel-17 Type-II port-selection codebook, the number L of selected ports can be parameterized by α with the number of CSI-RS ports. For example, L=2K₁ and K₁=αP_{CSIRS}, where α takes a value from {¼, ½, ¾, 1}.

In one embodiment, the component W_{f} is according to at least one of the following examples.

In one example, the component W_{f} is TRP-common and layer-common, i.e., one common W_{f} is reported for all TRPs and for all layers (when number of layers or rank>1).

In one example, the component W_{f} is TRP-common and layer-specific, i.e., for each layer l∈{1, . . . , υ}, where υ is a rank value or number of layers, one common W_{f} is reported for all TRPs.

In one example, the component W_{f} is TRP-specific and layer-common, i.e., for each TRP r∈{1, . . . , N_{TRP}}, one common W_{f} is reported for all layers.

In one example, the component W_{f} is TRP-specific and layer-specific, i.e., for each TRP r∈{1, . . . , N_{TRP}} and for each layer l∈{1, . . . , υ}, one W_{f} is reported.

In one example, the component W_{f} is TRP-pair-common and layer-common, i.e., one common W_{f} is reported for each TRP pair and for all layers (when number of layers or rank>1).

In one example, the component W_{f} is TRP-pair-common and layer-specific, i.e., for each layer l∈{1, . . . , υ}, where υ is a rank value or number of layers, one common W_{f} is reported for each TRP pair.

In one embodiment, let W_{f} comprise M_{υ} columns for a given rank value υ. The value of M_{υ} can be fixed (e.g., 1 or 2). or configured via higher layer (RRC) signaling (similar to R16 enhanced Type II codebook) or reported by the UE as part of the CSI report). The value of M_{υ} and some other parameters (e.g., α, β as Rel-17 Type-II CB) can be jointly parameterized and the joint parameter can be configured by NW. The value of M_{υ} is according to at least one of the following examples. In one example, M_{υ}∈{1,2} when W₁ comprises port selection vectors, i.e., when the UE is configured with a port selection Type II codebook, as described in this disclosure. In one example,

$${M}_{υ} = ⌈ \frac{{p}_{υ} {N}_{3}}{R} ⌉$$

when W₁ comprises DFT basis vectors, i.e., when the UE is configured with a regular Type II codebook, as described in this disclosure, and as in section 5.2.2.2.5 TS 38.214.

In one example, the value of M_{υ} is TRP-common, layer-common, and RI-common. The same M_{υ} value is used common for all values of N_{TRP}, υ, and layers=1, . . . , υ.

In one example, the value of M_{υ} is TRP-common, layer-common, and RI-specific. For each RI value υ, the same M_{υ} value is used common for all values of N_{TRP} and layers=1, . . . , υ.

In one example, the value of M_{υ} is TRP-common, layer-specific, and RI-common. For each layers=1, . . . , υ, the same M_{υ} value is used common for all values of N_{TRP} and υ.

In one example, the value of M_{υ} is TRP-specific, layer-common, and RI-common. For each TRP r∈{1, . . . , N_{TRP}}, the same M_{υ} value is used common for all values of υ and layers=1, . . . , υ.

In one example, the value of M_{υ} is TRP-common, layer-specific, and RI-specific.

In one example, the value of M_{υ} is TRP-specific, layer-specific, and RI-common.

In one example, the value of M_{υ} is TRP-specific, layer-common, and RI-specific.

In one example, the value of M_{υ} is TRP-specific, layer-specific, and RI-specific.

In one example, the value of M_{υ} is TRP-pair-common, layer-common, and RI-common.

In one example, the value of M_{υ} is TRP-pair-common, layer-common, and RI-specific.

In one example, the value of M_{υ} is TRP-pair-common, layer-specific, and RI-common.

In one example, the value of M_{υ} is TRP-pair-common, layer-specific, and RI-specific.

In one embodiment, the columns of W_{f} are selected from a set of oversampled DFT vectors. When the antenna port layout is the same across TRPs, for a given N₃ and oversampling factors O₃, a DFT vector y_{f} can be expressed as follows.

$${y}_{f} = [ \begin{matrix}1 & {e}^{j \frac{2 π f}{{O}_{3} {N}_{3}}} & … & {e}^{j \frac{2 π f ( {N}_{3} - 1 )}{{O}_{3} {N}_{3}}}\end{matrix} ]$$

where f∈{0, 1, . . . , O₃N₃−1}.

When N₃ value can be different across TRPs, for r-th TRP, a DFT vector y_{f}_{ᵣ} can be expressed as follows.

$${y}_{{f}_{r}} = [ \begin{matrix}1 & {e}^{j \frac{2 π {f}_{r}}{{O}_{3 , r} {N}_{3 , r}}} & … & {e}^{j \frac{2 π {f}_{r} ( {N}_{3} - 1 )}{{O}_{3} {N}_{3}}}\end{matrix} ]$$

where fᵣ∈{0, 1, . . . , O₃,N_{3,r}−1}.

In one example, the oversampling factor is TRP-common, hence remains the same across TRPs. For example, e.g., O_{3,r}=O₃. In one example, the oversampling factor is TRP-specific, hence is independent for each TRP. For example, O_{3,r}=x and x is chosen (fixed or configured) from {1,2,4,8}. In one example, the oversampling factor=1. Then, the DFT vector y_{f} can be expressed as follows.

$${y}_{f} = [ \begin{matrix}1 & {e}^{j \frac{2 π f}{{N}_{3}}} & … & {e}^{j \frac{2 π f ( {N}_{3} - 1 )}{{N}_{3}}}\end{matrix} ] .$$

In one embodiment, the columns of W_{f} are selected from a set of port selection vectors. When N₃ value is the same across TRPs, for a given N₃ value, a port selection vector vₘ is a N₃-element column vector containing a value of 1 in element (m mod N₃) and zeros elsewhere (where the first element is element 0).

When N₃ value can be different across TRPs, for a given N_{3,r} value, a port selection vector vₘ_{ᵣ} is a N₃-element column vector containing a value of 1 in element (m, mod N₃) and zeros elsewhere (where the first element is element 0).

In one embodiment, the FD bases (or FD basis vectors) used for W_{f} quantitation are limited within a single window/set with size N configured to the UE.

In one example, FD bases (or FD basis vectors) in the window are consecutive from an orthogonal DFT matrix.

In one example, FD bases (or FD basis vectors) in the set can be consecutive/non-consecutive, and are selected freely by NW from an orthogonal DFT matrix.

In one embodiment, a UE is configured with an mTRP (or D-MIMO or C-JT) codebook, via e.g., higher layer parameter codebookType set to ‘typeII-r18-cjt’ or ‘typeII-PortSelection-r18-cjt’, which is designed based on Rel-16/17 Type-II codebook. For example, The mTRP codebook has a triple-stage structure which can be represented as

$$W = {W}_{1} {W}_{2} {W}_{f}^{H} ,$$

where the component W₁ is used to report/indicate a spatial-domain (SD) basis matrix comprising SD basis vectors, the component W_{f} is used to report/indicate a frequency-domain (FD) basis matrix comprising FD basis vectors, and the component W₂ is used to report/indicate coefficients corresponding to SD and FD basis vectors.

In one embodiment, the components W₁ and W_{f} are determined/reported in a TRP-common manner, i.e., W1 and Wf are the same for all TRPs (hence only one W1 and one Wf are reported regardless of the value of N_{TRP}). For example, for the mTRP codebook

$$W = {W}_{1} {W}_{2} {W}_{f}^{H}$$

the precoding matrices can be represented as

$$W = [ \begin{matrix}{W}_{1} & 0 & 0 \\ 0 & ⋱ & 0 \\ 0 & 0 & {W}_{1}\end{matrix} ] [ \begin{matrix}{W}_{2 , 1} \\ ⋮ \\ {W}_{2 , {N}_{TRP}}\end{matrix} ] \\ {W}_{f}^{H} = [ \begin{matrix}\begin{matrix}{W}_{1} {W}_{2 , 1} {W}_{f}^{H} \\ ⋮\end{matrix} \\ {W}_{1} {W}_{2 , {N}_{TRP}} {W}_{f}^{H}\end{matrix} ] .$$

where W_{2,r} is the W₂ component for the r-th TRP, where r=1, . . . , N_{TRP}.

For example, similar to the Rel-16 Type-II codebook, for the component W₁, vectors,

$${v}_{{m}_{1}^{( i )} , {m}_{2}^{( i ) ,}} i = 0 , 1 , … , L - 1 ,$$

are identified by the indices q₁, q₂, n₁, n₂, indicated by i_{1,1}, i_{1,2}, obtained as in 5.2.2.2.3 [9], where the values of C(x, y) are given in Table 5.2.2.2.5-4 in [9].

For example, similar to the Rel-17 Type-II codebook [9], for the component W₁, K₁=αP_{CSI-RS} ports are selected from P_{CSI-RS} ports based on L vectors, vₘ_{⁽ⁱ⁾}, i=0, 1, . . . , L−1, where L=K₁/2, which are identified by [9]

$$m = [ {m}^{( 0 )} … {m}^{( L - 1 )} ] \\ {m}^{( i )} ∈ \{ 0 , 1 , … , \frac{{P}_{CSI - RS}}{2} - 1 \}$$

which are indicated by the index i_{1,2}, where

$${i}_{1 , 2} ∈ \{ 0 , 1 , … , ( \begin{matrix}{P}_{CSI - RS} / 2 \\ L\end{matrix} ) - 1 \} .$$

For example, similar to the Rel-16 Type-II codebook [9], for the component W_{f},

$${M}_{υ} = ⌈ {p}_{υ} \frac{{N}_{3}}{R} ⌉ vector , {[ {y}_{0 , l}^{( f )} , {y}_{1 , l}^{( f )} , … , {y}_{{N}_{3} - 1 , l}^{( f )} ]}^{T} , f = 0 , 1 , … , {M}_{υ} - 1 ,$$

are identified by Mᵢₙᵢₜᵢₐₗ (for N₃>19) and n_{3,l} (l=1, . . . , υ) where

$${M}_{initial} ∈ \{ - 2 {M}_{v} + 1 , - 2 {M}_{v} + 2 , … , 0 \} \\ {n}_{3 , l} = [ {n}_{3 , l}^{( 0 )} , … , {n}_{3 , l}^{( {M}_{v} - 1 )} ] \\ {n}_{3 , l}^{( f )} ∈ \{ 0 , 1 , … , {N}_{3} - 1 \}$$

which are indicated by means of the indices i_{1,5} (for N₃>19) and i_{1,6,l} (for M_{υ}>1 and l=1, . . . , υ), where

$${i}_{1 , 5} ∈ \{ 0 , 1 , … , 2 {M}_{v} - 1 \} \\ {i}_{1 , 6 , l} ∈ \{ \begin{matrix}\{ 0 , 1 , … , ( \begin{matrix}{N}_{3} - 1 \\ {N}_{v} - 1\end{matrix} ) - 1 \} & {N}_{3} \leq 19 \\ \{ 0 , 1 , … , ( \begin{matrix}2 {M}_{v} - 1 \\ {M}_{v} - 1\end{matrix} ) - 1 \} & {N}_{3} > 19\end{matrix} .$$

For example, similar to the Rel-17 Type-II codebook [9], for the component W_{f},

$$M vectors , {[ {y}_{0}^{( f )} , {y}_{1}^{( f )} , … , {y}_{{N}_{3} - 1}^{( f )} ]}^{T} , f ∈ \{ 0 , … , M - 1 \} ,$$

are identified by n₃, where N₃ is defined as in clause 5.2.2.2.5 [9], and where

$${n}_{3} = [ {n}_{3}^{( 0 )} … {n}_{3}^{( M - 1 )} ] \\ {n}_{3}^{( f )} ∈ \{ \begin{matrix}\{ 0 \} & M = 1 \\ \{ 0 , 1 , … , min ( N , {N}_{3} ) - 1 \} & M = 2\end{matrix} .$$

with the indices f∈{0, . . . , M−1} assigned such that

$${n}_{3}^{( f )}$$

increases with f. n₃ is indicated by the index i_{1,6}, when M=2 and N=4, where

$${i}_{1 , 6} ∈ \{ 0 , 1 , 2 \} .$$

If M=1, or M=2 and N=2, i_{1,6} is not reported.
If M=2 and N=4, the nonzero offset between

$${n}_{3}^{( 0 )} and {n}_{3}^{( 1 )}$$

is reported with i_{1,6} assuming that

$${n}_{3}^{( 0 )}$$

(reference for the offset) is 0. The nonzero offset values are mapped to the index values of i_{1,6} in increasing order with offset value 1 mapped to index value ‘0’.

In one example, W_{2,r}=\tilde{W}_{2,r}Qᵣ, where Qᵣ is a co-scaling component which includes, for example, co-phase and co-amplitude components, and \tilde{W}_{2,r} is the W₂ component for the r-th TRP, where r=1, . . . , N_{TRP}.
In one example, Qᵣ=aᵣe^{jθ}^{ᵣ} (a scalar value) for the r-th TRP co-scaling component, where aᵣ and θᵣ are selected from respective codebooks, e.g., 3-bit/4-bit amplitude and phase codebooks similar to the codebooks for coefficients in Rel-16 Type-II codebook.
   In one example, co-amplitude (aᵣ) and co-phase (θᵣ) for each TRP are reported.
   In one example, co-amplitude (a_{r*}) and co-phase (θ_{r*}) of the strongest TRP r* are fixed (e.g., 1) hence not reported, and co-amplitudes and co-phases for the remaining N_{TRP}−1 TRPs are reported.
In one example,

$${Q}_{r} = diag ( {a}_{r , 1} {e}^{j {θ}_{r , 1}} , … {a}_{r , {M}_{v}} {e}^{j {θ}_{r , Mv}} )$$

for the r-th TRP co-scaling component (per FD basis, i.e., in total M_{υ} co-scaling components), where diag(x₁, . . . , x_{A}) is the A×A diagonal matrix including x₁, . . . , X_{A} as diagonal entries, and a_{r,i} and θ_{r,i} are selected from respective codebooks, e.g., 3-bit/4-bit amplitude and phase codebooks similar to the codebooks for coefficients in Rel-16 Type-II codebook.
In one example, co-amplitudes ({a_{r,i}}) and co-phases ({θ_{r,i}}) for each TRP are reported.
In one example, for each i of the Mᵥ FD basis units, co-amplitude (a_{r*,i}) and co-phase (θ_{r*,i}) of the strongest TRP r* are fixed (e.g., 1) hence not reported, and co-amplitudes and co-phase for the remaining N_{TRP}−1 TRPs are reported.
   In one example, a strongest TRP is the same for all Mᵥ FD basis units, i.e., one strongest TRP is reported.
   In one example, a strongest TRP can be different across Mᵥ FD basis units, i.e., Mᵥ strongest TRPs are reported.
In one example, Qᵣ is identity.
\tilde{W}_{2,r} is an 2L×Mᵥ matrix and can be quantized via a quantization scheme (similar to the Rel-16 Type-II codebook for amplitude/phase coefficients).

For rank>1 (when υ>1),
In one example, Qᵣ reporting can be common for all layers, i.e., one Qᵣ is reported that is common for all layers.
In one example, Qᵣ reporting can be separate for each layer, i.e., υ Qᵣ are reported, one for each layer.

In one example, the mTRP codebook W can be represented as

$$W = [ \begin{matrix}{W}_{1} {W}_{2 , 1} {W}_{f}^{H} {Q}_{1} \\ {W}_{1} {W}_{2 , {N}_{TRP}} {W}_{f}^{H} {Q}_{{N}_{TRP}}\end{matrix} ] ,$$

where Qᵣ is a co-scaling component for the r-th TRP.
In one example, Qᵣ=aᵣe^{jθ}^{ᵣ} (a scalar value, i.e., WB) for the r-th TRP co-scaling component, where aᵣ and θᵣ are selected from respective codebooks, e.g., 3-bit/4-bit amplitude and phase codebooks similar to the codebooks for coefficients in Rel-16 Type-II codebook.
   In one example, co-amplitude (aᵣ) and co-phase (θᵣ) for each TRP are reported.
   In one example, co-amplitude (a_{r*}) and co-phase (θ_{r*}) of the strongest TRP r* are fixed (e.g., 1) hence not reported, and co-amplitudes and co-phases for the remaining N_{TRP}−1 TRPs are reported.
In one example,

$${Q}_{r} = diag ( {a}_{r , 1} {e}^{j {θ}_{r , 1}} , … {a}_{r {N}_{3}} {e}^{j {θ}_{r , {N}_{3}}} )$$

for the r-th TRP co-scaling component (per FD compression unit, i.e., in total N₃), where diag(x₁, . . . , X_{A}) is the A×A diagonal matrix including x₁, . . . , X_{A} as diagonal entries, and a_{r,i} and θ_{r,i} are selected from respective codebooks, e.g., 3-bit/4-bit amplitude and phase codebooks similar to the codebooks for coefficients in Rel-16 Type-II codebook.
In one example, co-amplitudes ({a_{r,i}}) and co-phases ({θ_{r,i}}) for each TRP are reported.
In one example, for each i of the N₃ FD compression units, co-amplitude (a_{r*,i}) and co-phase (θ_{r*,i}) of the strongest TRP r* are fixed (e.g., 1) hence not reported, and co-amplitudes and co-phase for the remaining N_{TRP}−1 TRPs are reported.
   In one example, a strongest TRP is the same for all N₃ FD compression units, i.e., one strongest TRP is reported.
   In one example, a strongest TRP can be different across N₃ FD compression units, i.e., N₃ strongest TRPs are reported.
In one example, Qᵣ is identity.
In one example, W_{2,r} is an 2L×Mᵥ matrix and can be quantized via a quantization scheme similar to the Rel-16 Type-II codebook for amplitude/phase coefficients.

In one example, without any additional co-scaling component, the stacked matrix of

$${\{ {W}_{2 , r} \}}_{r = 1}^{{N}_{TRP}} , i . e . , [ \begin{matrix}{W}_{2 , 1} \\ ⋮ \\ {W}_{2 , {N}_{TRP}}\end{matrix} ]$$

can be regarded as a component W₂, and the stacked matrix is an 2Lₛᵤₘ×Mᵥ, where Lₛᵤₘ=LN_{TRP} in this example, and can be (jointly across TRPs) quantized via a quantization scheme similar to the Rel-16 Type-II codebook for amplitude/phase coefficients.

In one example, each of the above examples, L vectors for the component W₁ are the same for all layers l=1, . . . , v, (i.e., layer-common,

$${v}_{{m}_{1}^{( i )} , {m}_{2}^{( i )}}$$

similar to the Rel-16 Type-II codebook), and Mᵥ vectors for the component W_{f} are the same for all layers l=1, . . . , v, (i.e., layer-common

$${[ {y}_{0}^{( f )} , {y}_{1}^{( f )} , … , {y}_{{N}_{3} - 1}^{( f )} ]}^{T} , f = 0 , 1 , … , {M}_{v} - 1 ) .$$

In one example, Qᵣ reporting can be common for all layers, i.e., one Qᵣ is reported that is common for all layers.
In one example, Qᵣ reporting can be separate for each layer, i.e., υ Qᵣ are reported, one for each layer.

In one example, each of the above examples, L vectors for the component W₁ are the same for all layers l=1, . . . , v, (i.e., layer-common,

$${v}_{{m}_{1}^{( i )} , {m}_{2}^{( i )}}$$

similar to the Rel-16 Type-II codebook), and Mᵥ vectors for the component W_{f} are independent for each layer l=1, . . . , v, (i.e., layer-specific,

$${[ {y}_{0 , l}^{( f )} , {y}_{1 , l}^{( f )} , … , {y}_{{N}_{3} - 1 , l}^{( f )} ]}^{T} , f = 0 , 1 … , {M}_{v} - 1 ,$$

similar to Rel-16 Type-II codebook).
In one example, Qᵣ reporting can be common for all layers, i.e., one Qᵣ is reported that is common for all layers.
In one example, Qᵣ reporting can be separate for each layer, i.e., υ Qᵣ are reported, one for each layer.

In one example, each of the above examples, L vectors for the component W₁ are independent for each layer l=1, . . . , v, (i.e., layer-specific,

$${v}_{{m}_{1 l}^{( i )} , {m}_{2 l}^{( i )}} ) ,$$

and Mᵥ vectors for the component W_{f} are the same for all layers l=1, . . . , v, (i.e., layer-common,

$${[ {y}_{0}^{( f )} , {y}_{1}^{( f )} , … , {y}_{{N}_{3} - 1}^{( f )} ]}^{T} , \\ f = 0 , 1 , … , {M}_{v} - 1 ) .$$

In one example, Qᵣ reporting can be common for all layers, i.e., one Qᵣ is reported that is common for all layers.
In one example, Qᵣ reporting can be separate for each layer, i.e., υ Qᵣ are reported, one for each layer.

In one example, each of the above examples, L vectors for the component W₁ are independent for each layer l=1, . . . , v, (i.e., layer-specific,

$${v}_{{m}_{1 , l}^{( i )} , {m}_{2 , l}^{( i )}} ) ,$$

and Mᵥ vectors for the component W_{f} are independent for each layer l=1, . . . , v, (i.e., layer-specific,

$${[ {y}_{0 , l}^{( f )} , {y}_{1 , l}^{( f )} , … , {y}_{{N}_{3} - 1 , l}^{( f )} ]}^{T} , f = 0 , 1 , … , {M}_{v} - 1 ) .$$

In one example, Qᵣ reporting can be common for all layers, i.e., one Qᵣ is reported that is common for all layers.
In one example, Qᵣ reporting can be separate for each layer, i.e., υ Qᵣ are reported, one for each layer.

In the present disclosure, when a quantity is reported as TRP-specific, it means that one value of the quantity is reported for each TRP. Likewise, when a quantity is reported as TRP-common, it means that only one value of the quantity is reported that is common for all TRPs.

In the present disclosure, when a quantity is reported as layer-specific, it means that one value of the quantity is reported for each layer. Likewise, when a quantity is reported as layer-common, it means that only one value of the quantity is reported that is common for all layers.

In one embodiment, the component W₁ is determined/reported in a TRP-specific manner, and the component W_{f} are determined/reported in a TRP-common manner. For example, for the mTRP codebook

$$W = {W}_{1} {W}_{2} {W}_{f}^{H}$$

the precoding matrices can be represented as

$$W = [ \begin{matrix}{W}_{1 , 1} & 0 & 0 \\ 0 & ⋱ & 0 \\ 0 & 0 & {W}_{1 , {N}_{TRP}}\end{matrix} ] [ \begin{matrix}{W}_{2 , 1} \\ ⋮ \\ {W}_{2 , {N}_{TRP}}\end{matrix} ] {W}_{f}^{H} = [ \begin{matrix}{W}_{1 , 1} {W}_{2 , 1} {W}_{f}^{H} \\ ⋮ \\ {W}_{1 , {N}_{TRP}} {W}_{2 , {N}_{TRP}} {W}_{f}^{H}\end{matrix} ] .$$

where W_{2,r} is W₂ component for the r-th TRP, and W_{1,r} is W₁ component for the r-th TRP where r=1, . . . , N_{TRP}.

For example, for the component W₁,r, vectors,

$${v}_{{m}_{1 , r}^{( i )} , {m}_{2 , r}^{( i )}} , i = 0 , 1 , … , L - 1 ,$$

for r=1, . . . , N_{TRP} are identified similar to the Rel-16 Type-II codebook.

In another example, for the component W_{1,r}, vectors,

$${v}_{{m}_{1 , r}^{( i )} , {m}_{2 , r}^{( i )}} , i = 0 , 1 , … , {L}_{r} - 1 ,$$

for r=1, . . . , N_{TRP} are identified similar to the Rel-16 Type-II codebook.

For example, for the component W_{1,r}, K₁=αP_{CSI-RS} ports are selected from P_{CSI-RS} ports based on L vectors,

$${v}_{{m}_{r}^{( i )}} , i = 0 , 1 , … , L - 1 ,$$

where L=K₁/2, which are identified similar to the Rel-17 Type-II codebook [9].

For example, for the component W_{1,r}, K_{1,r}=αᵣP_{CSI-RS} ports are selected from P_{CSI-RS} ports based on Lᵣ vectors,

$${v}_{{m}_{r}^{( i )}} , i = 0 , 1 , … , L - 1 ,$$

where Lᵣ=K_{1,r}/2, which are identified similar to the Rel-17 Type-II codebook [9].

For example, similar to the Rel-16 Type-II codebook [9], for the component W_{f},

$${M}_{v} = ⌈ {p}_{v} \frac{{N}_{3}}{R} ⌉ vectors , {[ {y}_{0 , l}^{( f )} , {y}_{1 , l}^{( f )} , … , {y}_{{N}_{3} - 1 , l}^{( f )} ]}^{T} , f = 0 , 1 , … , {M}_{v} - 1 ,$$

are identified by Mᵢₙᵢₜᵢₐₗ (for N₃>19) and n_{3,l} (l=1, . . . , υ) where

$${M}_{initial} ∈ \{ - 2 {M}_{v} + 1 , - 2 {M}_{v} + 2 , … , 0 \}$$

$${n}_{3 , l} = [ {n}_{3 , l}^{( 0 )} , … , {n}_{3 , l}^{( {M}_{v} - 1 )} ]$$

$${n}_{3 , l}^{( f )} ∈ \{ 0 , 1 , … , {N}_{3} - 1 \}$$

which are indicated by means of the indices i_{1,5} (for N₃>19) and i_{1,6,l} (for M_{υ}>1 and l=1, . . . , υ), where

$${i}_{1 , 5} ∈ \{ 0 , 1 , … , 2 {M}_{v} - 1 \}$$

$${i}_{1 , 6 , l} ∈ \{ \begin{matrix}\{ 0 , 1 , … , ( \begin{matrix}{N}_{3} - 1 \\ {M}_{v} - 1\end{matrix} ) - 1 \} & {N}_{3} \leq 19 \\ \{ 0 , 1 , … , ( \begin{matrix}2 {M}_{v} - 1 \\ {M}_{v} - 1\end{matrix} ) - 1 \} & {N}_{3} > 19\end{matrix} .$$

For example, similar to the Rel-17 Type-II codebook [9], for the component W_{f}, M vectors,

$${[ {y}_{0}^{( f )} , {y}_{1}^{( f )} , … , {y}_{{N}_{3} - 1}^{( f )} ]}^{T} , f ∈ \{ 0 , … , M - 1 \} ,$$

are identified by n₃, where N₃ is defined as in clause 5.2.2.2.5 [9], and where

$${n}_{3} = [ {n}_{3}^{( 0 )} , … , {n}_{3}^{( M - 1 )} ]$$

$${n}_{3}^{( f )} ∈ \{ \begin{matrix}\{ 0 \} & M = 1 \\ \{ 0 , 1 , … , min ( N , {N}_{3} ) - 1 \} & M = 2\end{matrix} .$$

with the indices f∈{0, . . . , M−1} assigned such that

$${n}_{3}^{( f )}$$

increases with f. n₃ is indicated by the index i_{1,6}, when M=2 and N=4, where

$${i}_{1 , 6} ∈ \{ 0 , 1 , 2 \} .$$

If M=1, or M=2 and N=2, i_{1,6} is not reported.
If M=2 and N=4, the nonzero offset between

$${n}_{3}^{( 0 )} and {n}_{3}^{( 1 )}$$

is reported with i_{1,6} assuming that n₃⁽⁰⁾ (reference for the offset) is 0. The nonzero offset values are mapped to the index values of i_{1,6} in increasing order with offset value 1 mapped to index value ‘0’.

In one example, W_{2,r}=\tilde{W}_{2,r}Qᵣ, where Qᵣ is a co-scaling component which includes, for example, co-phase and co-amplitude components, and W_{2,r} is the W₂ component for the r-th TRP, where r=1, . . . , N_{TRP}.
In one example, Qᵣ=aᵣe^{jθ}^{ᵣ} (a scalar value) for the r-th TRP co-scaling component, where aᵣ and θᵣ are selected from respective codebooks, e.g., 3-bit/4-bit amplitude and phase codebooks similar to the codebooks for coefficients in Rel-16 Type-II codebook.
   In one example, co-amplitude (aᵣ) and co-phase (θᵣ) for each TRP are reported.
   In one example, co-amplitude (a_{r*}) and co-phase (θ_{r*}) of the strongest TRP r* are fixed (e.g., 1) hence not reported, and co-amplitudes and co-phases for the remaining N_{TRP}−1 TRPs are reported.
In one example,

$${Q}_{r} = diag ( {a}_{r , 1} {e}^{j {θ}_{r , 1}} , … {a}_{r , {M}_{v}} {e}^{j {θ}_{r , Mv}} )$$

for the r-th TRP co-scaling component (per FD basis, i.e., in total M), where diag(x₁, . . . , X_{A}) is the A×A diagonal matrix including x₁, . . . , X_{A} as diagonal entries, and a_{r,i} and θ_{r,i} are selected from respective codebooks, e.g., 3-bit/4-bit amplitude and phase codebooks similar to the codebooks for coefficients in Rel-16 Type-II codebook.
In one example, co-amplitudes ({a_{r,i}}) and co-phases ({θ_{r,i}}) for each TRP are reported.
In one example, for each i of the Mᵥ FD basis units, co-amplitude (a_{r*,i}) and co-phase (θ_{r*,i}) of the strongest TRP r* are fixed (e.g., 1) hence not reported, and co-amplitudes and co-phase for the remaining N_{TRP}−1 TRPs are reported.
In one example, a strongest TRP is the same for all Mᵥ FD basis units, i.e., one strongest TRP is reported.
In one example, a strongest TRP can be different across Mᵥ FD basis units, i.e., Mᵥ strongest TRPs are reported.
In one example, Qᵣ is identity.
In one example, \tilde{W}_{2,r} is an 2L×Mᵥ (or 2Lᵣ×Mᵥ) matrix and can be quantized via a quantization scheme (similar to the Rel-16 Type-II codebook for amplitude/phase coefficients).

For rank>1 (when υ>1),
In one example, Qᵣ reporting can be common for all layers, i.e., one Qᵣ is reported that is common for all layers.
In one example, Qᵣ reporting can be separate for each layer, i.e., υ Qᵣ are reported, one for each layer.

In one example, the mTRP codebook W can be represented as

$$W = [ \begin{matrix}{W}_{1 , 1} {W}_{2 , 1} {W}_{f}^{H} {Q}_{1} \\ ⋮ \\ {W}_{1 , {N}_{TRP}} {W}_{2 , {N}_{TRP}} {W}_{f}^{H} {Q}_{{N}_{TRP}}\end{matrix} ] ,$$

where Qᵣ is a co-scaling component for the r-th TRP.
In one example, Qᵣ=aᵣe^{jθ}^{ᵣ} (a scalar value, i.e., WB) for the r-th TRP co-scaling component, where aᵣ and θᵣ are selected from respective codebooks, e.g., 3-bit/4-bit amplitude and phase codebooks similar to the codebooks for coefficients in Rel-16 Type-II codebook.
   In one example, co-amplitude (aᵣ) and co-phase (θᵣ) for each TRP are reported.
   In one example, co-amplitude (a_{r*}) and co-phase (θ_{r*}) of the strongest TRP r* are fixed (e.g., 1) hence not reported, and co-amplitudes and co-phases for the remaining N_{TRP}−1 TRPs are reported.
In one example,

$${Q}_{r} = diag ( {a}_{r , 1} {e}^{j {θ}_{r , 1}} , … {a}_{r {N}_{3}} {e}^{j {θ}_{r , {N}_{3}}} )$$

for the r-th TRP co-scaling component (per FD compression unit, i.e., in total N₃), where diag(x₁, . . . , X_{A}) is the A×A diagonal matrix including x₁, . . . , X_{A} as diagonal entries, and a_{r,i} and θ_{r,i} are selected from respective codebooks, e.g., 3-bit/4-bit amplitude and phase codebooks similar to the codebooks for coefficients in Rel-16 Type-II codebook.
In one example, co-amplitudes ({a_{r,i}}) and co-phases ({θ_{r,i}}) for each TRP are reported.
In one example, for each i of the N₃ FD compression units, co-amplitude (a_{r*,i}) and co-phase (θ_{r*,i}) of the strongest TRP r* are fixed (e.g., 1) hence not reported, and co-amplitudes and co-phase for the remaining N_{TRP}−1 TRPs are reported.
   In one example, a strongest TRP is the same for all N₃ FD compression units, i.e., one strongest TRP is reported.
   In one example, a strongest TRP can be different across N₃ FD compression units, i.e., N₃ strongest TRPs are reported.
In one example, Qᵣ is identity.
In one example, W_{2,r} is an 2L×Mᵥ (or 2Lᵣ×Mᵥ) matrix and can be quantized via a quantization scheme similar to the Rel-16 Type-II codebook for amplitude/phase coefficients.

In one example, without any additional co-scaling component, the stacked matrix of

$${\{ {W}_{2 , r} \}}_{r = 1}^{{N}_{TRP}} , i . e . , [ \begin{matrix}{W}_{2 , 1} \\ ⋮ \\ {W}_{2 , {N}_{TRP}}\end{matrix} ]$$

can be regarded as a component W₂, and the stacked matrix is an 2Lsum×Mᵥ, where Lₛᵤₘ=LN_{TRP} for the case of the same L for all TRPs, or where

$${L}_{sum} = {\sum }_{r = 1}^{{N}_{TRP}} {L}_{r}$$

for the case of Lᵣ (different per TRP), and can be quantized (jointly across TRPs) via a quantization scheme similar to the Rel-16 Type-II codebook for amplitude/phase coefficients.

In one example, each of the above examples, L (or Lᵣ) vectors for the component W_{1,r} are the same for all layers l=1, . . . , v, (i.e., layer-common,

$${v}_{{m}_{1 , r}^{( i )} , {m}_{2 , r}^{( i )}}$$

similar to the Rel-16 Type-II codebook) for r=1, . . . , N_{TRP}, and Mᵥ vectors for the component W_{f} are the same for all layers l=1, . . . , v, (i.e., layer-common,

$${[ {y}_{0}^{( f )} , {y}_{1}^{( f )} , ... , {y}_{{N}_{3} - 1}^{( f )} ]}^{T} , f = 0 , 1 , ... , {M}_{v} - 1 ) .$$

In one example, Qᵣ reporting can be common for all layers, i.e., one Qᵣ is reported that is common for all layers.
In one example, Qᵣ reporting can be separate for each layer, i.e., υ Qᵣ are reported, one for each layer.

In one example, each of the above examples, L (or Lᵣ) vectors for the component W_{1,r} are the same for all layers l=1, . . . , v, (i.e., layer-common

$${v}_{{m}_{1 , r}^{( i )} , {m}_{2 , r}^{( i )}}$$

similar to the Rel-16 Type-II codebook) for r=1, . . . , N_{TRP}, and Mᵥ vectors for the component W_{f} are independent for each layer l=1, . . . , v, (i.e., layer-specific,

$${[ {y}_{0 , l}^{( f )} , {y}_{1 , l}^{( f )} , ... , {y}_{{N}_{3} - 1 , l}^{( f )} ]}^{T} , f = 0 , 1 , ... , {M}_{v} - 1 ,$$

similar to Rel-16 Type-II codebook).
In one example, Qᵣ reporting can be common for all layers, i.e., one Qᵣ is reported that is common for all layers.
In one example, Qᵣ reporting can be separate for each layer, i.e., υ Qᵣ are reported, one for each layer.

In one example, each of the above examples, L (or Lᵣ) vectors for the component W_{1,r} are independent for each layer l=1, . . . , v, (i.e., layer-specific,

$${v}_{{m}_{1 , l , r}^{( i )} , {m}_{2 , l , r}^{( i )}} )$$

for r=1, . . . , N_{TRP}, and Mᵥ vectors for the component W_{f} are the same for all layers l=1, . . . , v, (i.e., layer-common,

$${[ {y}_{0}^{( f )} , {y}_{1}^{( f )} , ... , {y}_{{N}_{3} - 1}^{( f )} ]}^{T} , f = 0 , 1 , ... , {M}_{v} - 1 ) .$$

In one example, Qᵣ reporting can be common for all layers, i.e., one Qᵣ is reported that is common for all layers.
In one example, Qᵣ reporting can be separate for each layer, i.e., υ Qᵣ are reported, one for each layer.

In one example, each of the above examples, L (or Lᵣ) vectors for the component W_{1,r} are independent for each layer I=1, . . . , v, (i.e., layer-specific,

$${v}_{{m}_{1 , l , r}^{( i )} , {m}_{2 , l , r}^{( i )}} )$$

for r=1, . . . , N_{TRP}, and Mᵥ vectors for the component W_{f} are independent for each layer l=1, . . . , v, (i.e., layer-specific,

$${[ {y}_{0 , l}^{( f )} , {y}_{1 , l}^{( f )} , ... , {y}_{{N}_{3} - 1 , l}^{( f )} ]}^{T} , f = 0 , 1 , ... , {M}_{v} - 1 ) .$$

In one example, Qᵣ reporting can be common for all layers, i.e., one Qᵣ is reported that is common for all layers.
In one example, Qᵣ reporting can be separate for each layer, i.e., υ Qᵣ are reported, one for each layer.

In one embodiment, the component W₁ is determined in a TRP-common manner, and the component W_{f} is determined in a TRP-specific manner. For example, the mTRP codebook

$$W = {W}_{1} {W}_{2} {W}_{f}^{H}$$

for the precoding matrices can be represented as

$$W = [ \begin{matrix}{W}_{1} & 0 & 0 \\ 0 & ⋱ & 0 \\ 0 & 0 & {W}_{1}\end{matrix} ] [ \begin{matrix}{W}_{2 , 1} & 0 & 0 \\ 0 & ⋱ & 0 \\ 0 & 0 & {W}_{2 , {N}_{TRP}}\end{matrix} ] [ \begin{matrix}{W}_{f , 1}^{H} \\ ⋮ \\ {W}_{f , {N}_{TRP}}^{H}\end{matrix} ] = [ \begin{matrix}{W}_{1} {W}_{2 , 1} {W}_{f , 1}^{H} \\ ⋮ \\ {W}_{1} {W}_{2 , {N}_{TRP}} {W}_{f , {N}_{TRP}}^{H}\end{matrix} ] .$$

where W_{2,r} is the W₂ component for the r-th TRP, and W_{f,r} is the W_{f} component for the r-th TRP, where r=1, . . . , N_{TRP}.

For example, similar to the Rel-16 Type-II codebook, for the component W₁, vectors,

$${v}_{{m}_{1}^{( i )} , {m}_{2}^{( i )}} , i = 0 , 1 , … , L - 1 ,$$

are identified by the indices q₁, q₂, n₁, n₂, indicated by i_{1,1}, i_{1,2}, obtained as in 5.2.2.2.3 [9], where the values of C(x, y) are given in Table 5.2.2.2.5-4 in [9].

For example, similar to the Rel-17 Type-II codebook [9], for the component W₁, K₁=αP_{CSI-RS} ports are selected from P_{CSI-RS} ports based on L vectors, vₘ_{⁽ⁱ⁾}, i=0, 1, . . . , L−1, where L=K₁/2, which are identified by [9]

$$m = [ {m}^{( 0 )} ... {m}^{( L - 1 )} ]$$

$${m}^{( i )} ∈ \{ 0 , 1 , ... , \frac{{P}_{CSI - RS}}{2} - 1 \}$$

which are indicated by the index i_{1,2}, where

$${i}_{1 , 2} ∈ \{ 0 , 1 , ... , ( \begin{matrix}{P}_{CSI - RS} / 2 \\ L\end{matrix} ) - 1 \} .$$

For example, for the component W_{f,r},

$${M}_{v} = ⌈ {p}_{v} \frac{{N}_{3}}{R} ⌉$$

vectors,

$${[ {y}_{0 , l , r}^{( f )} , {y}_{1 , l , r}^{( f )} , … , {y}_{{N}_{3} - 1 , l , r}^{( f )} ]}^{T} , f = 0 , 1 , … , {M}_{v} - 1 ,$$

are identified for r=1, . . . , N_{TRP}, similar to the Rel-16 Type-II codebook [9].

In another example, for the component

$${W}_{f , r} , M = ⌈ p \frac{{N}_{3}}{R} ⌉$$

vectors,

$${[ {y}_{0 , l , r}^{( f )} , {y}_{1 , l , r}^{( f )} , … , {y}_{{N}_{3} - 1 , l , r}^{( f )} ]}^{T} , f = 0 , 1 , … , M - 1 ,$$

are identified for r=1, . . . , N_{TRP}, similar to the Rel-16 Type-II codebook [9].

In another example, for the component

$${W}_{f , r} , {M}_{v , r} = ⌈ {p}_{v , r} \frac{{N}_{3}}{R} ⌉$$

vectors,

$${[ {y}_{0 , l , r}^{( f )} , {y}_{1 , l , r}^{( f )} , … , {y}_{{N}_{3} - 1 , l , r}^{( f )} ]}^{T} , f = 0 , 1 , … , {M}_{v , r} - 1 ,$$

are identified for r=1, . . . , N_{TRP}, similar to the Rel-16 Type-II codebook [9].

For example, for the component W_{f,r}, M vectors,

$${[ {y}_{0}^{( f )} , {y}_{1}^{( f )} , … , {y}_{{N}_{3} - 1}^{( f )} ]}^{T} , f ∈ \{ 0 , … , M - 1 \} ,$$

are identified similar to the Rel-17 Type-II codebook [9].

For example, for the component W_{f,r}, Mᵣ vectors,

$${[ {y}_{0}^{( f )} , {y}_{1}^{( f )} , … , {y}_{{N}_{3} - 1}^{( f )} ]}^{T} , f ∈ \{ 0 , … , {M}_{r} - 1 \} ,$$

are identified similar to the Rel-17 Type-II codebook [9].

In one example, W_{2,r}=\tilde{W}_{2,r}Qᵣ, where Qᵣ is a co-scaling component which includes, for example, co-phase and co-amplitude components, and \tilde{W}_{2,r} is the W₂ component for the r-th TRP, where r=1, . . . , N_{TRP}.
In one example, Qᵣ=aᵣe^{jθ}^{ᵣ} (a scalar value) for the r-th TRP co-scaling component, where aᵣ and θᵣ are selected from respective codebooks, e.g., 3-bit/4-bit amplitude and phase codebooks similar to the codebooks for coefficients in Rel-16 Type-II codebook.
   In one example, co-amplitude (aᵣ) and co-phase (θᵣ) for each TRP are reported.
   In one example, co-amplitude (a_{r*}) and co-phase (θ_{r*}) of the strongest TRP r* are fixed (e.g., 1) hence not reported, and co-amplitudes and co-phases for the remaining N_{TRP}−1 TRPs are reported.
In one example,

$${Q}_{r} = diag ( {a}_{r , 1} {e}^{j {θ}_{r , 1}} , … {a}_{r , {M}_{v}} {e}^{j {θ}_{r , Mv}} )$$

for the r-th TRP co-scaling component (per FD basis, i.e., in total M), where diag(x₁, . . . , X_{A}) is the A×A diagonal matrix including x₁, . . . , X_{A} as diagonal entries, and a_{r,i} and θ_{r,i} are selected from respective codebooks, e.g., 3-bit/4-bit amplitude and phase codebooks similar to the codebooks for coefficients in Rel-16 Type-II codebook.
In one example, co-amplitudes ({a_{r,i}}) and co-phases ({θ_{r,i}}) for each TRP are reported.
In one example, for each i of the Mᵥ FD basis units, co-amplitude (a_{r*,i}) and co-phase (θ_{r*,i}) of the strongest TRP r* are fixed (e.g., 1) hence not reported, and co-amplitudes and co-phase for the remaining N_{TRP}−1 TRPs are reported.
   In one example, a strongest TRP is the same for all Mᵥ FD basis units, i.e., one strongest TRP is reported.
   In one example, a strongest TRP can be different across Mᵥ FD basis units, i.e., M_{υ} strongest TRPs are reported.
In one example, Qᵣ is identity.
In one example, \tilde{W}_{2,r} is an 2L×Mᵥ matrix and can be quantized via a quantization scheme (similar to the Rel-16 Type-II codebook for amplitude/phase coefficients).

For rank>1 (when υ>1),
In one example, Qᵣ reporting can be common for all layers, i.e., one Qᵣ is reported that is common for all layers.
In one example, Qᵣ reporting can be separate for each layer, i.e., υ Qᵣ are reported, one for each layer.

In one example, the mTRP codebook W can be represented as

$$W = [ \begin{matrix}{W}_{1} {W}_{2 , 1} {W}_{f , 1}^{H} {Q}_{1} \\ ⋮ \\ {W}_{1} {W}_{2 , {N}_{TRP}} {W}_{f , {N}_{TRP}}^{H} {Q}_{{N}_{TRP}}\end{matrix} ] ,$$

where Qᵣ is a co-scaling component for the r-th TRP.
In one example, Qᵣ=aᵣe^{jθ}^{ᵣ} (a scalar value, i.e., WB) for the r-th TRP co-scaling component, where aᵣ and θᵣ are selected from respective codebooks, e.g., 3-bit/4-bit amplitude and phase codebooks similar to the codebooks for coefficients in Rel-16 Type-II codebook.
   In one example, co-amplitude (aᵣ) and co-phase (θᵣ) for each TRP are reported.
   In one example, co-amplitude (a_{r*}) and co-phase (θ_{r*}) of the strongest TRP r* are fixed (e.g., 1) hence not reported, and co-amplitudes and co-phases for the remaining N_{TRP}−1 TRPs are reported.
In one example,

$${Q}_{r} = diag ( {a}_{r , 1} {e}^{j {θ}_{r , 1}} , … {a}_{r {N}_{3}} {e}^{j {θ}_{r , {N}_{3}}} )$$

for the r-th TRP co-scaling component (per FD compression unit, i.e., in total N₃), where diag(x₁, . . . , X_{A}) is the A×A diagonal matrix including x₁, . . . , X_{A} as diagonal entries, and a_{r,i} and θ_{r,i} are selected from respective codebooks, e.g., 3-bit/4-bit amplitude and phase codebooks similar to the codebooks for coefficients in Rel-16 Type-II codebook.
In one example, co-amplitudes ({a_{r,i}}) and co-phases ({θ_{r,i}}) for each TRP are reported.
In one example, for each i of the N₃ FD compression units, co-amplitude (a_{r*,i}) and co-phase (θ_{r*,i}) of the strongest TRP r* are fixed (e.g., 1) hence not reported, and co-amplitudes and co-phase for the remaining N_{TRP}−1 TRPs are reported.
   In one example, a strongest TRP is the same for all N₃ FD compression units, i.e., one strongest TRP is reported.
   In one example, a strongest TRP can be different across N₃ FD compression units, i.e., N₃ strongest TRPs are reported.
In one example, Qᵣ is identity.
In one example, W_{2,r} is an 2L×Mᵥ matrix and can be quantized via a quantization scheme similar to the Rel-16 Type-II codebook for amplitude/phase coefficients.

In one example, without any additional co-scaling component, the stacked matrix of

$${\{ {W}_{2 , r} \}}_{r = 1}^{{N}_{TRP}} , i . e . , [ \begin{matrix}{W}_{2 , 1} \\ ⋮ \\ {W}_{2 , {N}_{TRP}}\end{matrix} ]$$

can be regarded as a component W₂, and the stacked matrix is an 2Lsum×Mᵥ, where Lₛᵤₘ=LN_{TRP} in this example, and can be quantized (jointly across TRPs) via a quantization scheme similar to the Rel-16 Type-II codebook for amplitude/phase coefficients.

In one example, each of the above examples, L vectors for the component W₁ are the same for all layers l=1, . . . , v, (i.e., layer-common,

$${v}_{{m}_{1}^{( i )} , {m}_{2}^{( i )}}$$

similar to ine Kei-16 Type-II codebook), and Mᵥ (or M_{v,r} or M) vectors for the component W_{f} are the same for all layers l=1, . . . , v, (i.e., layer-common,

$${[ {y}_{0 , r}^{( f )} , {y}_{1 , r}^{( f )} , … , {y}_{{N}_{3} - 1 , r}^{( f )} ]}^{T} , f = 0 , 1 , … , {M}_{v} - 1 )$$

for r=1, . . . , N_{TRP}.
In one example, Qᵣ reporting can be common for all layers, i.e., one Qᵣ is reported that is common for all layers.
In one example, Qᵣ reporting can be separate for each layer, i.e., υ Qᵣ are reported, one for each layer.

In one example, each of the above examples, L vectors for the component W₁ are the same for all layers l=1, . . . , v, (i.e., layer-common,

$${v}_{{m}_{1}^{( i )} , {m}_{2}^{( i )}}$$

similar to the Rel-16 Type-II codebook), and Mᵥ (or M_{v,r} or M) vectors for the component W_{f,r} are independent for each layer l=1, . . . , v, (i.e., layer-specific,

$${[ {y}_{0 , l , r}^{( f )} , {y}_{1 , l , r}^{( f )} , … , {y}_{{N}_{3} - 1 , l , r}^{( f )} ]}^{T} , f = 0 , 1 , … , {M}_{v} - 1 ,$$

similar to the Rel-16 Type-II codebook) for r=1, . . . , N_{TRP}.
In one example, Qᵣ reporting can be common for all layers, i.e., one Qᵣ is reported that is common for all layers.
In one example, Qᵣ reporting can be separate for each layer, i.e., υ Qᵣ are reported, one for each layer.

In one example, each of the above examples, L vectors for the component W₁ are independent for each layer l=1, . . . , v, (i.e., layer-specific,

$${v}_{{m}_{1 , l}^{( i )} , {m}_{2 , l}^{( i )}} ) ,$$

and Mᵥ (or M_{v,r} or M) vectors for the component W_{f,r} are the same for all layers l=1, . . . , v, (i.e., layer-common,

$${[ {y}_{0 , r}^{( f )} , {y}_{1 , r}^{( f )} , ... , {y}_{{N}_{3} - 1 , r}^{( f )} ]}^{T} , f = 0 , 1 , ... , {M}_{v} - 1 )$$

for r=1, . . . , N_{TRP}.
In one example, Qᵣ reporting can be common for all layers, i.e., one Qᵣ is reported that is common for all layers.
In one example, Qᵣ reporting can be separate for each layer, i.e., υ Qᵣ are reported, one for each layer.

In one example, each of the above examples, L vectors for the component W₁ are independent for each layer l=1, . . . , v, (i.e., layer-specific,

$${v}_{{m}_{1 , l}^{( i )} , {m}_{2 , l}^{( i )}} ) ,$$

and Mᵥ (or M_{v,r} or M) vectors for the component W_{f,r} are independent for each layer l=1, . . . , v, (i.e., layer-specific,

$${[ {y}_{0 , l , r}^{( f )} , {y}_{1 , l , r}^{( f )} , ... , {y}_{{N}_{3} - 1 , l , r}^{( f )} ]}^{T} , f = 0 , 1 , ... , {M}_{v} - 1 )$$

for r=1, . . . , N_{TRP}.
In one example, Qᵣ reporting can be common for all layers, i.e., one Qᵣ is reported that is common for all layers.
In one example, Qᵣ reporting can be separate for each layer, i.e., υ Qᵣ are reported, one for each layer.

In one embodiment, the components W₁ and W_{f} are determined in a TRP-common manner. For example, the mTRP codebook

$$W = {W}_{1} {W}_{2} {W}_{f}^{H}$$

for the precoding matrices can be represented as

$$W = [ \begin{matrix}{W}_{1 , 1} & 0 & 0 \\ 0 & ⋱ & 0 \\ 0 & 0 & {W}_{1 , {N}_{TRP}}\end{matrix} ] [ \begin{matrix}{W}_{2 , 1} & 0 & 0 \\ 0 & ⋱ & 0 \\ 0 & 0 & {W}_{2 , {N}_{TRP}}\end{matrix} ] [ \begin{matrix}{W}_{f , 1}^{H} \\ ⋮ \\ {W}_{f , {N}_{TRP}}^{H}\end{matrix} ] = [ \begin{matrix}{W}_{1 , 1} {W}_{2 , 1} {W}_{f , 1}^{H} \\ ⋮ \\ {W}_{1 , {N}_{TRP}} {W}_{2 , {N}_{TRP}} {W}_{f , {N}_{TRP}}^{H}\end{matrix} ] .$$

where W_{1,r} is the W₁ component for the r-th TRP, W_{2,r} is the W₂ component for the r-th TRP, and W_{f,r} is the W_{f} component for the r-th TRP where r=1, . . . , N_{TRP}.

For example, for the component W_{1,r}, vectors

$${v}_{{m}_{1 , r}^{( i )} , {m}_{2 , r}^{( i )}} , i = 0 , 1 , ... , L - 1 ,$$

for r=1, . . . , N_{TRP} are identified similar to the Rel-16 Type-II codebook.

In another example, for the component W_{1,r}, vectors,

$${v}_{{m}_{1 , r}^{( i )} , {m}_{2 , r}^{( i )}} , i = 0 , 1 , ... , {L}_{r} - 1 ,$$

for r=1, . . . , N_{TRP} are identified similar to the Rel-16 Type-II codebook.

For example, for the component W_{1,r}, K₁=αP_{CSI-RS} ports are selected from P_{CSI-RS} ports based on L vectors,

$${v}_{{m}_{r}^{( i )}} , i = 0 , 1 , ... , L - 1 ,$$

where L=K₁/2, which are identified similar to the Rel-17 Type-II codebook [9].
For example, for the component W_{1,r}, K_{1,r}=αᵣP_{CSI-RS} ports are selected from P_{CSI-RS} ports based on Lᵣ vectors,

$${v}_{{m}_{r}^{( i )}} , i = 0 , 1 , ... , L - 1 ,$$

where Lᵣ=K_{1,r}/2, which are identified similar to the Rel-17 Type-II codebook [9].

For example, for the component

$${W}_{f , r} , {M}_{v} = ⌈ {p}_{v} \frac{{N}_{3}}{R} ⌉ vectors ,$$

$${[ {y}_{0 , l , r}^{( f )} , {y}_{1 , l , r}^{( f )} , ... , {y}_{{N}_{3} - 1 , l , r}^{( f )} ]}^{T} , f = 0 , 1 , ... , {M}_{v} - 1 ,$$

are identified for r=1, . . . , N_{TRP}, similar to the Rel-16 Type-II codebook [9].

In another example, for the component

$${W}_{f , r} , M = ⌈ p \frac{{N}_{3}}{R} ⌉ vectors ,$$

$${[ {y}_{0 , l , r}^{( f )} , {y}_{1 , l , r}^{( f )} , ... , {y}_{{N}_{3} - 1 , l , r}^{( f )} ]}^{T} , f = 0 , 1 , ... , {M}_{v} - 1 ,$$

are identified for r=1, . . . , N_{TRP}, similar to the Rel-16 Type-II codebook [9].

In another example, for the component

$${W}_{f , r} , {M}_{v , r} = ⌈ {p}_{v , r} \frac{{N}_{3}}{R} ⌉ vectors ,$$

$${[ {y}_{0 , l , r}^{( f )} , {y}_{1 , l , r}^{( f )} , ... , {y}_{{N}_{3} - 1 , l , r}^{( f )} ]}^{T} , f = 0 , 1 , ... , {M}_{v} - 1 ,$$

are identified for r=1, . . . , N_{TRP}, similar to the Rel-16 Type-II codebook [9].

For example, for the component W_{f,r}, M vectors,

$${[ {y}_{0}^{( f )} , {y}_{1}^{( f )} , ... , {y}_{{N}_{3} - 1}^{( f )} ]}^{T} , f ∈ \{ 0 , ... , M - 1 \} ,$$

are identified similar to the Rel-17 Type-II codebook [9].

For example, for the component W_{f,r}, Mᵣ vectors,

$${[ {y}_{0}^{( f )} , {y}_{1}^{( f )} , … , {y}_{{N}_{3} - 1}^{( f )} ]}^{T} , f ∈ \{ 0 , … , {M}_{r} - 1 \} ,$$

are identified similar to the Rel-17 Type-II codebook [9].

In one example, W_{2,r}=\tilde{W}_{2,r}Qᵣ, where Qᵣ is a co-scaling component which includes, for example, co-phase and co-amplitude components, and \tilde{W}_{2,r} is the W₂ component for the r-th TRP, where r=1, . . . , N_{TRP}.
In one example, Qᵣ=aᵣe^{jθ}^{ᵣ} (a scalar value) for the r-th TRP co-scaling component, where aᵣ and θᵣ are selected from respective codebooks, e.g., 3-bit/4-bit amplitude and phase codebooks similar to the codebooks for coefficients in Rel-16 Type-II codebook.
   In one example, co-amplitude (aᵣ) and co-phase (θᵣ) for each TRP are reported.
   In one example, co-amplitude (a_{r*}) and co-phase (θ_{r*}) of the strongest TRP r* are fixed (e.g., 1) hence not reported, and co-amplitudes and co-phases for the remaining N_{TRP}−1 TRPs are reported.
In one example,

$${Q}_{r} = diag ( {a}_{r , 1} {e}^{j {θ}_{r , 1}} , … {a}_{r , {M}_{v}} {e}^{j {θ}_{r , Mv}} )$$

for the r-th TRP co-scaling component (per FD basis, i.e., in total M), where diag(x₁, . . . , X_{A}) is the A×A diagonal matrix including x₁, . . . , X_{A} as diagonal entries, and a_{r,i} and θ_{r,i} are selected from respective codebooks, e.g., 3-bit/4-bit amplitude and phase codebooks similar to the codebooks for coefficients in Rel-16 Type-II codebook.
In one example, co-amplitudes ({a_{r,i}}) and co-phases ({θ_{r,i}}) for each TRP are reported.
In one example, for each i of the Mᵥ FD basis units, co-amplitude (a_{r*i}) and co-phase (θ_{r*,i}) of the strongest TRP r* are fixed (e.g., 1) hence not reported, and co-amplitudes and co-phase for the remaining N_{TRP}−1 TRPs are reported.
   In one example, a strongest TRP is the same for all Mᵥ FD basis units, i.e., one strongest TRP is reported.
   In one example, a strongest TRP can be different across Mᵥ FD basis units, i.e., M_{υ} strongest TRPs are reported.
In one example, Qᵣ is identity.
In one example, \tilde{W}_{2,r} is an 2L×Mᵥ matrix and can be quantized via a quantization scheme (similar to the Rel-16 Type-II codebook for amplitude/phase coefficients).

For rank>1 (when v>1),
In one example, Qᵣ reporting can be common for all layers, i.e., one Qᵣ is reported that is common for all layers.
In one example, Qᵣ reporting can be separate for each layer, i.e., υ Qᵣ are reported, one for each layer.

In one example, the mTRP codebook W can be represented as

$$W = [ \begin{matrix}{W}_{1 , 1} {W}_{2 , 1} {W}_{f , 1}^{H} {Q}_{1} \\ ⋮ \\ {W}_{1 , 1} {W}_{2 , {N}_{TRP}} {W}_{f , {N}_{TRP}}^{H} {Q}_{{N}_{TRP}}\end{matrix} ] ,$$

where Qᵣ is a co-scaling component for the r-th TRP.
In one example, Qᵣ=aᵣe^{jθ}^{ᵣ} (a scalar value, i.e., WB) for the r-th TRP co-scaling component, where aᵣ and θᵣ are selected from respective codebooks, e.g., 3-bit/4-bit amplitude and phase codebooks similar to the codebooks for coefficients in Rel-16 Type-II codebook.
   In one example, co-amplitude (aᵣ) and co-phase (θᵣ) for each TRP are reported.
   In one example, co-amplitude (a_{r*}) and co-phase (θ_{r*}) of the strongest TRP r* are fixed (e.g., 1) hence not reported, and co-amplitudes and co-phases for the remaining N_{TRP}−1 TRPs are reported.
In one example,

$${Q}_{r} = diag ( {a}_{r , 1} {e}^{j {θ}_{r , 1}} , … {a}_{r {N}_{3}} {e}^{j {θ}_{r , {N}_{3}}} )$$

for the r-th TRP co-scaling component (per FD compression unit, i.e., in total N₃), where diag(x₁, . . . , X_{A}) is the A×A diagonal matrix including x₁, . . . , X_{A} as diagonal entries, and a_{r,i} and θ_{r,i} are selected from respective codebooks, e.g., 3-bit/4-bit amplitude and phase codebooks similar to the codebooks for coefficients in Rel-16 Type-II codebook.
In one example, co-amplitudes ({a_{r,i}}) and co-phases ({θ_{r,i}}) for each TRP are reported.
In one example, for each i of the N₃ FD compression units, co-amplitude (a_{r*,i}) and co-phase (θ_{r*,i}) of the strongest TRP r* are fixed (e.g., 1) hence not reported, and co-amplitudes and co-phase for the remaining N_{TRP}−1 TRPs are reported.
   In one example, a strongest TRP is the same for all N₃ FD compression units, i.e., one strongest TRP is reported.
   In one example, a strongest TRP can be different across N₃ FD compression units, i.e., N₃ strongest TRPs are reported.
In one example, Qᵣ is identity.
In one example, W_{2,r} is an 2L×Mᵥ matrix and can be quantized via a quantization scheme similar to the Rel-16 Type-II codebook for amplitude/phase coefficients.

In one example, without any additional co-scaling component, the stacked matrix of

$${\{ {W}_{2 , r} \}}_{r = 1}^{{N}_{TRP}} , i . e . , [ \begin{matrix}{W}_{2 , 1} \\ ⋮ \\ {W}_{2 , {N}_{TRP}}\end{matrix} ]$$

can be regarded as a component W₂, and the stacked matrix is an 2Lsum×Mᵥ, where Lₛᵤₘ=LN_{TRP} for the case of the same L for all TRPs, or where

$${L}_{s u m} = {\sum }_{r = 1}^{{N}_{TRP}} {L}_{r}$$

for the case of Lᵣ (different per TRP), and can be quantized (jointly across TRPs) via a quantization scheme similar to the Rel-16 Type-II codebook for amplitude/phase coefficients.

In one example, each of the above examples, L (or Lᵣ) vectors for the component W_{1,r} are the same for all layers l=1, . . . , v, (i.e., layer-common

$${v}_{{m}_{1 , r}^{( i )} , {m}_{2 , r}^{( i )}}$$

similar to the Rel-16 Type-II codebook) for r=1, . . . , N_{TRP}, and Mᵥ (or M_{v,r} or M) vectors for the component W_{f,r} are the same for all layers l=1, . . . , v, (i.e., layer-common,

$${[ {y}_{0 , r}^{( f )} , {y}_{1 , r}^{( f )} , … , {y}_{{N}_{3} - 1 , r}^{( f )} ]}^{T} , f = 0 , 1 , … , {M}_{v} - 1 )$$

for r=1, . . . , N_{TRP}.
In one example, Qᵣ reporting can be common for all layers, i.e., one Qᵣ is reported that is common for all layers.
In one example, Qᵣ reporting can be separate for each layer, i.e., υ Qᵣ are reported, one for each layer.

In one example, each of the above examples, L (or Lᵣ) vectors for the component W_{1,r} are the same for all layers l=1, . . . , v, (i.e., layer-common,

$${v}_{{m}_{1 , r}^{( i )} , {m}_{2 , r}^{( i )}}$$

similar to the Rel-16 Type-II codebook) for r=1, . . . , N_{TRP}, and Mᵥ (or M_{v,r} or M) vectors for the component W_{f,r} are independent for each layer l=1, . . . , v, (i.e., layer-specific,

$${[ {y}_{0 , l , r}^{( f )} , {y}_{1 , l , r}^{( f )} , … , {y}_{{N}_{3} - 1 , l , r}^{( f )} ]}^{T} , f = 0 , 1 , … , {M}_{v} - 1 ,$$

similar to Rel-16 Type-II codebook) for r=1, . . . , N_{TRP}.
In one example, Qᵣ reporting can be common for all layers, i.e., one Qᵣ is reported that is common for all layers.
In one example, Qᵣ reporting can be separate for each layer, i.e., υ Qᵣ are reported, one for each layer.

In one example, each of the above examples, L (or Lᵣ) vectors for the component W_{1,r} are independent for each layer l=1, . . . , v, (i.e., layer-specific,

$${v}_{{m}_{1 , l , r}^{( i )} , {m}_{2 , l , r}^{( i )}} )$$

for r=1, . . . , N_{TRP}, and Mᵥ (or M_{v,r} or M) vectors for the component W_{f,r} are the same for all layers l=1, . . . , v, (i.e., layer-common,

$${[ {y}_{0 , r}^{( f )} , {y}_{1 , r}^{( f )} , … , {y}_{{N}_{3} - 1 , r}^{( f )} ]}^{T} , f = 0 , 1 , … , {M}_{v} - 1 )$$

for r=1, . . . , N_{TRP}.
In one example, Qᵣ reporting can be common for all layers, i.e., one Qᵣ is reported that is common for all layers.
In one example, Qᵣ reporting can be separate for each layer, i.e., υ Qᵣ are reported, one for each layer.

In one example, each of the above examples, L (or Lᵣ) vectors for the component W_{1,r} are independent for each layer l=1, . . . , v, (i.e., layer-specific,

$${v}_{{m}_{1 , l , r}^{( i )} , {m}_{2 , l , r}^{( i )}} )$$

for r=1, . . . , N_{TRP}, and Mᵥ (or M_{v,r} or M) vectors for the component W_{f,r} are independent for each layer l=1, . . . , v, (i.e., layer-specific,

$${[ {y}_{0 , l , r}^{( f )} , {y}_{1 , l , r}^{( f )} , … , {y}_{{N}_{3} - 1 , l , r}^{( f )} ]}^{T} , f = 0 , 1 , … , {M}_{v} - 1 )$$

for r=1, . . . , N_{TRP}.
In one example, Qᵣ reporting can be common for all layers, i.e., one Qᵣ is reported that is common for all layers.
In one example, Qᵣ reporting can be separate for each layer, i.e., υ Qᵣ are reported, one for each layer.

In one embodiment, a co-scaling component Qᵣ for r=1, . . . , N_{TRP}, which includes co-amplitude and co-phase components can be reported according to at least one of the following examples.
In one example, both the co-amplitude and co-phase components are reported in a wideband (WB) manner. For example,

$${Q}_{r} = {a}_{r} {e}^{j {θ}_{r ,}}$$

where aᵣ and θᵣ are amplitude and phase values for TRP r,
In one example, co-amplitude (aᵣ) and co-phase (θᵣ) for each TRP are reported.
In one example, co-amplitude (a_{r*}) and co-phase (θ_{r*}) of the strongest TRP r* are fixed (e.g., 1) hence not reported, and co-amplitudes and co-phases for the remaining N_{TRP}−1 TRPs are reported.
In one example, the co-amplitude component is reported in a WB manner, and the co-phase component is reported per SB, per FD unit (total N₃ FD units), or per FD basis vector (total M FD basis vectors). In one example, Qᵣ=aᵣPᵣ, where Pᵣ is a diagonal matrix for the phase component.
   In one example, for the case of per-FD-basis vector reporting for the phase component, Pᵣ is an M×M diagonal matrix including

$${e}^{j {θ}_{r , 1}} , … , {e}^{j {θ}_{r , M}} .$$

In one example, for the case of per-FD-unit reporting for the phase component, Pᵣ is an N₃×N₃ diagonal matrix including

$${e}^{j {θ}_{r , 1}} , … , {e}^{j {θ}_{r , {N}_{3}}} .$$

In one example, for the case of per-SB reporting for the phase component, Pᵣ is an N₃×N₃ diagonal matrix including R repeated

$${e}^{j {θ}_{r , i}}$$

values for every R diagonal term. For example, R=2 and N₃=20,

$${P}_{r} = diag ( {e}^{j {θ}_{r , 1}} , {e}^{j {θ}_{r , 1}} , {e}^{j {θ}_{r , 2}} , {e}^{j {θ}_{r 2}} , … , {e}^{j {θ}_{r , 10}} , {e}^{j {θ}_{r , 10}} ) .$$

In one example, co-amplitude (aᵣ) and co-phase ({θ_{r,i}}) for each TRP are reported.
In one example, co-amplitude (a_{r*}) and co-phase ({θ_{r*,i}}) of the strongest TRP r* are fixed (e.g., 1) hence not reported, and co-amplitudes and co-phases for the remaining N_{TRP}−1 TRPs are reported.
In one example, the co-phase component is reported in a WB manner, and the co-amplitude component is reported per SB, per FD unit (total N₃ FD units), or per FD basis vector (total M FD basis vectors). In one example, Qᵣ=e^{jθ}^{ᵣ}Aᵣ, where Aᵣ is a diagonal matrix for the amplitude component.
   In one example, for the case of per-FD-basis vector reporting for the amplitude component, Aᵣ is an M×M diagonal matrix including a_{r,1}, . . . , a_{r,M}.
   In one example, for the case of per-FD-unit reporting for the amplitude component, Aᵣ is an N₃×N₃ diagonal matrix including a_{r,1}, . . . , a_{r,N}_{₃}.
   In one example, for the case of per-SB reporting for the phase component, Aᵣ is an N₃×N₃ diagonal matrix including R repeated a_{r,i} values for every R diagonal term. For example, R=2 and N₃=20, Aᵣ=diag(a_{r,1}, a_{r,1}, a_{r,2}, a_{r,2}, . . . , a_{r,10}, a_{r,10}).
   In one example, for each i of the considered units for either case of per-FD-unit reporting (N₃) or per-SB reporting

$$( \frac{{N}_{3}}{2} )$$

or per-rv-basis vector reporting (M), co-amplitude (a_{r*,i}) and co-phase (θ_{r*}) of the strongest TRP r* are fixed (e.g., 1) hence not reported, and co-amplitudes and co-phase for the remaining N_{TRP}−1 TRPs are reported.
   In one example, a strongest TRP is the same for all units (N₃ for the case of FD compression units,

$$\frac{{N}_{3}}{2}$$

for the case of per-SB reporting, or M for the case of FD-basis-vector reporting), i.e., one strongest TRP is reported.
In one example, a strongest TRP can be different across all units (N₃ for the case of FD compression units,

$$\frac{{N}_{3}}{2}$$

for the case of per-SB reporting, or M for the case of FD-basis-vector reporting), i.e.,

$${N}_{3} , \frac{{N}_{3}}{2} ,$$

or M strongest TRPs are reported.
In one example, both the co-amplitude and co-phase components are reported per SB, per FD unit (total N₃ FD units), or per FD basis vector (total M FD basis vectors). In one example, Qᵣ=AᵣPᵣ, where Aᵣ, Pᵣ are diagonal matrices for the amplitude/phase components.
   In one example, for the case of per-FD-basis vector reporting for the amplitude/phase components, Aᵣ and Pᵣ are M×M diagonal matrices including a_{r,1}, . . . , a_{r,M} and e^{jθ}^{_{r,1}}, . . . , e^{jθ}^{ᵣ}, M, respectively.
   In one example, for the case of per-FD-unit reporting for the amplitude/phase components, Aᵣ and Pᵣ are N₃×N₃ diagonal matrices including a_{r,1}, . . . , a_{r,N}_{₃} and

$${e}^{j {θ}_{r , 1}} , … , {e}^{j {θ}_{r , {N}_{3}}} ,$$

respectively.
In one example, for the case of per-SB reporting for the amplitude/phase components, Aᵣ and Pᵣ are N₃×N₃ diagonal matrices including R repeated a_{r,i} values and e^{jθ}^{_{r,i}}, respectively, for every R diagonal term. For example, R=2 and N₃=20, Aᵣ=diag(a_{r,1}, a_{r,1}, a_{r,2}, a_{r,2}, . . . , a_{r,10}, a_{r,10}) and

$${P}_{r} = diag ( {e}^{j {θ}_{r , 1}} , {e}^{j {θ}_{r , 1}} , {e}^{j {θ}_{r , 2}} , {e}^{j {θ}_{r 2}} , … , {e}^{j {θ}_{r , 10}} , {e}^{j {θ}_{r , 10}} ) .$$

In one example, for each i of the considered units for either case of per-FD-unit reporting (N₃) or per-SB reporting

$$( \frac{{N}_{3}}{2} )$$

or per-FD-basis vector reporting (M), co-amplitude (a_{r*,i}) and co-phase (θ_{r*,i}) of the strongest TRP r* are fixed (e.g., 1) hence not reported, and co-amplitudes and co-phase for the remaining N_{TRP}−1 TRPs are reported.
   In one example, a strongest TRP is the same for all units (N₃ for the case of FD compression units,

$$\frac{{N}_{3}}{2}$$

for the case of per-SB reporting, or M for the case of FD-basis-vector reporting), i.e., one strongest TRP is reported.
In one example, a strongest TRP can be different across all units (N₃ for the case of FD compression units,

$$\frac{{N}_{3}}{2}$$

for the case of per-SB reporting, or M for the case of FD-basis-vector reporting), i.e.,

$${N}_{3} , \frac{{N}_{3}}{2} ,$$

or M strongest TRPs are reported.

In Rel-16/17 Type-II codebook, amplitude quantization scheme for W₂ is in a differential manner, i.e., each amplitude value is computed as p⁽¹⁾p⁽²⁾ where p⁽¹⁾ is a reference amplitude value, and p⁽²⁾ is a (differential) coefficient amplitude value. There are two reference amplitude values

$${p}_{l}^{( 1 )} = [ {p}_{l , 0}^{( 1 )} {p}_{l , 1}^{( 1 )} ]$$

for layer l=1, . . . , v in [9] wherein one reference value corresponding to the SCI is set to 1 (hence not reported, i.e.,

$${k}_{l , ⌊ \frac{{i}_{l}^{*}}{L} ⌋}^{( 1 )} = 15 , {k}_{l , {i}_{l}^{*} , 0}^{( 2 )} = 7 , {k}_{l , {i}_{l}^{*} , 0}^{( 3 )} = 1 and {c}_{l , {i}_{l}^{*} , 0} = 0 ) ,$$

and the other reference value, which corresponds to the other polarization of the coefficient of the SCI, is selected from 4-bit amplitude codebook, Table 5.2.2.2.5-2 in [9], and is reported (i.e., the indicator

$${k}_{l , ( ⌊ \frac{{i}_{l}^{*}}{L} ⌋ + 1 ) mod 2}^{( 1 )}$$

is reported). For p⁽²⁾, please refer to [9] in detail.

In the mTRP codebook of the disclosure, for N_{TRP}≥2, the number of reference amplitude values (on p⁽¹⁾) can be according to at least one of the following examples. Let

$${p}_{r , l}^{( 1 )} = [ {p}_{r , l , 0}^{( 1 )} {p}_{r , l , 1}^{( 1 )} ]$$

be the two reference amplitude values for TRP r∈{1, . . . , N_{TRP}} and layer l=1, . . . , v. N≤N_{TRP} can be configured via RRC, MAC-CE or DCI, or can be determined by UE and reported or can be determined implicitly, where N is the number of (selected) cooperating TRPs among N_{TRP} TRPs.

In one embodiment, a co-amplitude component in a co-scaling component Qᵣ for r=1, . . . , N_{TRP} is an independent component from the reference coefficient component

$${p}_{l}^{( 1 )} .$$

In one embodiment, a co-scaling component Q, for r=1, . . . , N_{TRP} does not include a co-amplitude component but only includes a co-phase component (i.e., Qᵣ=Pᵣ). In one example, (an extension of) the reference coefficient component on pₗ⁽¹⁾ can be utilized as a role of co-amplitude component, i.e., co-amplitude values are absorbed in the reference coefficient component.

In one embodiment, there is no co-scaling component Qᵣ. In one example, (an extension of) the reference coefficient component on

$${p}_{l}^{( 1 )}$$

can be utilized as a role of co-amplitude component, and the phase component in W₂ can be utilized as a role of co-phase component.

In one example, one of the above examples/embodiments is configurable based on RRC, e.g., CSI-reportConfig or MAC-CE or DCI.

In one example, for each of the above examples/embodiments, a_{r,i} and e^{jθr,i} are selected from respective codebooks.
In one example, the codebooks are fixed, e.g., x-bit amplitude and y-bit phase codebooks, where x=3, y=3.
In one example, one codebook is configured via RRC, MAC-CE, or DCI, and the other codebook is fixed. For example, an x-bit amplitude codebook is fixed and an y-bit phase codebook is configured, where x=3, y={3,4}.
In one example, both the codebooks are configured via RRC, MAC-CE, or DCI, For example, x-bit amplitude and y-bit phase codebook is configured, where x={3,4}, y={3,4}.
   Any of the above examples in this embodiment can be applied to other embodiments.

In one embodiment, the value of co-amplitude can be 0, where the value 0 indicates that the corresponding TRP is not selected (or not included) for CSI reporting. In one example, when the UE reports multiple co-amplitude values for each TRP, then either all co-amplitude values are 0 or all values are non-zero (or >0).

When the CSI reporting is via a two-part UCI comprising UCI part 1 and UCI part 2, then the UCI part 1 may include a UCI parameter or indicator indicating an information about whether co-amplitude=0 or >0 for different TRPs.
In one example, a bitmap comprising N_{TRP} bits is used to indicate the information. For example, when a bit value is ‘1’, then corresponding TRP has co-amplitude>0, and when a bit value is ‘0’, then corresponding TRP has co-amplitude=0. Or, when a bit value is ‘0’, then corresponding TRP has co-amplitude>0, and when a bit value is ‘1’, then corresponding TRP has co-amplitude=0.
In one example, a ┌log₂ N_{TRP}┐ bit indicator is used to indicate the number of TRPs with co-amplitude>0. In this case, the indices of TRPs with co-amplitude>0 can be indicated via UCI part 2 (either a separate indicator or via an existing indicator, e.g., bitmap indicator).

In one embodiment, a co-scaling component can be determined/reported using a linear-combination compression technique such as Rel-15/16/17 Type-II CSI codebook. For example, a matrix including co-amplitudes/co-phases across TRPs can be represented as S=S₁S₂ or

$$S = {S}_{1} {S}_{2} {S}_{f}^{H} ,$$

where S₁ is a basis matrix including SD beam vectors on the N_{TRP}-dim space, S_{f} is a basis matrix including FD beam vectors on the N₃-dim or M-dim space, and S₂ is a coefficient matrix including coefficients corresponding to SD/FD beam pairs.

In one embodiment, a UE is configured with an mTRP (or D-MIMO or C-JT) codebook, via e.g., higher layer parameter codebookType set to ‘typeII-r18-cjt’ or ‘typeII-PortSelection-r18-cjt’, where the codebook is one of the following two:
Mode 1: Per-TRP/TRP-group SD/FD basis selection. Example formulation (N_{TRP}=number of TRPs or TRP groups):

$$[ \begin{matrix}{W}_{1 , 1} {\tilde{W}}_{2 , 1} {W}_{f , 1}^{H} \\ ⋮ \\ {W}_{1 , N} {\tilde{W}}_{2 , N} {W}_{f , N}^{H}\end{matrix} ]$$

Mode 2: Per-TRP/TRP group (port-group or resource) SD basis selection and joint (across N_{TRP} TRPs) FD basis selection. Example formulation (N_{TRP}=number of TRPs or TRP groups):

$$[ \begin{matrix}\begin{matrix}{W}_{1 , 1} & 0 \\ 0 & ⋱\end{matrix} & \begin{matrix}0 & 0 \\ 0 & 0\end{matrix} \\ \begin{matrix}0 & 0 \\ 0 & 0\end{matrix} & {W}_{1 , N}\end{matrix} ] {\tilde{W}}_{2} {W}_{f}^{H} or [ \begin{matrix}{W}_{1 , 1} {\tilde{W}}_{2 , 1} {W}_{f}^{H} \\ ⋮ \\ {W}_{1 , N} {\tilde{W}}_{2 , N} {W}_{f}^{H}\end{matrix} ]$$

In one example, Mode 1 is the codebook described in one or more embodiments described herein and Mode 2 is the codebook described in one or more embodiments described herein.

In one example, the two modes can share the same detailed designs such as parameter combinations, basis selection, TRP (group) selection, reference amplitude, \tilde{W}₂ quantization schemes.
In one example, parameter combinations can be a tuple of parameters such as L, pᵥ, β for regular Type-II CJT codebook or a tuple of parameters such as M, α, β for port-selection Type-II CJT codebook.
In one example, basis selection scheme can be SD basis selection and/or FD basis selection schemes described herein.
In one example, a \tilde{W}₂ quantization scheme can include strongest coefficient indicator, upper bound of non-zero coefficients, reference amplitudes, a scheme that each coefficient is decomposed into phase and amplitude and they are selected respective codebooks, and a codebook subset restriction.

In one embodiment, a UE reports UE capability on possible mode operations among the two modes.
In one example, a UE reports Mode 1-only as UE capability. If NW receives this UE capability, the NW can configure Mode 1 only to the UE.
In one example, a UE reports Mode 2-only as UE capability. If NW receives this UE capability, the NW can configure Mode 2 only to the UE.
In one example, a UE reports Modes 1 and 2 as UE capability. If NW receives this UE capability, the NW can configure either Mode 1 or Mode 2 to the UE.

In one embodiment, the two modes support a same set of rank candidates [symbol] , i.e., any rank in [symbol] can be configured for either mode 1 or mode 2.
In one example, [symbol] ={1,2}.
In one example, [symbol] ={1,2,3}.
In another example [symbol] ={1,2,3,4}.

In one embodiment, each mode i support a different set of rank candidates [symbol] ᵢ.
In one example, low ranks, e.g., [symbol] ₁={1,2}, can be configured for Mode 1, and high ranks, e.g., [symbol] ₂={3,4}, can be configured for Mode 2.
In one example, low ranks, e.g., [symbol] ₂={1,2}, are for Mode 2, and high ranks, e.g., [symbol] ₁={3,4}, are for Mode 1.
In one example, low ranks, e.g., [symbol] ₁={1,2}, are for Mode 1, and any rank, e.g., [symbol] ₂={1,2,3,4}, is for Mode 2.
In one example, low ranks, e.g., [symbol] ₂={1,2}, are for Mode 2, and any rank, e.g., [symbol] ₁={1,2,3,4}, is for Mode 2.

In one embodiment, there are common codebook parameters for Mode 1 and Mode 2, and mode-specific codebook parameters.
In one example, L (or Lₛᵤₘ or Lᵣ) value(s) is a common parameter for both Mode 1 and Mode 2, i.e., same value(s) can be configured for both Mode 1 and Mode 2.
In one example, L (or Lₛᵤₘ or Lᵣ) value(s) is a mode-specific parameter, i.e., independent L value(s) can be configured for each mode.
In one example Mᵥ

$$( or {M}_{v , sum} = {\sum }_{r = 1}^{{N}_{TRP}} {M}_{v , r} or {M}_{v , r} )$$

value(s) is a common parameter for both Mode 1 and Mode 2, i.e., same value(s) of Mᵥ

$$( or {M}_{v , sum} = {\sum }_{r = 1}^{{N}_{TRP}} {M}_{v , r} or {M}_{v , r} )$$

can be configured for both Mode 1 and Mode 2.
In one example, Mᵥ (or M_{v,sum} or M_{v,r}) value(s) is a mode-specific parameter, i.e., independent M_{υ} (or M_{v,sum} or M_{v,r}) value(s) can be configured for each mode.

In one embodiment, one of the two modes is signaled to UE according to at least one of the following examples:

In one example, a new RRC parameter is introduced to choose/indicate one of Mode 1 and Mode 2, for example, a higher-layer parameter codebookMode is used, where codebookMode is set to Mode1 when Mode 1 is configured, and is set to Mode2 when Mode 2 is configured.

One example can be as follows:

| CodebookConfig-r18 ::= | SEQUENCE { |
|---|---|
| codebookType | CHOICE { |
| type2-cjt | SEQUENCE { |
| subType | CHOICE { |
| typeII-r18-cjt | SEQUENCE { |
| ... (codebook parameters for typeII-r18-cjt) | |
| }, | |
| typeII-PortSelection-r18-cjt | SEQUENCE { |
| ... (codebook parameters for typeII-PortSelection-r18-cjt) | |
| } | |
| }, | |
| ... (common codebook parameters for typeII-r18-cjt and typeII-PortSelection-r18-cjt) | |
| codebookMode | INTEGER (1..2) |

```
    }
  }
}
```

Another example can be as follows:

| CodebookConfig-r18 ::= | SEQUENCE { |
|---|---|
| codebookType | CHOICE { |
| type2-cjt | SEQUENCE { |
| ... (codebook parameters for typeII-r18-cjt) | |
| }, | |
| ... | |
| codebookMode | INTEGER (1..2) |
| }, | |
| type2-PortSelection-cjt | SEQUENCE { |
| ... (codebook parameters for typeII-PortSelection-r18-cjt) | |
| }, | |
| ... | |
| codebookMode | INTEGER (1..2) |
| } | |

}
}

Another example can be as follows:

| CodebookConfig-r18 ::= | SEQUENCE { |
|---|---|
| codebookType | CHOICE { |
| type2-cjt | SEQUENCE { |
| subType | CHOICE { |
| typeII-r18-cjt | SEQUENCE { |
| codebookMode | CHOICE { |
| Mode 1 | SEQUENCE { |
| ... (CodebookParameters for Mode1) | |
| }, | |
| Mode 2 | SEQUENCE { |
| ... (CodebookParameters for Mode2) | |
| }, | |
| ... (common codebook parameters for both Mode 1 and Mode 2) | |
| }, | |
| typeII-PortSelection-r18-cjt | SEQUENCE { |
| codebookMode | CHOICE { |
| Mode 1 | SEQUENCE { |
| ... (CodebookParameters for Mode1) | |
| }, | |
| Mode 2 | SEQUENCE { |

```
                ... (CodebookParameters for Mode2)
              },
            ... (common codebook parameters for Mode 1 and Mode 2)
          }
        },
      ... (common codebook parameters for typeII-r18-cjt and typeII-PortSelection-r18-cjt)
      }
    }
  }
```

Another example can be as follows:

| CodebookConfig-r18 ::= | SEQUENCE { |
|---|---|
| codebookType | CHOICE { |
| type2-cjt | SEQUENCE { |
| codebookMode | CHOICE { |
| Mode 1 | SEQUENCE { |
| ... (CodebookParameters for Mode1) | |
| }, | |
| Mode 2 | SEQUENCE { |
| ... (CodebookParameters for Mode2) | |
| }, | |
| ... (common codebook parameters for both Mode 1 and Mode 2) | |
| }, | |
| } | |
| type2-PortSelection-cjt | SEQUENCE { |
| codebookMode | CHOICE { |
| Mode1 | SEQUENCE { |
| ... (CodebookParameters for Mode1) | |
| }, | |
| Mode2 | SEQUENCE { |

```
            ... (CodebookParameters for Mode2)
        },
      ... (common codebook parameters for Mode 1 and Mode 2)
      },
    }
  }
}
```

In one example, an extension of existing parameters is used to choose/indicate one of Mode 1 and Mode 2, for example, higher-layer parameter codebookType is set to typeII-r18-cjt-mode1, typeII-r18-cjt-mode2, typeII-PortSelection-r18-cjt-mode1, or typeII-PortSelection-r18-cjt-mode2.

One example can be as follows:

| | |
|---|---|
| CodebookConfig-r18 ::= | SEQUENCE { |
| codebookType | CHOICE { |
| type2-cjt | SEQUENCE { |
| subType | CHOICE { |
| typeII-r18-cjt-mode1 | SEQUENCE { |

```
          ... (codebook parameters for typeII-r18-cjt-mode1)
        },
```

| | |
|---|---|
| typeII-r18-cjt-mode2 | SEQUENCE { |

```
          ... (codebook parameters for typeII-r18-cjt-mode2)
        },
```

| | |
|---|---|
| typeII-PortSelection-r18-cjt-mode1 | SEQUENCE { |

```
          ... (codebook parameters for typeII-PortSelection-r18-cjt-mode1)
        },
```

| | |
|---|---|
| typeII-PortSelection-r18-cjt-mode2 | SEQUENCE { |

```
          ... (codebook parameters for typeII-PortSelection-r18-cjt-mode2)
        },
      },
    ... (common codebook parameters for typeII-r18-cjt and typeII-PortSelection-r18-cjt)
    }
  }
}
```

Another example can be as follows:

| | |
|---|---|
| CodebookConfig-r18 ::= | SEQUENCE { |
| codebookType | CHOICE { |
| type2-cjt-mode1 | SEQUENCE { |

```
      ... (codebook parameters for typeII-r18-cjt-mode1)
      },
```

| | |
|---|---|
| type2-cjt-mode2 | SEQUENCE { |

```
      ... (codebook parameters for typeII-r18-cjt-mode2)
      },
    },
```

| | |
|---|---|
| type2-PortSelection-cjt-mode1 | SEQUENCE { |

```
      ... (codebook parameters for typeII-PortSelection-r18-cjt-mode1)
      },
```

| | |
|---|---|
| type2-PortSelection-cjt-mode2 | SEQUENCE { |

```
      ... (codebook parameters for typeII-PortSelection-r18-cjt-mode2)
      },
    }
  }
}
```

In one example, a UE is indicated/configured with either mode 1 or mode 2 via MAC-CE or DCI.

In another example, a UE determines one of the two modes and reports it as a part of CSI report (e.g., via UCI part 1 of a two-part UCI).

In one example, FD bases (or FD basis vectors) in the set can be consecutive/non-consecutive, and are selected freely by NW from an orthogonal DFT matrix.

In the present disclosure, the term ‘polarization’ is used to indicate a group of CSI-RS antenna ports. For example, a first polarization can correspond to CSI-RS antenna ports

$$\{ 0 , 1 , … , \frac{{P}_{CSIRS}}{2} - 1 \}$$

and a second polarization can correspond to CSI-RS antenna ports

$$\{ \frac{{P}_{CSIRS}}{2} , … {P}_{CSIRS} - 1 \} .$$

The coefficients matrix W₂ across all TRPs can be determined based per TRP W_{2.r} matrices, where r=1, . . . , N_{TRP}. For example,
When W_{f} is TRP-common (one W_{f} common for all TRPs), then

$${W}_{2} = [ \begin{matrix}{W}_{2 , 1} \\ ⋮ \\ {W}_{2 , {N}_{TRP}}\end{matrix} ]$$

is the coefficient matrix across all TRPs.
When W_{f} is TRP-specific (one W_{f,r} for each TRP r), then

$${W}_{2} = [ \begin{matrix}{W}_{2 , 1} & 0 & 0 \\ 0 & ⋱ & 0 \\ 0 & 0 & {W}_{2 {N}_{TRP}}\end{matrix} ]$$

is the coefficient matrix across all TRPs.

In one embodiment, a strongest coefficient indicator (SCI) is used to indicate the location (or index) of the strongest coefficient of the component W₂ across all TRPs. (The other coefficients are normalized by the coefficient of the SCI.) In one example, the SCI is common for all layers, i.e., one SCI is reported for all layers. In another example, the SCI is layer-specific, i.e., one SCI is reported for each layer value. The coefficient corresponding to the SCI is set to 1 (hence not reported).

The payload of the SCI can be according to one of the following examples.
In one example, the payload is ┌log₂(X)┐ bits.
   In one example, X=2L (e.g., when L SD basis vectors are joint across TRPs).
   In one example,

$$X = 2 {\sum }_{r = 1}^{{N}_{TRP}} {L}_{r}$$

(e.g., when SD basis vectors are separate for each TRP, and each TRP can have different number of SD basis vectors).
In one example, X=2N_{TRP}L (e.g., when SD basis vectors are separate for each TRP, and each TRP has same number of SD basis vectors).
In one example, X=2LM or 2LM_{υ} (e.g., when L SD basis vectors and FD basis vectors are joint across TRPs).
In one example,

$$X = 2 {\sum }_{r = 1}^{{N}_{TRP}} {L}_{r} {M}_{r}$$

vectors are separate for each TRP, and each TRP can have different number of SD/FD basis vectors).
In one example,

$$X = 2 M {\sum }_{r = 1}^{{N}_{TRP}} {L}_{r} .$$

In one example,

$$X = 2 L {\sum }_{r = 1}^{{N}_{TRP}} {M}_{r} .$$

In one example,

$$X = 2 {\sum }_{r = 1}^{{N}_{TRP}} {L}_{r} {M}_{r} .$$

In one example, X=2N_{TRP}LM (e.g., when SD/FD basis vectors are separate for each TRP, and each TRP has same number of SD/FD basis vectors).
In one example, X=β2LM or β2LM_{υ} (e.g., when L SD basis vectors and FD basis vectors are joint across TRPs).
In one example,

$$X = 2 β {\sum }_{r = 1}^{{N}_{TRP}} {L}_{r} {M}_{r}$$

(e.g., when SD basis vectors and FD basis vectors are separate for each TRP, and each TRP can have different number of SD/FD basis vectors).
In one example,

$$X = 2 M β {\sum }_{r = 1}^{{N}_{TRP}} {L}_{r} .$$

In one example,

$$X = 2 L β {\sum }_{r = 1}^{{N}_{TRP}} {M}_{r} .$$

In one example,

$$X = 2 β {\sum }_{r = 1}^{{N}_{TRP}} {L}_{r} {M}_{r} .$$

In one example, X=2N_{TRP}βLM (e.g., when SD/FD basis vectors are separate for each TRP, and each TRP has same number of SD/FD basis vectors).
In one example, the payload is ┌log₂(X)┐+┌log₂(Y)┐ bits, where ┌log₂(X)┐ bits are used to indicate the index of the strongest coefficient and ┌log₂(Y)┐ bits are used to indicate the index of the TRP the strongest coefficient belong to (e.g., strongest TRP).
   In one example, X=2L and Y=N_{TRP}.
   In one example, X=2Lᵣ and Y=N_{TRP}.
   In one example, X=2LM and Y=N_{TRP}.
   In one example, X=2LᵣMᵣ and Y=N_{TRP}.
   In one example, X=β2LM and Y=N_{TRP}.
   In one example, X=β2LᵣMᵣ and Y=N_{TRP}.

Here, the SCI can implicitly indicate a strongest TRP. That is, the TRP index r* the strongest coefficient belongs to is also the strongest TRP.

In one example, a strongest TRP described in all embodiments/examples in this disclosure can be replaced by a reference TRP or a selected TRP (from a total of N_{TRP} TRPs). In one example, a reference TRP can be configured via RRC, MAC-CE, or DCI. In one example, a reference TRP can be fixed or determined in a pre-defined rule. In one example, a reference TRP can be determined by UE and reported as a part of CSI.

In one example, the SCI comprises a pair of indicators (x, y), where the indicator x indicates the index of the strongest coefficient, and the indicator y indicates the index of the TRP the strongest coefficient belong to (e.g., y is a strongest TRP indicator).

In one example, there are two separate indicators (x, y), where the SCI corresponds to x and the strongest TRP indicator corresponds to y.

In one example, the payload of the indicator y is ┌log₂(Y)┐ bits.

In one example, the payload of the indicator y is ┌log₂(X)┐ bits.
In one example, X=2L.
In one example, X=2Lᵣ.
In one example, X=2LM.
In one example, X=2LᵣMᵣ.
In one example, X=β2LM.
In one example, X=β2LᵣMᵣ.

In Rel-16/17 Type-II codebook, the amplitude quantization scheme for W₂ is in a differential manner, i.e., each amplitude value is computed as p⁽¹⁾p⁽²⁾ where p⁽¹⁾ is a reference amplitude value, and p⁽²⁾ is a (differential) coefficient amplitude value. There are two reference amplitude values

$${p}_{l}^{( 1 )} = [ {p}_{l , 0}^{( 1 )} {p}_{l , 1}^{( 1 )} ]$$

for layer l=1, . . . , v in [9] wherein one reference value corresponding to the SCI is set to 1 (hence not reported, i.e.,

$${k}_{l , ⌊ \frac{{i}_{l}^{*}}{L} ⌋}^{( 1 )} = 15 , {k}_{l , {i}_{l}^{*} , 0}^{( 2 )} = 7 , {k}_{l , {i}_{l}^{*} , 0}^{( 3 )} = 1 and {c}_{l , {i}_{l}^{*} , 0} = 0 ) ,$$

and the other reference value, which corresponds to the other polarization of the coefficient of the SCI, is selected from 4-bit amplitude codebook, Table 5.2.2.2.5-2 in [9], and is reported (i.e., the indicator

$${k}_{l , ( ⌊ \frac{{i}_{l}^{*}}{L} ⌋ + 1 ) mod 2}^{( 1 )}$$

is reported). For p⁽²⁾, please refer to [9] in detail.

In the mTRP codebook of the disclosure, for N_{TRP}≥2, the number of reference amplitude values (on p⁽¹⁾) can be according to at least one of the following examples. Let

$${p}_{r , l}^{( 1 )} = [ {p}_{r , l , 0}^{( 1 )} {p}_{r , l , 1}^{( 1 )} ]$$

be the two reference amplitude values for TRP r∈{1, . . . , N_{TRP}} and layer l=1, . . . , v.

In one example, for each layer l (layer-specific), the number of reference amplitude values (N_{ref}) is fixed regardless of the value of N_{TRP}. For example, N_{ref}=2. So, there are a total of 2υ reference amplitude values for υ layers.
In one example, similar to Rel-16/17 Type-II codebook, for each layer l, one reference value corresponding to the SCI is set to 1 for the polarization

$$( {x}^{*} = ⌊ \frac{{i}_{l}^{*}}{L} ⌋ )$$

### of the SCI for all TRPs, i.e.,

$${p}_{r , l , {x}^{*}}^{( 1 )} = 1$$

for all r values, and the other reference value for the other polarization (x≠x*) for all TRPs is selected from 4-bit amplitude codebook and is reported. So, the total payload is 4N_{TRP} bits per layer.
In one example, similar to Rel-16/17 Type-II codebook, for each layer l, one reference value corresponding to the SCI is set to 1 for the polarization

$$( {x}^{*} = ⌊ \frac{{i}_{l}^{*}}{L} ⌋ )$$

of the SCI for the strongest TRP, i.e.,

$${p}_{{r}^{*} , l , {x}^{*}}^{( 1 )} = 1$$

for the r* value associated with the strongest TRP, and the other reference value for the other polarization (x≠x*) for the strongest TRP is selected from 4-bit amplitude codebook and is reported. So, the total payload is 4 bits per layer.
In one example, similar to Rel-16/17 Type-II codebook, for each layer l, one reference value corresponding to the SCI is set to 1 for the polarization

$$( {x}^{*} = ⌊ \frac{{i}_{l}^{*}}{L} ⌋ )$$

of the SCI for the strongest TRP, i.e.,

$${p}_{{r}^{*} , l , {x}^{*}}^{( 1 )} = 1$$

for the r* value associated with the strongest TRP, and the other reference value for the remaining coefficients not associated with the polarization of the SCI for the strongest TRP (i.e., ∀(r,x)≠(r*,x*) is selected from 4-bit amplitude codebook and is reported. So, the total payload is 4 bits per layer.
In one example, for each layer l, one reference value corresponding to the SCI is set to 1 (hence no reported) for the polarization of the SCI for all TRPs. For each layer l, for the other polarization of the SCI, a second strongest coefficient indicator is used to indicate the location (or index) of the strongest coefficient of the W₂ across all TRPs (i.e., among a half of number of coefficients in W₂ for the other polarization of the SCI). The other reference value corresponding to the second SCI is selected from an x-bit amplitude codebook (e.g., x=4) and is reported. This reference value is for the other polarization of the SCI for all TRPs.

In one example, the number of reference amplitude values (N_{ref}) is fixed regardless of the value of N_{TRP}. For example, N_{ref}=2, and the total number of reference amplitude values for v layers is 2 (layer-common).
In one example, for all layers, one reference value corresponding to the SCI is set to 1 for the polarization

$$( {x}^{*} = ⌊ \frac{{i}_{l}^{*}}{L} ⌋ )$$

### of the SCI for all TRPS, i.e.,

$${p}_{r , l , {x}^{*}}^{( 1 )} = 1$$

for all r values, and the other reference value for the other polarization (x≠x*) for all TRPs is selected from 4-bit amplitude codebook and is reported. So, the total payload is 4N_{TRP} bits for all layers.
In one example, similar to Rel-16/17 Type-II codebook, for all layers l, one reference value corresponding to the SCI is set to 1 for the polarization

$$( {x}^{*} = ⌊ \frac{{i}_{l}^{*}}{L} ⌋ )$$

of the SCI for the strongest TRP, i.e.,

$${p}_{{r}^{*} , l , {x}^{*}}^{( 1 )} = 1$$

for the r* value associated with the strongest TRP, and the other reference value for the other polarization (x≠x*) for the strongest TRP is selected from 4-bit amplitude codebook and is reported. So, the total payload is 4 bits for all layers.
In one example, similar to Rel-16/17 Type-II codebook, for all layers l, one reference value corresponding to the SCI is set to 1 for the polarization

$$( {x}^{*} = ⌊ \frac{{i}_{l}^{*}}{L} ⌋ )$$

of the SCI for the strongest TRP, i.e.,

$${p}_{{r}^{*} , l , {x}^{*}}^{( 1 )} = 1$$

for the r* value associated with the strongest TRP, and the other reference value for the remaining coefficients not associated with the polarization of the SCI for the strongest TRP (i.e., ∀(r,x)≠(r*,x*) is selected from 4-bit amplitude codebook and is reported. So, the total payload is 4 bits for all layers.
In one example, for all layers, one reference value corresponding to the SCI is set to 1 (hence no reported) for the polarization of the SCI for all TRPs. For all layers, for the other polarization of the SCI, a second strongest coefficient indicator is used to indicate the location (or index) of the strongest coefficient of the W₂ across all TRPs (i.e., among a half of number of coefficients in W₂ for the other polarization of the SCI). The other reference value corresponding to the second SCI is selected from an x-bit amplitude codebook (e.g., x=4) and is reported. This reference value is for the other polarization of the SCI for all TRPs.

In one example, for each layer l (layer-specific), the number of reference amplitude values (N_{ref}) is fixed regardless of the value of N_{TRP}. For example, N_{ref}=3. So, there are a total of 3υ reference amplitude values for v layers.
In one example, similar to Rel-16/17 Type-II codebook, for each layer l, one reference value corresponding to the SCI is set to 1 for the polarization

$$( {x}^{*} = ⌊ \frac{{i}_{l}^{*}}{L} ⌋ )$$

of the SCI for the strongest TRP, i.e.,

$${p}_{{r}^{*} , l , {x}^{*}}^{( 1 )} = 1$$

for the r* value associated with the strongest TRP, and another other reference value for the other polarization (x≠x*) for the strongest TRP is selected from 4-bit amplitude codebook and is reported, and the other reference value for the remaining coefficients not associated with the strongest TRP is selected from 4-bit amplitude codebook and is reported. So, the total payload is 8 bits per layer.

In one example, the number of reference amplitude values (N_{ref}) is fixed regardless of the value of N_{TRP}. For example, N_{ref}=3, and the total number of reference amplitude values for v layers is 3 (layer-common).
In one example, similar to Rel-16/17 Type-II codebook, for all layers, one reference value corresponding to the SCI is set to 1 for the polarization

$$( {x}^{*} = ⌊ \frac{{i}_{l}^{*}}{L} ⌋ )$$

of the SCI for the strongest TRP, i.e.,

$${p}_{{r}^{*} , l , {x}^{*}}^{( 1 )} = 1$$

for the r* value associated with the strongest TRP, and another other reference value for the other polarization (x≠x*) for the strongest TRP is selected from 4-bit amplitude codebook and is reported, and the other reference value for the remaining coefficients not associated with the strongest TRP is selected from 4-bit amplitude codebook and is reported. So, the total payload is 8 bits for all layers.

In one example, for each layer l (layer-specific), the number of reference amplitude values (N_{ref}) is fixed regardless of the value of N_{TRP}. For example, N_{ref}=4. So, there are a total of 4υ reference amplitude values for v layers.
In one example, similar to Rel-16/17 Type-II codebook, for each layer l, one reference value corresponding to the SCI is set to 1 for the polarization

$$( {x}^{*} = ⌊ \frac{{i}_{l}^{*}}{L} ⌋ )$$

of the SCI for the strongest TRP, i.e.,

$${p}_{{r}^{*} , l , {x}^{*}}^{( 1 )} = 1$$

for the r* value associated with the strongest TRP, and a second reference value for the other polarization (x≠x*) for the strongest TRP is selected from 4-bit amplitude codebook and is reported, and a third reference value for the remaining coefficients for the TRPs not associated with the strongest TRP for the polarization of the SCI is selected from 4-bit amplitude codebook and is reported, and a fourth reference value for the remaining coefficients for the TRPs not associated with the strongest TRP for the other polarization of the SCI is selected from 4-bit amplitude codebook and is reported. So, the total payload is 12 bits per layer.

In one example, the number of reference amplitude values (N_{ref}) is fixed regardless of the value of N_{TRP}. For example, N_{ref}=4, and the total number of reference amplitude values for v layers is 4 (layer-common).
In one example, similar to Rel-16/17 Type-II codebook, for all layers, one reference value corresponding to the SCI is set to 1 for the polarization

$$( {x}^{*} = ⌊ \frac{{i}_{l}^{*}}{L} ⌋ )$$

of the SCI for the strongest TRP, i.e.,

$${p}_{{r}^{*} , l , {x}^{*}}^{( 1 )} = 1$$

for the r* value associated with the strongest TRP, and a second reference value for the other polarization (x≠x*) for the strongest TRP is selected from 4-bit amplitude codebook and is reported, and a third reference value for the remaining coefficients for the TRPs not associated with the strongest TRP for the polarization of the SCI is selected from 4-bit amplitude codebook and is reported, and a fourth reference value for the remaining coefficients for the TRPs not associated with the strongest TRP for the other polarization of the SCI is selected from 4-bit amplitude codebook and is reported. So, the total payload is 12 bits for all layers.

In one example, for each of the above examples, equal-bit codebook (e.g., 4-bit) can be used for reference amplitude values.

In another example, for each of the above examples, unequal-bit codebook (e.g., 4-bit) can be used for reference amplitude values.
For example, for a reference amplitude value associated with a strongest TRP, 4-bit amplitude codebook is used, and for a reference amplitude value associated a weaker TRP, 3-bit amplitude codebook is used. The unequal-bit can be signaled by NW via RRC, MAC-CE, or DCI.

In one example, for each layer l (layer-specific), the number N_{ref} of reference amplitude values is 2N_{TRP}.
In one example, one reference value corresponding to the SCI is set to 1 (hence not reported) for the polarization of the SCI for the TRP associated with the SCI, and another reference value is for the other polarization for the TRP associated with the SCI, is selected from an x-bit amplitude codebook (e.g., x=4), and is reported. Each of the remaining 2N_{TRP}−2 reference values is a reference amplitude value for each polarization for each of the other (N_{TRP}−1) TRPs that are not associated with the SCI. The reference amplitude value is selected from an y-bit amplitude codebook (e.g., y=4, or y=3), and is reported. In one example, x,y can be the same value (x=y), fixed or configured by NW.
In one example, one reference value corresponding to the SCI is set to 1 (hence no reported) for the polarization of the SCI for the TRP associated with the SCI. For the other polarization, a second strongest coefficient indicator is used to indicate the location (or index) of the strongest coefficient of the W₂ across all TRPs (i.e., among a half of number of coefficients in W₂ for the other polarization of the SCI). Another reference value corresponding to the second SCI is selected from an x-bit amplitude codebook (e.g., x=4) and is reported. In one example, the second SCI is common for all layers i.e., one second-SCI is reported for all layers. In another example, the second-SCI is layer-specific, i.e., one second-SCI is reported for each layer value. In one example, the other 2N_{TRP}−2 remaining reference values are partitioned into two groups, wherein group 1 is for the polarization of the SCI for each of the (N_{TRP}−1) TRPs not associated with the SCI, and group 2 is for the other polarization of the SCI for each of the (N_{TRP}−1) TRPs not associated with the SCI. For the reference values in group 1, each reference value is selected from an y₁-bit amplitude codebook. For the reference values in group 2, each reference value is selected from an y₂-bit amplitude codebook. In one example, each reference value in group 2 is a second-level reference value, i.e., each corresponding resultant reference value is computed as the product of the second-level reference value and the reference value for the other polarization of the SCI for the TRP associated with the SCI. In one example, x, y₁, y₂ can be the same value, fixed or configured by NW.

In one example, for all layers (layer-common), the number N_{ref} of reference amplitude values is 2N_{TRP}. The above examples can be the examples for all layers.

In one example, for each layer l (layer-specific), the number N_{ref} of reference amplitude values is 2+(N_{TRP}−1).
In one example, one reference value corresponding to the SCI is set to 1 (hence not reported) for the polarization of the SCI for the TRP associated with the SCI, and another reference value is for the other polarization of the SCI for the TRP associated with the SCI, is selected from an x-bit amplitude codebook (e.g., x=4), and is reported. Each of the remaining N_{TRP}−1 reference values is a reference amplitude value for both the polarizations for each of the other (N_{TRP}−1) TRPs not associated with the SCI. The reference amplitude value is selected from an y-bit amplitude codebook (e.g., y=4, or y=3), and is reported. In one example, x,y can be the same value, fixed or configured by NW.

In one example, for all layers (layer-common), the number N_{ref} of reference amplitude values is 2+(N_{TRP}−1). The above examples can be the examples for all layers.

In one example, for each layer l (layer-specific), the number N_{ref} of reference amplitude values is N_{TRP}.
In one example, one reference value corresponding to the SCI is set to 1 (hence not reported) for the both polarizations for the TRP associated with the SCI, and each of the remaining N_{TRP}−1 reference value is for the both polarizations for each of the N_{TRP}−1 TRPs not associated with the SCI, is selected from an x-bit amplitude codebook (e.g., x=4), and is reported. Each of the remaining N_{TRP}−1 reference values is a reference amplitude value for both the polarizations for each of the other (N_{TRP}−1) TRPs not associated with the SCI. The reference amplitude value is selected from an y-bit amplitude codebook (e.g., y=4, or y=3), and is reported. In one example, x,y can be the same value, fixed or configured by NW.

In one example, for all layers (layer-common), the number N_{ref} of reference amplitude values is N_{TRP}. The above examples can be the examples for all layers.

In one example, for each layer I (layer-specific), the number N_{ref} of reference amplitude values is N_{TRP}-specific.
In one example, N_{ref}=a for N_{TRP}≤b, and N_{ref}=c for N_{TRP}>b, e.g., a=2, b=3, c=4.

In one example, for all layers (layer-common), the number N_{ref} of reference amplitude values is N_{TRP}-specific. The above examples can be the examples for all layers.

In one example, for each layer l (layer-specific), the number N_{ref} of reference amplitude values is configured by NW.
In one example, N_{ref}={2, 2N_{TRP}} and one of the values is configured via DCI, MAC-CE, or RRC parameter. Once one value is configured, reference amplitude values can be according to one of the above examples.
In one example, N_{ref}={2, 2+N_{TRP}−1} and one of the values is configured via DCI, MAC-CE, or RRC parameter. Once one value is configured, reference amplitude values can be according to one of the above examples.
In one example, N_{ref}={2, N_{TRP}} and one of the values is configured via DCI, MAC-CE, or RRC parameter. Once one value is configured, reference amplitude values can be according to one of the above examples.
In one example, N_{ref}={2, N_{TRP}, 2N_{TRP}} and one of the values is configured via DCI, MAC-CE, or RRC parameter. Once one value is configured, reference amplitude values can be according to one of the above examples.
In one example, N_{ref}={2,2+N_{TRP}−1,2N_{TRP}} and one of the values is configured via DCI, MAC-CE, or RRC parameter. Once one value is configured, reference amplitude values can be according to one of the above examples.
In one example, any subset of {2,3,4, N_{TRP}, 2N_{TRP}, 2+N_{TRP}−1} can be a set for N_{ref}, and one of the values is configured via DCI, MAC-CE, or RRC parameter. Once one value is configured, reference amplitude values can be according to one of the above examples.

In one example, for all layers (layer-common), the number N_{ref} of reference amplitude values is configured by NW. The above examples can be the examples for all layers.

In one example, for each layer l (layer-specific), the number N_{ref} of reference amplitude values is determined by UE and reported.
In one example, N_{ref}={2, 2N_{TRP}} and one of the values is determined and reported. Once one value is determined, reference amplitude values can be according to one of the above examples.
In one example, N_{ref}={2, 2+N_{TRP}−1} and one of the values is determined and reported. Once one value is determined, reference amplitude values can be according to one of the above examples.
In one example, N_{ref}={2, N_{TRP}} and one of the values is determined and reported. Once one value is determined, reference amplitude values can be according to one of the above examples.
In one example, N_{ref}={2, N_{TRP}, 2N_{TRP}} and one of the values is determined and reported. Once one value is determined, reference amplitude values can be according to one of the above examples.
In one example, N_{ref}={2,2+N_{TRP}−1,2N_{TRP}} and one of the values is determined and reported. Once one value is determined, reference amplitude values can be according to one of the above examples.
In one example, any subset of {2,3,4, N_{TRP}, 2N_{TRP}, 2+N_{TRP}−1} can be a set for N_{ref}, and one of the values is determined and reported. Once one value is determined, reference amplitude values can be according to one of the above examples.

In one example, for all layers (layer-common), the number N_{ref} of reference amplitude values is determined by UE and reported. The above examples can be the examples for all layers.

In one embodiment, for the mTRP codebook, W_{f} basis vectors (or indices of FD basis vectors) and W₂ FD indices (columns of W₂) or FD indices of coefficients are shifted (or rotated or remapping) based on or with respect to the FD beam index f*, which can be reference FD beam index.

In Rel-16 Type-II codebook, the remapping procedure is as follows [9]: Let f*ₗ∈{0, 1, . . . , M_{υ}−1} be the index of i_{2,4,l} and i*ₗ∈{0, 1, . . . , 2L−1} be the index of

$${k}_{l , {f}_{l}^{*}}^{( 2 )}$$

which identify the strongest coefficient of layer l, i.e., the element

$${k}_{l , {i}_{l}^{*} , {f}_{l}^{*}}^{( 2 )}$$

of i_{2,4,l}, for l=1, . . . , υ. The codebook indices of n_{3,l} are remapped with respect to

$${n}_{3 , l}^{( {f}_{l}^{*} )}$$

as

$${n}_{3 , l}^{( f )} = ( {n}_{3 , l}^{( f )} - {n}_{3 , l}^{( {f}_{l}^{*} )} ) mod {N}_{3} ,$$

such that

$${n}_{3 , l}^{( {f}_{l}^{*} )} = 0 ,$$

after remapping. The index f is remapped with respect to

$${f}_{l}^{*}$$

as

$$f = ( f - {f}_{l}^{*} ) mod {M}_{υ} ,$$

such that the index of the strongest coefficient is f*ₗ=0 (l=1, . . . , υ), after remapping. The indices of i_{2,4,l}, i_{2,5,l} and i_{1,7,l} indicate amplitude coefficients, phase coefficients and bitmap after remapping.

In one example, the strongest coefficient of layer l is identified by i_{1,8,l}∈{0, 1, . . . , 2L−1}, which is obtained as follows

$${i}_{1 , 8 , l} = \{ \begin{matrix}{\sum }_{i = 0}^{{i}_{1}^{*}} {k}_{1 , i , 0}^{( 3 )} - 1 & υ = 1 \\ {i}_{l}^{*} & 1 < υ \leq 4\end{matrix}$$

for l=1, . . . , υ.

In one example, the strongest coefficient of layer l is identified by i_{1,8,l}∈{0, 1, . . . , 2L−1}, which is obtained as follows

$${i}_{1 , 8 , l} = {i}_{l}^{*}$$

for all rank υ={1, . . . , 4} and for l=1, . . . , υ.

In one example, the reference FD beam index f* is the FD beam index f of the SCI (of the strongest TRP). The SCI hence the index f* is layer-common, i.e., the same for all layers.

In one example, the reference FD beam index f* is the FD beam index f of the SCI of a reference TRP. The SCI hence the index f* is layer-common, i.e., the same for all layers.

In one example, a reference TRP can be configured via RRC, MAC-CE, or DCI. In one example, a reference TRP can be fixed or determined in a pre-defined rule. In one example, a reference TRP can be determined by UE and reported as a part of CSI. In one example, a strongest TRP can be a reference TRP.

In one example, the reference FD beam index f* is fixed (e.g., the lowest index among the FD basis vectors). The fixed index f* is layer-common, i.e., the same for all layers.

In one example, the reference FD beam index f* is a configured, via, DCI, MAC-CE, or RRC by NW (layer-common). The configured index can be one of indices of FD basis vectors. Or, the configured index can be different from indices of FD basis vectors. The configured index f* is layer-common, i.e., the same for all layers.

In one example, W_{f} basis vectors and W₂ FD indices (columns of W₂) associated with the strongest TRP (or a reference TRP) are shifted (or rotate or remapping FD indices) based on the FD beam index f*, where f* is according to one of the above examples herein. For the rest of the TRPs, the shift or rotation or remapping may not be performed. The index f* is layer-common, i.e., the same for all layers.

In one example, W_{f} basis vectors and W₂ FD indices (columns of W₂) associated with all TRPs are shifted (or rotated or remapping FD indices) based on the FD beam index f*, where f* is according to one of the above examples (I.19.1 through I.19.3).

In one example, the reference FD beam index

$${f}_{l}^{*}$$

is the FD beam index fₗ of the SCI (of the strongest TRP, or a reference TRP) for each layer l. The SCI hence the index

$${f}_{l}^{*}$$

is layer-specific, i.e., one SCI for each layer.

In one example, the reference FD beam index

$${f}_{l}^{*}$$

is fixed (e.g., the lowest index among the FD basis vectors) for each layer l. The fixed index

$${f}_{l}^{*}$$

is layer-specific, i.e., one SCI for each layer.

In one example, the reference FD beam index

$${f}_{l}^{*}$$

is a configured, via, DCI, MAC-CE, or RRC by NW (layer-specific). The configured index can be one of indices of FD basis vectors. Or, the configured index can be different from indices of FD basis vectors. The configured index

$${f}_{l}^{*}$$

is layer-specific, i.e., one for each layer.

In one example, for each layer l=1, . . . , υ, W_{f} basis vectors and W₂ FD indices (columns of W₂) associated with the strongest TRP (or a reference TRP) are shifted (or rotate or remapping FD indices) based on the FD beam index

$${f}_{l}^{*} ,$$

where

$${f}_{l}^{*}$$

is according to one of the above examples herein. The index

$${f}_{l}^{*}$$

is layer-specific, i.e., one for each layer.

In one example, for each layer l=1, . . . , υ, W_{f} basis vectors and W₂ FD indices (columns of W₂) associated with all TRPs are shifted (or rotated or remapping FD indices) based on the FD beam index

$${f}_{l}^{*} ,$$

where

$${f}_{l}^{*}$$

is according to one or the above examples (I.19.6 through I.19.8).

In one embodiment, a UE is configured to report a (relative) offset in FD with respect to a reference FD index (f*), where the reference FD index is according to one of the examples herein. In one example, the one (relative) offset in FD is defined as δ_{f}=f−f*.

For N_{TRP}>1 TRPs, the one (relative) offset in FD for a TRP r∈{0, 1 . . . , N_{TRP}−1} is defined as

$${δ}_{r , f} = {f}_{r} - {f}_{r}^{*} ,$$

where fᵣ is the index (of FD basis vectors or W₂ coefficient matrix), and

$${f}_{r}^{*}$$

is the reference FD index. When the reference FD index is the same for all TRPs (i.e., there is only one reference FD index),

$${f}_{r}^{*} = {f}^{*} ,$$

and hence δ_{r,f}=fᵣ−f*.

In one example, the one (relative) offset is reported regardless of the value of N≤N_{TRP}. where N is the number of TRPs selected from N_{TRP} TRPs by the UE for CSI reporting. In one example, the one (relative) offset is reported only when N>1, and not reported when N=1.

In one example, the one (relative) offset is reported for each TRP (including the strongest TRP which includes the strongest coefficient with the reference FD index f*). So, the total number of (relative) offset reported is N.

In one example, the one (relative) offset is reported for each TRP except the strongest TRP (which includes the strongest coefficient with the reference FD index f*). So, the total number of (relative) offset reported is N−1. The (relative) offset for the strongest TRP is fixed to 0.

In one example, the one (relative) offset is reported only when N=2, and two (relative) offsets are reported when N∈{3,4}, and no reported when N=1.

In one example, the one (relative) offset is reported only when N∈{2,3}, and two (relative) offsets are reported when N=4, and no reported when N=1.

In one example, the (relative) offset is reported from a window of FD indices. In one example, the window is {0, 1, . . . , X−1}. In one example, the window is {Mᵢₙᵢₜ, Mᵢₙᵢₜ+1, . . . , Mᵢₙᵢₜ+X−1} mod N₃. The size (X) and/or the starting index (Mᵢₙᵢₜ) can be fixed or configured (e.g., via RRC) or reported by the UE.

For N>1 and/or υ>1, the (relative) offset is reported according to at least one of the following examples.
In one example, the (relative) offset is reported in layer common manner, i.e., one (relative) offset is reported that is common across all layers l=1, . . . , υ.
In one example, the (relative) offset is reported in layer specific manner, i.e., one (relative) offset is reported for each layer l=1, . . . , υ.
In one example, the (relative) offset is reported in TRP common manner, i.e., one (relative) offset is reported that is common across all TRPs.
In one example, the (relative) offset is reported in TRP specific manner, i.e., one (relative) offset is reported for each TRP.
In one example, the (relative) offset is reported in TRP-group specific manner, i.e., one (relative) offset is reported for each TRP group, and the same offset is assumed for each TRP within a TRP group.
In one example, the (relative) offset is reported in layer common manner and TRP common manner, i.e., one (relative) offset is reported that is common across all layers and all TRPs.
In one example, the (relative) offset is reported in layer common manner and TRP specific manner, i.e., for each TRP, one (relative) offset is reported that is common across all layers.
In one example, the (relative) offset is reported in layer common manner and TRP-group specific manner, i.e., for each TRP-group, one (relative) offset is reported that is common across all layers.
In one example, the (relative) offset is reported in layer specific manner and TRP common manner, i.e., for each layer, one (relative) offset is reported that is common across all TRPs.
In one example, the (relative) offset is reported in layer specific manner and TRP specific manner, i.e., for each layer and for each TRP, one (relative) offset is reported.

In one embodiment, a UE is configured to report a (relative) delay offset δ_{τ} with respect to a reference delay τ*, where the reference delay is according to at least one of the following examples.
In one example, the reference delay τ* is 0, hence not reported.
In one example, the reference delay τ* is in an index set of {0, 1, 2, . . . , T_{ref}}, where T_{ref} is fixed or configured via RRC, MAC-CE, or DCI. In one example, T_{ref}=4,8,16,32.
In one example, the reference delay τ* is in [0, τₘₐₓ], where τₘₐₓ is fixed or configured via RRC, MAC-CE, or DCI. In one example, τ* is selected/reported using an x-bit codebook including equidistance points in [0, τₘₐₓ].

In one example, the delay offset δ_{τ} is defined as δ_{τ}=τ−τ*. The delay offset δ_{τ} is according to at least one of the following examples.
In one example, the delay offset δ_{τ} is in an index set of {0, 1, 2, . . . , Tᵣₑₗ}, where Tᵣₑₗ is fixed or configured via RRC, MAC-CE, or DCI. In one example, T_{ref}=Tᵣₑₗ. In one example, Tᵣₑₗ=4,8,16,32.
In one example, the delay offset δ_{τ} is in [0, τ_{max,rel}], where τ_{max,rel} is fixed or configured via RRC, MAC-CE, or DCI. In one example, δ_{τ} is selected/reported using an y-bit codebook including equidistance points in [0, τ_{max,rel}]. In one example, τₘₐₓ=τ_{max,rel}.
In one example, delay offset δ_{τ} is represented in a phase form, e.g., [0,2π]. In this case, for example, instead of “delay offset”, we can refer it as “phase offset”, “phase ramp/slope”, “phase offset of delay difference between TRPs”, etc.

In one example, when delay offset δ_{τ} is represented in a phase form, 2ⁿ^{_{bit}}-PSK can be used to quantize [0,2π] for reporting. For example, n_{bit}=2, 3, 4 . . . and so on.
In one example, n_{bit} can be fixed to 3 or 4 or 5 . . .
In another example, n_{bit} can be configured by NW via DCI, MAC-CE, or RRC.
In one example, n_{bit} can be determined by a pre-defined rule. For example, n_{bit}=a+nₚ, where a is fixed (e.g., 0, 1 or 2) and nₚ is the number of bits configured for phase component in W₂.

In one example, delay offset δ_{τ} can be reported using a DFT codebook. For example, the phase offset associated with the delay offset can be selected/reported from a DFT codebook with size N₅ and oversampling factor O₅, which can be expressed as

$${z}_{n} = [ \begin{matrix}1 & {e}^{j \frac{2 π n}{{O}_{5} {N}_{5}}} & … & {e}^{j \frac{2 π n ( {N}_{5} - 1 )}{{O}_{5} {N}_{5}}} ] , where n = 0 , 1 , … , {N}_{5} - 1 ,\end{matrix}$$

i.e., the index of n is reported for delay offset δ_{τ}. The payload size for this can be given by ┌log₂ O₅N₅┐ bits.
In one example, N₅ is determined in a pre-defined rule.
In one example, N₅ is fixed.
In one example, N₅ is configured by NW via DCI, MAC-CE, or RRC.
In one example, O₅ is determined in a pre-defined rule.
In one example, O₅ is fixed, e.g., O₅=1 or O₅=2.
In one example, O₅ is configured by NW via DCI, MAC-CE or RRC.
In one example, any combination of the above examples can be applied.

For examples, N₅ is the same number of N₃ (i.e., frequency-domain compression unit). In this case, additional configuration may not be needed.

In another example, N₅ is defined based on N₃ and the density of (associated) CSI-RS (DL RS) resources.

In another example, N₅ is defined based on the number of configured SBS n_{SB} for (associated) CSI-RS (DL RS) resource/reporting/measurement bandwidth.

In another example, N₅ is defined based on the number of configured SBS n_{SB} and CSI-RS density for (associated) CSI-RS (DL RS) resource/reporting/measurement bandwidth.

In another example, N₅ is defined based on the number of configured RBS n_{RB} for (associated) CSI-RS (DL RS) resource/reporting/measurement bandwidth.

In another example, N₅ is defined based on the number of configured RBs n_{RB} and CSI-RS density for (associated) CSI-RS (DL RS) resource/reporting/measurement bandwidth.

The quantization method (e.g., 2ⁿ^{_{bit}}-PSK or DFT codebook zₙ) described in each example above can be applied for δ_{r,τ} described in examples below.

For N_{TRP}>1 TRPs, the one (relative) delay offset for a TRP r∈{0, 1 . . . , N_{TRP}−1} is defined as

$${δ}_{r , τ} = {τ}_{r} - {τ}_{r}^{*} ,$$

where τᵣ is the delay value for TRP r, and

$${τ}_{r}^{*}$$

is the reference delay value. When the reference delay value is the same for all TRPs (i.e., there is only one reference delay),

$${τ}_{r}^{*} = {τ}^{*}$$

and hence δ_{r,τ}=τᵣ−τ*.

In one example, the one (relative) delay offset is reported regardless of the value of N≤N_{TRP}. where N is the number of TRPs selected from N_{TRP} TRPs by the UE for CSI reporting. In one example, the one (relative) delay offset is reported only when N>1, and not reported when N=1.

In one example, the one (relative) delay offset is reported for each TRP (including the strongest TRP which includes the strongest coefficient). So, the total number of (relative) delay offset reported is N.

In one example, the one (relative) delay offset is reported for each TRP except the strongest TRP (which includes the strongest coefficient). So, the total number of (relative) offset reported is N−1. The (relative) delay offset for the strongest TRP is fixed to 0.

In one example, the one (relative) delay offset is reported only when N=2, and two (relative) delay offsets are reported when N∈{3,4}, and no reported when N=1.

In one example, the one (relative) delay offset is reported only when N∈{2,3}, and two (relative) delay offsets are reported when N=4, and no reported when N=1.

For N>1 and/or υ>1, the (relative) delay offset (above mentioned, e.g., δ_{τ} (δ_{r,τ})) is reported according to at least one of the following examples.
In one example, the (relative) delay offset is reported in layer common manner, i.e., one (relative) delay offset is reported that is common across all layers l=1, . . . , υ.
In one example, the (relative) delay offset is reported in layer specific manner, i.e., one (relative) delay offset is reported for each layer l=1, . . . , υ.
In one example, the (relative) delay offset is reported in TRP common manner, i.e., one (relative) delay offset is reported that is common across all TRPs.
In one example, the (relative) delay offset is reported in TRP specific manner, i.e., one (relative) delay offset is reported for each TRP.
In one example, the (relative) delay offset is reported in TRP-group specific manner, i.e., one (relative) delay offset is reported for each TRP group, and the same delay offset is assumed for each TRP within a TRP group.
In one example, the (relative) delay offset is reported in layer common manner and TRP common manner, i.e., one (relative) delay offset is reported that is common across all layers and all TRPs.
In one example, the (relative) delay offset is reported in layer common manner and TRP specific manner, i.e., for each TRP, one (relative) delay offset is reported that is common across all layers.
In one example, the (relative) delay offset is reported in layer common manner and TRP-group specific manner, i.e., for each TRP-group, one (relative) delay offset is reported that is common across all layers.
In one example, the (relative) delay offset is reported in layer specific manner and TRP common manner, i.e., for each layer, one (relative) delay offset is reported that is common across all TRPs.
In one example, the (relative) delay offset is reported in layer specific manner and TRP specific manner, i.e., for each layer and for each TRP, one (relative) delay offset is reported.

In one embodiment, a UE is configured to report a (relative) frequency offset δ_{g} with respect to a reference frequency g*, where the reference frequency is according to at least one of the following examples.
In one example, the reference frequency g* is 0, hence not reported.
In one example, the reference frequency g* is in an index set of {0, 1, 2, . . . , F_{ref}}, where F_{ref} is fixed or configured via RRC, MAC-CE, or DCI. In one example, F_{ref}=4,8,16,32.
In one example, the reference frequency g* is in [0, gₘₐₓ], where gₘₐₓ is fixed or configured via RRC, MAC-CE, or DCI. In one example, g* is selected/reported using an x-bit codebook including equidistance points in [0, gₘₐₓ].

In one example, the frequency offset δ_{g} is defined as δ_{g}=g−g*. The frequency offset δ_{g} is according to at least one of the following examples.
In one example, the frequency offset δ_{g} is in an index set of {0, 1, 2, . . . , Fᵣₑₗ}, where Fᵣₑₗ is fixed or configured via RRC, MAC-CE, or DCI. In one example, F_{ref}=Fᵣₑₗ. In one example, Fᵣₑₗ=4,8,16,32.
In one example, the frequency offset δ_{g} is in [0, g_{max,rel}], where g_{max,rel} is fixed or configured via RRC, MAC-CE, or DCI. In one example, δ_{g} is selected/reported using an y-bit codebook including equidistance points in [0, g_{max,rel}]. In one example, gₘₐₓ=g_{max,rel}.

For N_{TRP}>1 TRPs, the one (relative) frequency offset for a TRP r∈{0, 1 . . . , N_{TRP}−1} is defined as

$${δ}_{r , g} = {g}_{r} - {g}_{r}^{*} ,$$

where gᵣ is the frequency value for TRP r, and

$${τ}_{r}^{*}$$

is the reference frequency value. When the reference frequency value is the same for all TRPs (i.e., there is only one reference frequency), g*ᵣ=g* and hence δ_{r,g}=gᵣ−g*.

In one example, the one (relative) frequency offset is reported regardless of the value of N≤N_{TRP}. where N is the number of TRPs selected from N_{TRP} TRPs by the UE for CSI reporting. In one example, the one (relative) frequency offset is reported only when N>1, and not reported when N=1.

In one example, the one (relative) frequency offset is reported for each TRP (including the strongest TRP which includes the strongest coefficient). So, the total number of (relative) frequency offset reported is N.

In one example, the one (relative) frequency offset is reported for each TRP except the strongest TRP (which includes the strongest coefficient). So, the total number of (relative) frequency reported is N−1. The (relative) frequency offset for the strongest TRP is fixed to 0.

In one example, the one (relative) frequency offset is reported only when N=2, and two (relative) frequency offsets are reported when N∈{3,4}, and no reported when N=1.

In one example, the one (relative) frequency offset is reported only when N∈{2,3}, and two (relative) frequency offsets are reported when N=4, and no reported when N=1.

For N>1 and/or υ>1, the (relative) frequency offset is reported according to at least one of the following examples.
In one example, the (relative) frequency offset is reported in layer common manner, i.e., one (relative) frequency offset is reported that is common across all layers l=1, . . . , υ.
In one example, the (relative) frequency offset is reported in layer specific manner, i.e., one (relative) frequency offset is reported for each layer l=1, . . . , υ.
In one example, the (relative) frequency offset is reported in TRP common manner, i.e., one (relative) frequency offset is reported that is common across all TRPs.
In one example, the (relative) frequency offset is reported in TRP specific manner, i.e., one (relative) frequency offset is reported for each TRP.
In one example, the (relative) frequency offset is reported in TRP-group specific manner, i.e., one (relative) frequency offset is reported for each TRP group, and the same frequency offset is assumed for each TRP within a TRP group.
In one example, the (relative) frequency offset is reported in layer common manner and TRP common manner, i.e., one (relative) frequency offset is reported that is common across all layers and all TRPs.
In one example, the (relative) frequency offset is reported in layer common manner and TRP specific manner, i.e., for each TRP, one (relative) frequency offset is reported that is common across all layers.
In one example, the (relative) frequency offset is reported in layer common manner and TRP-group specific manner, i.e., for each TRP-group, one (relative) frequency offset is reported that is common across all layers.
In one example, the (relative) frequency offset is reported in layer specific manner and TRP common manner, i.e., for each layer, one (relative) frequency offset is reported that is common across all TRPs.
In one example, the (relative) frequency offset is reported in layer specific manner and TRP specific manner, i.e., for each layer and for each TRP, one (relative) frequency offset is reported.

In one embodiment, the reporting of the relative offset, for one or more of the examples herein, can be turned ON/OFF (or enabled). For instance, the UE can be configured with the information regarding whether the relative offset(s) is/are reported by the UE. If turned ON, the UE reported the relative offset(s); else it does not. The information can be provided via e.g., RRC, MAC-CE, or DCI.

In one embodiment, a UE is configured to report one of the relative offset types (e.g., offset in FD index, delay offset, and frequency offset).
In one example, the UE can be configured to report the relative offset(s) in FD index f*.
In one example, the UE can be configured to report the relative delay offset(s) with respect to τ*.
In one example, the UE can be configured to report the relative frequency offset(s) with respect to g*.

In one embodiment, a UE is configured to report two of the relative offset types (e.g., offset in FD index, delay offset, and frequency offset).
In one example, the UE can be configured to report the relative offset(s) in FD index f* and the relative delay offset(s) with respect to τ*.
In one example, the UE can be configured to report the relative offset(s) in FD index f* and the relative frequency offset(s) with respect to g*.
In one example, the UE can be configured to report the relative delay offset(s) with respect to τ* and the relative frequency offset(s) with respect to g*.

In one embodiment, a UE is configured to report all of the relative offset types (e.g., offset in FD index, delay offset, and frequency offset).
In one example, the UE can be configured to report the relative offset(s) in FD index f* and the relative delay offset(s) with respect to τ* and the relative frequency offset(s) with respect to g*.

In one embodiment, the reporting of the relative offset, for one or more of the examples herein, can be dependent on the CB type.

In one example, the reporting of the relative offset can be configured only when the configured codebook type is a decoupled codebook (CB1), where the CB1 includes SD basis vectors (W₁) per TRP/TRP-group, and FD basis vectors (W_{f}) per TRP/TRP-group, and coefficients W₂ per TRP/TRP-group, and inter-TRP components including co-amplitude/co-phase/reference-amplitude.

In one example, the reporting of the relative offset can be configured only when the configured codebook type is a joint codebook (CB2), where the CB2 includes SD basis vectors (W₁) per TRP/TRP-group, FD basis vectors (W_{f}) across TRPs, and a joint coefficient component W₂ across TRPs.

In one example, the reporting of the relative offset can be configured only when the configured codebook type is a joint codebook (CB2), where the CB2 includes SD basis vectors (W₁) per TRP/TRP-group, FD basis vectors (W_{f}) per TRP/TRP-group, and a joint coefficient component W₂ across TRPs.

In one example, the reporting of the relative offset can be configured only when the configured codebook type is a codebook (CB3) comprising (SD, FD) basis vectors, where the CB3 includes a joint SD-FD basis vector component and a combining coefficient component for the joint SD-FD basis vector component per TRP/TRP-group. In one example, the joint SD-FD basis vector component includes an oversampled set of DFT vectors over 2N₁N₂N₃ (i.e., a product of SD basis dimension and FD basis dimension).

In one example, the reporting of the relative offset can be configured only when the configured codebook type either CB1 and/or CB2 and/or CB3.

In one embodiment, a UE is configured with a CSI reporting based on an mTRP (or D-MIMO or C-JT) codebook, via e.g., higher layer parameter codebookType set to ‘typeII-r18-cjt’ or ‘typeII-PortSelection-r18-cjt’, where the codebook is one of the following two modes: In one example, one of the two modes is configured, e.g., via higher layer (e.g., via parameter codebookMode)
Mode 1: Per-TRP/TRP-group SD/FD basis selection. Example formulation (N_{TRP}=number of TRPs or TRP groups): The UE reports (i) SD basis vectors for each TRP, (ii) FD basis vectors for each TRP, and (iii) either a joint W2 across all TRPs or one W2 for each TRP.

$$[ \begin{matrix}{W}_{1 , 1} {\tilde{W}}_{2 , 1} {W}_{f , 1}^{H} \\ ⋮ \\ {W}_{1 , N} {\tilde{W}}_{2 , N} {W}_{f , N}^{H}\end{matrix} ]$$

Mode 2: Per-TRP/TRP group (port-group or resource) SD basis selection and joint (across N_{TRP} TRPs) FD basis selection. Example formulation (N_{TRP}=number of TRPs or TRP groups): The UE reports (i) SD basis vectors for each TRP, (ii) one common/joint FD basis vectors across all TRPs, and (iii) either a joint W2 across all TRPs or one W2 for each TRP.

$$[ \begin{matrix}\begin{matrix}{W}_{1 , 1} & 0 \\ 0 & ⋱\end{matrix} & \begin{matrix}0 & 0 \\ 0 & 0\end{matrix} \\ \begin{matrix}0 & 0 \\ 0 & 0\end{matrix} & {W}_{1 , N}\end{matrix} ] {\tilde{W}}_{2} {W}_{f}^{H} or [ \begin{matrix}{W}_{1 , 1} {\tilde{W}}_{2 , 1} {W}_{f , 1}^{H} \\ ⋮ \\ {W}_{1 , N} {\tilde{W}}_{2 , N} {W}_{f , N}^{H}\end{matrix} ]$$

In one example, W₂ in one or more of the embodiments herein can be \tilde{W}₂ in the embodiment.

In one example, the two modes can share similar detailed designs such as parameter combinations, basis selection, TRP (group) selection, reference amplitude, \tilde{W}₂ quantization schemes.
In one example, parameter combinations can be a tuple of parameters such as L, pᵥ, β for regular Type-II CJT codebook or a tuple of parameters such as M, α, β for port-selection Type-II CJT codebook.
In one example, basis selection scheme can be SD basis selection and/or FD basis selection schemes described herein.
In one example, a \tilde{W}₂ quantization scheme can include strongest coefficient indicator, upper bound of non-zero coefficients, reference amplitudes, a scheme that each coefficient is decomposed into phase and amplitude and they are selected respective codebooks, and a codebook subset restriction.

In one embodiment, a UE reports a (relative) offset in FD (e.g., δ_{f}) and/or a (relative) delay offset (e.g., δ_{τ}), and/or a (relative) frequency offset (e.g., δ_{g}) only when Mode 1 codebook is configured (i.e., relative FD offset is not reported when Mode 2 codebook is configured). In one example, a UE reports a relative offset in FD. In one example, a UE reports a relative delay offset. In one example, a UE reports a (relative) frequency offset. In one example, a UE reports any combination of the threes.
In one example, δ_{f} is according to at least one of the examples in one or more embodiments herein.
In one example, δ_{τ} is according to at least one of the examples in one or more embodiments herein.
In one example, δ_{g} is according to at least one of the examples in one or more embodiments herein.

Alternatively, the UE is expected to report the relative FD offset when mode 1 codebook is configured, and the UE is not expected to report the relative FD offset when mode 2 codebook is configured.

In one embodiment, a UE reports a (relative) offset in FD (e.g., δ_{f}), a (relative) delay offset (e.g., δ_{τ}), and/or a (relative) frequency offset (e.g., δ_{g}) only when Mode 2 codebook is configured (i.e., relative FD offset is not reported when Mode 2 codebook is configured). In one example, a UE reports a relative offset in FD. In one example, a UE reports a relative delay offset. In one example, a UE reports a (relative) frequency offset. In one example, a UE reports any combination of the threes.
In one example, δ_{f} is according to at least one of the examples in one or more embodiments herein.
In one example, δ_{τ} is according to at least one of the examples in one or more embodiments herein.
In one example, δ_{g} is according to at least one of the examples in one or more embodiments herein.

Alternatively, the UE is expected to report the relative FD offset when mode 2 codebook is configured, and the UE is not expected to report the relative FD offset when mode 1 codebook is configured.

In one embodiment, a UE reports a (relative) offset in FD (e.g., δ_{f}), a (relative) delay offset (e.g., δ_{τ}), and/or a (relative) frequency offset (e.g., δ_{g}) both for Mode 1 and Mode 2. In one example, a UE reports a relative offset in FD. In one example, a UE reports a relative delay offset. In one example, a UE reports a (relative) frequency offset. In one example, a UE reports any combination of the threes.
In one example, δ_{f} is according to at least one of the examples in one or more embodiments herein.
In one example, δ_{τ} is according to at least one of the examples in one or more embodiments herein.
In one example, δ_{g} is according to at least one of the examples in one or more embodiments herein.

Alternatively, the UE is expected to report the relative FD offset for both codebook modes.

In one embodiment, a UE is configured (e.g., via higher layer) to report a (relative) offset in FD (e.g., δ_{f}), a (relative) delay offset (e.g., δ_{τ}), and/or a (relative) frequency offset (e.g., δ_{g}) when mTRP codebook (with N>1 TRPs or NZP CSI-RS resources) is configured. In one example, a UE reports a relative offset in FD. In one example, a UE reports a relative delay offset. In one example, a UE reports a (relative) frequency offset. In one example, a UE is configured to report any combination of the threes.
In one example, δ_{f} is according to at least one of the examples in one or more embodiments herein.
In one example, δ_{τ} is according to at least one of the examples in one or more embodiments herein.
In one example, δ_{g} is according to at least one of the examples in one or more embodiments herein.

In one embodiment, a UE is configured (e.g., via higher layer) to report a (relative) offset in FD (e.g., δ_{f}), a (relative) delay offset (e.g., δ_{τ}), and/or a (relative) frequency offset (e.g., δ_{g}) for Mode 1 only or for Mode 2 only or either Mode 1 or Mode 2, using a new higher-layer parameter. For example, a parameter relativeOffsetEnabledMode1orMode2 is used to indicate which Mode is configured to report relative offset. In one example, relativeOffsetEnabledMode1orMode2 can have two integer values, e.g., 1 and 2. In one example, a UE is configured to report a relative offset in FD. In one example, a UE is configured to report a relative delay offset. In one example, a UE is configured to report a (relative) frequency offset. In one example, a UE is configured to report any combination of the threes.
In one example, δ_{f} is according to at least one of the examples in one or more embodiments herein.
In one example, δ_{τ} is according to at least one of the examples in one or more embodiments herein.
In one example, δ_{g} is according to at least one of the examples in one or more embodiments herein.

In one embodiment, a UE decides whether to report a (relative) offset in FD (e.g., δ_{f}), a (relative) delay offset (e.g., δ_{τ}), and/or a (relative) frequency offset (e.g., δ_{g}) or not via a parameter in UCI part 1. In one example, a UE decides whether to report a relative offset in FD or not. In one example, a UE decides whether to report a relative delay offset or not. In one example, a UE decides whether to report a (relative) frequency offset or not. In one example, a UE decides whether to report any combination of the threes or not.
In one example, δ_{f} is according to at least one of the examples in one or more embodiments herein.
In one example, δ_{τ} is according to at least one of the examples in one or more embodiments herein.
In one example, δ_{g} is according to at least one of the examples in one or more embodiments herein.

In one embodiment, a UE reports UE capability on reporting a (relative) offset in FD (e.g., δ_{f}), a (relative) delay offset (e.g., δ_{τ}), and/or a (relative) frequency offset (e.g., δ_{g}).
In one example, a UE reports its capability on reporting a (relative) offset in FD as UE capability. If NW receives this UE capability, the NW needs to follow the UE capability and can configure based on the UE capability.
In one example, a UE reports its capability on reporting a (relative) delay offset as UE capability. If NW receives this UE capability, the NW needs to follow the UE capability and can configure based on the UE capability.
In one example, a UE reports its capability on reporting a (relative) frequency offset as UE capability. If NW receives this UE capability, the NW needs to follow the UE capability and can configure based on the UE capability.
In one example, a UE reports its capability on reporting any combination of the above three offset components as UE capability. If NW receives this UE capability, the NW needs to follow the UE capability and can configure based on the UE capability.

In one embodiment, a UE reports UE capability on possible mode operations among the two modes.
In one example, a UE reports Mode 1-only as UE capability. If NW receives this UE capability, the NW can configure Mode 1 only to the UE.
In one example, a UE reports Mode 2-only as UE capability. If NW receives this UE capability, the NW can configure Mode 2 only to the UE.
In one example, a UE reports Modes 1 and 2 as UE capability. If NW receives this UE capability, the NW can configure either Mode 1 or Mode 2 to the UE.

In one embodiment, the two modes support a same set of rank candidates [symbol] , i.e., any rank in [symbol] can be configured for either mode 1 or mode 2.
In one example, [symbol] ={1,2}.
In one example, [symbol] ={1,2,3}.
In another example [symbol] ={1,2,3,4}.

In one embodiment, each mode i support a different set of rank candidates [symbol] ᵢ.
In one example, low ranks, e.g., [symbol] ₁={1,2}, can be configured for Mode 1, and high ranks, e.g., [symbol] ₂={3,4}, can be configured for Mode 2.
In one example, low ranks, e.g., [symbol] ₂={1,2}, are for Mode 2, and high ranks, e.g., [symbol] ₁={3,4}, are for Mode 1.
In one example, low ranks, e.g., [symbol] ₁={1,2}, are for Mode 1, and any rank, e.g., [symbol] ₂={1,2,3,4}, is for Mode 2.
In one example, low ranks, e.g., [symbol] ₂={1,2}, are for Mode 2, and any rank, e.g., [symbol] ₁={1,2,3,4}, is for Mode 2.

In one embodiment, there are common codebook parameters for Mode 1 and Mode 2, and mode-specific codebook parameters.
In one example, L (or Lₛᵤₘ or Lᵣ) value(s) is a common parameter for both Mode 1 and Mode 2, i.e., same value(s) can be configured for both Mode 1 and Mode 2.
In one example, L (or Lₛᵤₘ or Lᵣ) value(s) is a mode-specific parameter, i.e., independent L value(s) can be configured for each mode.
In one example Mᵥ

$$( or {M}_{v , sum} = {\sum }_{r = 1}^{{N}_{TRP}} {M}_{v , r} or {M}_{v , r} )$$

value(s) is a common parameter for both Mode 1 and Mode 2, i.e., same value(s) of Mᵥ

$$( or {M}_{v , sum} = {\sum }_{r = 1}^{{N}_{TRP}} {M}_{v , r} or {M}_{v , r} )$$

can be configured for both Mode 1 and Mode 2.
In one example, Mᵥ (or M_{v,sum} or M_{v,r}) value(s) is a mode-specific parameter, i.e., independent Mᵥ (or M_{v,sum} or M_{v,r}) value(s) can be configured for each mode.

In one embodiment, a UE is configured with a CSI report for N≥1 TRPs (where TRP corresponds to a NZP CSI-RS resource or a subset of CSI-RS antenna ports within a NZP CSI-RS resource) based on a mTRP CJT codebook, where the codebook is configured according to (at least) one of the examples herein.

In one embodiment, FD basis vectors and relative offsets in FD for N≥1 TRPs are reported as part of CSI report according to (at least) one of the following examples.

In one example, (Alt 1) a relative offset in FD (e.g., δ_{f} or δ_{f,r}) for each of N TRPs (or each of N−1 TRPs, e.g., excluding a reference TRP) is reported and a common set of Mᵥ FD basis vectors for all TRP are reported, as part of CSI report. So, the UE reports {δ_{f,r}: r=1, . . . , N−1} (or {δ_{f,r}: r=1, . . . , N}) and a set of M_{υ} FD basis vectors via respective indicators.
In one example, a reference TRP can be configured by RRC, MAC-CE, or DCI.
In one example, a reference TRP can be determined by UE and reported. In one example, a reference TRP can be a strongest TRP.
In one example, a reference TRP can be fixed using a pre-defined rule. (e.g., the TRP that includes the SCI).

In one example, (Alt 2) a relative offset in FD (e.g., δ_{f} or δ_{f,r}) for each of N TRPs (or each of N−1 TRPs, e.g., excluding a reference TRP) is reported and Mᵥ (or M_{v,r}) FD basis vectors for each TRP r are reported, as part of CSI report. So, the UE reports {δ_{f,r}: r=1, . . . , N−1} (or {δ_{f,r}: r=1, . . . , N}) and N sets of M_{υ,r} FD basis vectors via respective indicators.
In one example, a reference TRP can be configured by RRC, MAC-CE, or DCI.
In one example, a reference TRP can be determined by UE and reported. In one example, a reference TRP can be a strongest TRP.
In one example, a reference TRP can be fixed using a pre-defined rule. (e.g., the TRP that includes the SCI).

In one example, (Alt 3) a common set of Mᵥ FD basis vectors for all TRPs (across TRPs) are reported, as part of CSI report, and there is no reporting of relative offsets.

In one example, (Alt 4) Mᵥ (or M_{v,r}) FD basis vectors for each TRP r are reported, as part of CSI report, and there is no reporting of relative offsets.

In one example, Alt 1 and Alt 2 are associated with Mode 1 and Mode 2, respectively, where Mode 1 and Mode 2 are described herein, i.e., Alt1 is used for FD basis vector reporting when Mode 1 is configured and Alt2 is used for FD basis vector reporting when Mode 2 is configured.

In one example, Alt 1 and Alt 3 are associated with Mode 1 and Mode 2, respectively, where Mode 1 and Mode 2 are described herein, i.e., Alt1 is used for FD basis vector reporting when Mode 1 is configured and Alt3 is used for FD basis vector reporting when Mode 2 is configured.

In one example, Alt 1 and Alt 4 are associated with Mode 1 and Mode 2, respectively, where the Mode 1 and Mode 2 are described herein, i.e., Alt1 is used for FD basis vector reporting when Mode 1 is configured and Alt4 is used for FD basis vector reporting when Mode 2 is configured.

In one example, Alt 2 and Alt 3 are associated with Mode 1 and Mode 2, respectively, where the Mode 1 and Mode 2 are described herein, i.e., Alt2 is used for FD basis vector reporting when Mode 1 is configured and Alt3 is used for FD basis vector reporting when Mode 2 is configured.

In one example, Alt 2 and Alt 4 are associated with Mode 1 and Mode 2, respectively, where the Mode 1 and Mode 2 are described herein, i.e., Alt2 is used for FD basis vector reporting when Mode 1 is configured and Alt4 is used for FD basis vector reporting when Mode 2 is configured.

In one example, Alt 3 and Alt 4 are associated with Mode 1 and Mode 2, respectively, where the Mode 1 and Mode 2 are described herein, i.e., Alt3 is used for FD basis vector reporting when Mode 1 is configured and Alt4 is used for FD basis vector reporting when Mode 2 is configured.

In one example, Alt 1 and Alt 2 are associated with Mode 2 and Mode 1, respectively, where the Mode 1 and Mode 2 are described herein, i.e., Alt1 is used for FD basis vector reporting when Mode 2 is configured and Alt2 is used for FD basis vector reporting when Mode 1 is configured.

In one example, Alt 1 and Alt 3 are associated with Mode 2 and Mode 1, respectively, where the Mode 1 and Mode 2 are described herein, i.e., Alt1 is used for FD basis vector reporting when Mode 2 is configured and Alt3 is used for FD basis vector reporting when Mode 1 is configured.

In one example, Alt 1 and Alt 4 are associated with Mode 2 and Mode 1, respectively, where the Mode 1 and Mode 2 are described herein, i.e., Alt1 is used for FD basis vector reporting when Mode 2 is configured and Alt4 is used for FD basis vector reporting when Mode 1 is configured.

In one example, Alt 2 and Alt 3 are associated with Mode 2 and Mode 1, respectively, where the Mode 1 and Mode 2 are described herein, i.e., Alt2 is used for FD basis vector reporting when Mode 2 is configured and Alt3 is used for FD basis vector reporting when Mode 1 is configured.

In one example, Alt 2 and Alt 4 are associated with Mode 2 and Mode 1, respectively, where the Mode 1 and Mode 2 are described herein, i.e., Alt2 is used for FD basis vector reporting when Mode 2 is configured and Alt4 is used for FD basis vector reporting when Mode 1 is configured.

In one example, Alt 3 and Alt 4 are associated with Mode 2 and Mode 1, respectively, where the Mode 1 and Mode 2 are described herein, i.e., Alt3 is used for FD basis vector reporting when Mode 2 is configured and Alt4 is used for FD basis vector reporting when Mode 1 is configured.

In one embodiment, one or more of the examples herein can be configured by RRC, MAC-CE, or DCI signaling.

In one embodiment, Mode 1 can be associated with a fixed Alt x from Alt1-Alt4 herein, and one of the Alts herein can be configured for Mode 2 via RRC, MAC-CE or DCI signaling.
In one example, Mode 1 can be associated with fixed Alt 1 and one of the Alts (from Alt1-Alt4) can be configured for Mode 2 via RRC, MAC-CE or DCI signaling.
In one example, Mode 1 can be associated with fixed Alt 2 and one of the Alts (from Alt1-Alt4) can be configured for Mode 2 via RRC, MAC-CE or DCI signaling.
In one example, Mode 1 can be associated with fixed Alt 3 and one of the Alts (from Alt1-Alt4) can be configured for Mode 2 via RRC, MAC-CE or DCI signaling.
In one example, Mode I can be associated with fixed Alt 4 and one of the Alts (from Alt1-Alt4) can be configured for Mode 2 via RRC, MAC-CE or DCI signaling.

In one embodiment, Mode 2 can be associated with a fixed Alt x from Alt1-Alt4 herein, and one of the Alts herein can be configured for Mode 1 via RRC, MAC-CE or DCI signaling.
In one example, Mode 2 can be associated with fixed Alt 1 and one of the Alts (from Alt1-Alt4) can be configured for Mode 1 via RRC, MAC-CE or DCI signaling.
In one example, Mode 2 can be associated with fixed Alt 2 and one of the Alts (from Alt1-Alt4) can be configured for Mode 1 via RRC, MAC-CE or DCI signaling.
In one example, Mode 2 can be associated with fixed Alt 3 and one of the Alts (from Alt1-Alt4) can be configured for Mode 1 via RRC, MAC-CE or DCI signaling.
In one example, Mode 2 can be associated with fixed Alt 4 and one of the Alts (from Alt1-Alt4) can be configured for Mode 1 via RRC, MAC-CE or DCI signaling.

In one embodiment, one of the Alts herein can be configured for either Mode 1 or Mode 2 via RRC, MAC-CE or DCI signaling.
In one example, one of the Alts (from Alt1-Alt4) can be configured for Mode 1 via RRC, MAC-CE, or DCI signaling.
In one example, one of the Alts (from Alt1-Alt4) can be configured for Mode 2 via RRC, MAC-CE, or DCI signaling.

In one embodiment, one of the Alts herein can be fixed for either Mode 1 or Mode 2.
In one example, one of the Alts (from Alt1-Alt4) can be fixed for Mode 1.
In one example, one of the Alts (from Alt1-Alt4) can be fixed for Mode 2.

FIG. 13 illustrates an example method 1300 performed by a UE in a wireless communication system according to embodiments of the present disclosure. The method 1300 of FIG. 13 can be performed by any of the UEs 111-116 of FIG. 1, such as the UE 116 of FIG. 3, and a corresponding method can be performed by any of the BSs 101-103 of FIG. 1, such as BS 102 of FIG. 2. The method 1300 is for illustration only and other embodiments can be used without departing from the scope of the present disclosure.

The method begins with the UE receiving information about a CSI report associated with Nₜᵣₚ groups of antenna ports (1310). For example, in 1310, Nₜᵣₚ>1. The UE then determines the CSI report associated with N≤Nₜᵣₚ groups of antenna ports (1320). For example, in 1320, the UE determines the CSI report based on the information. In various embodiments, N∈{2, 3, . . . , Nₜᵣₚ} and the CSI report includes: a first indicator indicating, for each layer l=1, . . . , υ, indices of Mᵥ vectors including columns of a frequency-domain (FD) basis matrix W_{f,l}, where v≥1 is a rank value and a second indicator indicating an index of a FD offset value φᵣ for each of the N groups of antenna ports, where r∈{1, . . . , N}, r≠r* and r* is an index of a reference group of antenna ports. For example, the FD basis matrix associated with an r-th group of antenna ports is determined based on W_{f,l} and φᵣ.

In various embodiments, the FD basis matrix associated with the r-th group of antenna ports is given by W_{f,l,r}=diag(φᵣ)W_{f,l}, where zφᵣ is a rotation vector that rotates the Mᵥ vectors based on the FD offset value φᵣ. In various embodiments,

$${z}_{{φ}_{r}} = [ 1 {e}^{j \frac{2 π {φ}_{r}}{{N}_{3} {O}_{3}}} … {e}^{j \frac{2 {πφ}_{r} ( {N}_{3} - 1 )}{{N}_{3} {O}_{3}}} ] ,$$

oversampling factor. For example, when O₃=1,

$${z}_{{φ}_{r}} = [ 1 {e}^{j \frac{2 π {φ}_{r}}{{N}_{3}}} … {e}^{j \frac{2 {πφ}_{r} ( {N}_{3} - 1 )}{{N}_{3}}} ] ,$$

φᵣ∈{0, 1, . . . , N₃−1} and a payload of the second indicator is (N−1)┌log₂ N₃┐ bits. In another example, or φᵣ∈{0, 1, . . . , X−1}, where X<N₃O₃ is a maximum value of the FD offset value and a payload of the second indicator is (N−1)┌log₂(X)┐ bits. In another example, when O₃=4, φᵣ∈{0, 1, . . . , 4N₃−1} and a payload of the second indicator is (N−1)┌log₂(4N₃)┐ bits.

In various embodiments, the UE may also transmit UE capability information indicating that the UE is capable of supporting O₃=4. In various embodiments, the information received includes information about Nₜᵣₚ NZP CSI-RS resources, each associated with one of the Nₜᵣₚ groups of antenna ports, and the UE measures the Nₜᵣₚ NZP CSI-RS resources to determine the CSI report based on the measurement. Thereafter, the UE transmits the CSI report (1330). For example, in 1330, the CSI report includes the first and the second indicators.

Any of the above variation embodiments can be utilized independently or in combination with at least one other variation embodiment. The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of this disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A method performed by a user equipment (UE) in a wireless communication system, the method comprising:
receiving, from a base station (BS), configuration information for a channel state information (CSI) report, wherein the configuration information indicates a codebook type for the CSI report as a type II coherent joint transmission with a plurality of transmission and reception points (TRPs);
identifying at least one offset in a frequency-domain (FD), for each of the plurality of TRPs based on the configuration information; and
transmitting, to the BS, the CSI report including information on the offset in the FD.

2. The method of claim 1, wherein:
the information on the offset in the FD is included in the CSI report based on a codebook mode is set to mode 1 based on the configuration information,
in case that the codebook mode is set to mode 2, the information on the offset in the FD is not included in the CSI report.

3. The method of claim 1, wherein a number of offsets indicated by the information corresponds to a number of the plurality of TRPs minus one.

4. The method of claim 3, wherein:
the offset in the FD is common for one or more layers,
a codebook for the CSI report is identified based on the offset in the FD, an oversampling factor, and a length of FD basis vector.

5. A user equipment (UE) in a wireless communication system, the UE comprising:
a transceiver, and
a controller coupled with the transceiver and configured to:
receive, from a base station (BS), configuration information for a channel state information (CSI) report, wherein the configuration information indicates a codebook type for the CSI report as a type II coherent joint transmission with a plurality of transmission and reception points (TRPs);
identify at least one offset in a frequency-domain (FD), for each TRP of the plurality of TRPs based on the configuration information, and
transmit, to the BS, the CSI report including information on the at least one offset in the FD.

6. The UE of claim 5, wherein:
the information on the offset in the FD is included in the CSI report based on a codebook mode is set to mode 1 based on the configuration information, and
in case that the codebook mode is set to mode 2, the information on the offset in the FD is not included in the CSI report.

7. The UE of claim 5, wherein a number of offsets indicated by the information corresponds to a number of the plurality of TRPs minus one.

8. The UE of claim 7, wherein:
the offset in the FD is common for one or more layers, and
a codebook for the CSI report is identified based on the offset in the FD, an oversampling factor, and a length of FD basis vector.

9. A base station (BS) in a wireless communication system, the BS comprising:
a transceiver, and
a controller coupled with the transceiver and configured to:
transmit, to a user equipment (UE), configuration information for a channel state information (CSI) report, wherein the configuration information indicates a codebook type for the CSI report as a type II coherent joint transmission with a plurality of transmission and reception points (TRPs), and
receive, from the UE, the CSI report including information on at least one offset of a frequency-domain (FD),
wherein the at least one offset of the FD for each TRP of the plurality of TRPs is associated with the configuration information.

10. The BS of claim 9, wherein:
the information on the offset in the FD is included in the CSI report based on a codebook mode is set to mode 1 based on the configuration information, and
in case that the codebook mode is set to mode 2, the information on the offset in the FD is not included in the CSI report.

11. The BS of claim 9, wherein a number of offsets indicated by the information corresponds to a number of the plurality of TRPs minus one.

12. The BS of claim 11, wherein:
the offset in the FD is common for one or more layers, and
a codebook for the CSI report is identified based on the offset in the FD, an oversampling factor, and a length of FD basis vector.
